(19) United States
(12) Patent Application Publication
(10) Pub. No.: US 2026/0129217 A1
(43) Pub. Date: May 7, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Kai ZHANG, Los Angeles, CA (US); Li ZHANG, Los Angeles, CA (US)

(21) Appl. No.: 19/435,496

(22) Filed: Dec. 29, 2025

Related U.S. Application Data
(63) Continuation of application No. PCT/CN2024/102148, filed on Jun. 27, 2024.

(30) Foreign Application Priority Data
Jun. 28, 2023 (WO) PCT/CN2023/103341

(51) Int. Cl. H04N 19/192; H04N 19/105; H04N 19/159; H04N 19/176; H04N 19/70

(52) U.S. Cl. CPC H04N 19/192; H04N 19/105; H04N 19/159; H04N 19/176; H04N 19/70

(57) ABSTRACT

Embodiments of the present disclosure provide a solution for video processing. A method for video processing is proposed. In the method, for a conversion between a current video block of a video and a bitstream of the video, usage information of a plurality of template-based approaches is determined for the current video block based on at least one syntax element at a first level. The first level is higher than a coding unit level. The conversion is performed based on the usage information. The plurality of template-based approaches comprises at least two coding tools associated with at least one of: intra coding, inter coding, or intra block copy (IBC) coding.

### CROSS-REFERENCE TO RELATED APPLICATIONS

This application is a continuation of International Application No. PCT/CN2024/102148, filed on Jun. 27, 2024, which claims the benefit of International Application No. PCT/CN2023/103341, filed on Jun. 28, 2023. The entire contents of these applications are hereby incorporated by reference in their entireties.

### FIELDS

Embodiments of the present disclosure relates generally to video processing techniques, and more particularly, to syntax element control of coding tool.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, usage information of a plurality of template-based approaches for the current video block based on at least one syntax element at a first level, the first level being higher than a coding unit level; and performing the conversion based on the usage information, wherein the plurality of template-based approaches comprises at least two coding tools associated with at least one of: intra coding, inter coding, or intra block copy (IBC) coding. The method in accordance with the first aspect of the present disclosure enables a high-level syntax element control for the template-based approaches, and thus can improve the coding effectiveness and/or coding efficiency.

In a second aspect, another method for video processing is proposed. The method comprises: determining, for a conversion between a current video block of a video and a bitstream of the video, a first syntax element for controlling a template matching, the template matching being used for at least one of: an intra coding, or an intra block copy (IBC) coding; determining usage information of a template-based coding tool for the current video block based on the first syntax element, the template-based coding tool comprising at least one of: a template-based intra coding tool, or a template-based IBC coding tool; and performing the conversion based on the usage information. The method in accordance with the second aspect of the present disclosure control the template-based coding tool based on the template matching control, and thus can improve the coding effectiveness and/or coding efficiency.

In a third aspect, another method for video processing is proposed. The method comprises: determining, for a conversion between a current video block of a video and a bitstream of the video, a first syntax element for controlling a template matching, the template matching being used for at least one of: an intra coding, or an intra block copy (IBC) coding; determining usage information of a local-boosting cross-component prediction for the current video block based on the first syntax element; and performing the conversion based on the usage information. The method in accordance with the third aspect of the present disclosure controls the local-boosting cross-component prediction based on high level syntax element, and thus can improve the coding effectiveness and/or coding efficiency.

In a fourth aspect, another method for video processing is proposed. The method comprises: determining, for a conversion between a current video block of a video and a bitstream of the video, usage information of an adaptive reordering of merge candidates (ARMC) for the current video block based on at least one syntax element; and performing the conversion based on the usage information. The method in accordance with the fourth aspect of the present disclosure controls the usage of the ARMC based on the syntax element, and thus can improve the coding effectiveness and/or coding efficiency.

In a fifth aspect, an apparatus for video processing is proposed. The apparatus comprises a processor and a non-transitory memory with instructions thereon. The instructions upon execution by the processor, cause the processor to perform a method in accordance with the first, second, third, or fourth aspect of the present disclosure.

In a sixth aspect, a non-transitory computer-readable storage medium is proposed. The non-transitory computer-readable storage medium stores instructions that cause a processor to perform a method in accordance with the first, second, third, or fourth aspect of the present disclosure.

In a seventh aspect, another non-transitory computer-readable recording medium is proposed. The non-transitory computer-readable recording medium stores a bitstream of a video which is generated by a method performed by an apparatus for video processing. The method comprises: determining usage information of a plurality of template-based approaches for a current video block of the video based on at least one syntax element at a first level, the first level being higher than a coding unit level; and generating the bitstream based on the usage information, wherein the plurality of template-based approaches comprises at least two coding tools associated with at least one of: intra coding, inter coding, or intra block copy (IBC) coding.

In an eighth aspect, another non-transitory computer-readable recording medium is proposed. The non-transitory computer-readable recording medium stores a bitstream of a video which is generated by a method performed by an apparatus for video processing. The method comprises: determining a first syntax element for controlling a template matching, the template matching being used for at least one of: an intra coding, or an intra block copy (IBC) coding; determining usage information of a template-based coding tool for a current video block of the video based on the first syntax element, the template-based coding tool comprising at least one of: a template-based intra coding tool, or a template-based IBC coding tool; and generating the bitstream based on the usage information.

In a ninth aspect, another non-transitory computer-readable recording medium is proposed. The non-transitory computer-readable recording medium stores a bitstream of a video which is generated by a method performed by an apparatus for video processing. The method comprises: determining a first syntax element for controlling a template matching, the template matching being used for at least one of: an intra coding, or an intra block copy (IBC) coding; determining usage information of a local-boosting cross-component prediction for a current video block of the video based on the first syntax element; and generating the bitstream based on the usage information.

In a tenth aspect, another non-transitory computer-readable recording medium is proposed. The non-transitory computer-readable recording medium stores a bitstream of a video which is generated by a method performed by an apparatus for video processing. The method comprises: determining usage information of an adaptive reordering of merge candidates (ARMC) for a current video block of the video based on at least one syntax element; and generating the bitstream based on the usage information.

In an eleventh aspect, a method for storing a bitstream of a video is proposed. The method comprises: determining usage information of a plurality of template-based approaches for a current video block of the video based on at least one syntax element at a first level, the first level being higher than a coding unit level; generating the bitstream based on the usage information; and storing the bitstream in a non-transitory computer-readable recording medium, wherein the plurality of template-based approaches comprises at least two coding tools associated with at least one of: intra coding, inter coding, or intra block copy (IBC) coding.

In a twelfth aspect, a method for storing a bitstream of a video is proposed. The method comprises: determining a first syntax element for controlling a template matching, the template matching being used for at least one of: an intra coding, or an intra block copy (IBC) coding; determining usage information of a template-based coding tool for a current video block of the video based on the first syntax element, the template-based coding tool comprising at least one of: a template-based intra coding tool, or a template-based IBC coding tool; generating the bitstream based on the usage information; and storing the bitstream in a non-transitory computer-readable recording medium.

In a thirteenth aspect, a method for storing a bitstream of a video is proposed. The method comprises: determining a first syntax element for controlling a template matching, the template matching being used for at least one of: an intra coding, or an intra block copy (IBC) coding; determining usage information of a local-boosting cross-component prediction for a current video block of the video based on the first syntax element; generating the bitstream based on the usage information; and storing the bitstream in a non-transitory computer-readable recording medium.

In a fourteenth aspect, a method for storing a bitstream of a video is proposed. The method comprises: determining usage information of an adaptive reordering of merge candidates (ARMC) for a current video block of the video based on at least one syntax element; generating the bitstream based on the usage information; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4A and FIG. 4B illustrate the effect of the slope adjustment parameter “u”, where FIG. 4A corresponds to the model created with the current CCLM, and FIG. 4B corresponds to the model updated as proposed;

FIG. 5 illustrates neighboring blocks (L, A, BL, AR, AL) used in the derivation of a general MPM list;

FIG. 6 illustrates neighboring reconstructed samples used for DIMD chroma mode;

FIG. 7 illustrates an intra template matching search area used;

FIG. 8 illustrates use of intraTMP block vector for IBC block;

FIG. 9A and FIG. 9B illustrate the division method for angular modes, respectively;

FIG. 10 illustrations an extended MRL candidate list;

FIG. 11 illustrates the template area;

FIG. 12 illustrates a spatial part of the convolutional filter;

FIG. 13 illustrates a reference area (with its paddings) used to derive the filter coefficients;

FIG. 14 illustrates four Sobel based gradient patterns for GLM;

FIG. 15 illustrates spatial GPM candidates;

FIG. 16 illustrates GPM template;

FIG. 17 illustrates GPM blending;

FIG. 18 illustrates possible positions of candidate regions;

FIG. 19 illustrates positions of the adjacent spatial candidates;

FIG. 20 illustrates a transform selection process for directional planar modes;

FIG. 21 illustrates luma blocks used to derive direct block vector;

FIG. 22A to FIG. 22C illustrate the defined three types of reconstructed areas include thirteen columns or rows of reconstructed pixels, respectively;

FIG. 23A to FIG. 23C illustrate the defined three types of filter shapes have fifteen inputs and generate one output, respectively;

FIG. 24A to FIG. 24C illustrate prediction for different positions in the current block, respectively;

FIG. 25 illustrates a spatial part of the filter;

FIG. 26 illustrates reference area used to derive the filter coefficients;

FIG. 27 illustrates a filter shape;

FIG. 28 illustrates spatial neighboring blocks used to derive the spatial merge candidates;

FIG. 29 illustrates template matching performs on a search area around initial MV;

FIG. 30 illustrates diamond regions in the search area;

FIG. 31 illustrates a template;

FIG. 32 illustrates the first HPT and the second HPT;

FIG. 33 illustrates spatial neighbors for deriving affine merge/AMVP candidates: (a) for deriving inherited candidates (b) for deriving the first type of constructed candidates;

FIG. 34 illustrates from non-adjacent neighbors to the first type of constructed affine merge/AMVP candidates;

FIG. 35 illustrates frequency responses of the interpolation filter and the VVC interpolation filter at half-pel phase;

FIG. 36 illustrates template and reference samples of the template in reference pictures;

FIG. 37 illustrates template and reference samples of the template for block with sub-block motion using the motion information of the subblocks of the current block;

FIG. 38 illustrates additional directions along k×π/8 diagonal angles (white positions are used in the anchor);

FIG. 39 illustrates the neighboring 4×4 subblocks that are used for RMVF parameter derivation. W and H are the width and height of the current CU;

FIG. 40 illustrates the ramp function for the weights for GPM blending based on the displacement (d) from a predicted sample position to the GPM partitioning boundary and the blending area size (i);

FIG. 41A to FIG. 41D illustrate GPM with inter and intra prediction. Available IPM candidates are shown in FIG. 41A to FIG. 41C. FIG. 41D shows example of GPM with intra and intra prediction;

FIG. 42 shows an edge on templates;

FIG. 43 illustrates padding candidates for the replacement of the zero-vector in the IBC list;

FIG. 44 illustrates an IBC reference region depending on current CU position.

FIG. 45 illustrates a reference area for IBC when CTU (m, n) is coded;

FIG. 46 illustrates motion compensated boundary padding method;

FIG. 47 illustrates an example of deriving a M×4 padding block with a left padding direction;

FIG. 48A illustrates BV adjustment for horizontal flip, and FIG. 48B illustrates BV adjustment for vertical flip, respectively;

FIG. 49 illustrates a flowchart of a method for video processing in accordance with embodiments of the present disclosure;

FIG. 50 illustrates a flowchart of a method for video processing in accordance with embodiments of the present disclosure;

FIG. 51 illustrates a flowchart of a method for video processing in accordance with embodiments of the present disclosure;

FIG. 52 illustrates a flowchart of a method for video processing in accordance with embodiments of the present disclosure; and

FIG. 53 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment.

Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

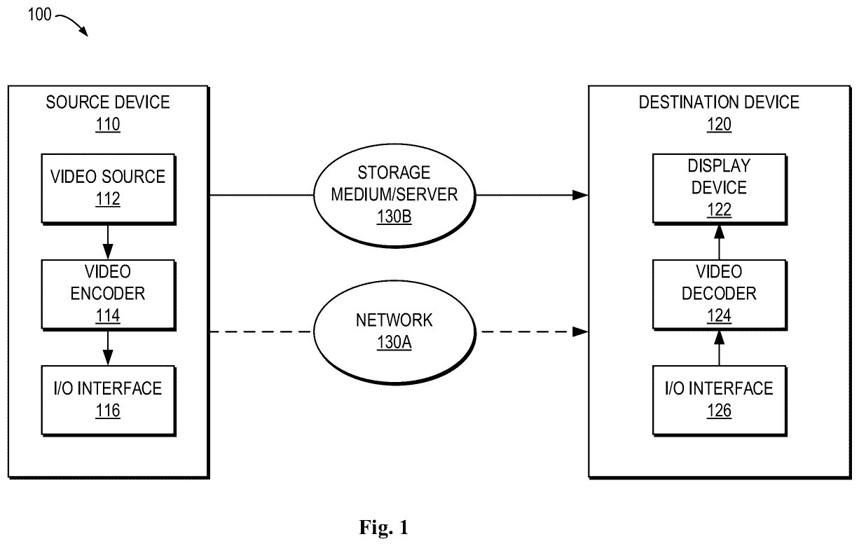

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

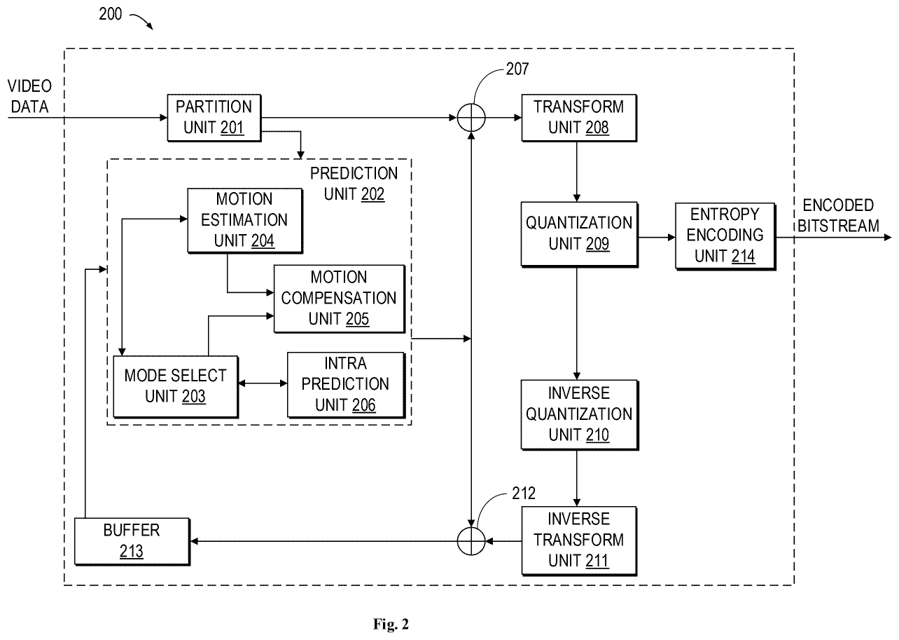

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

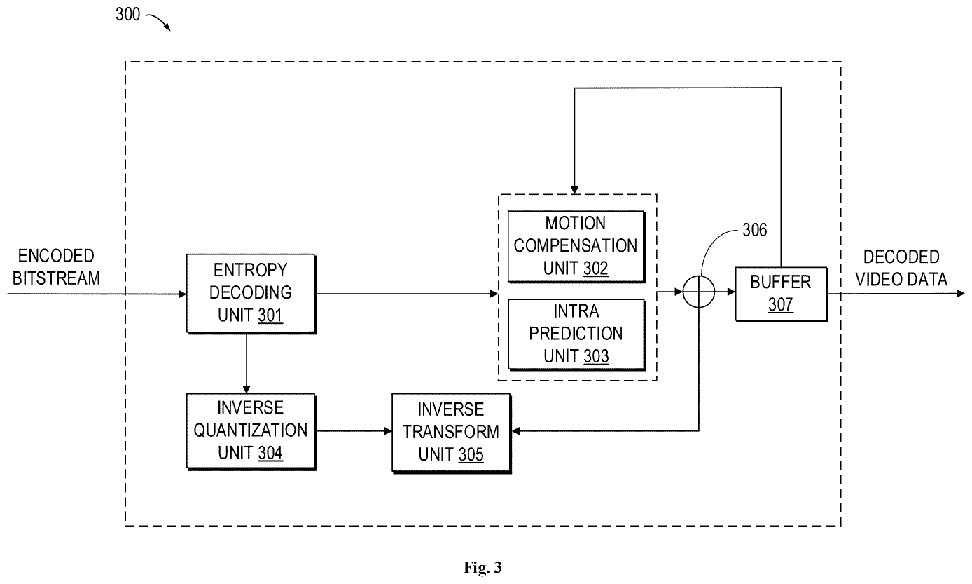

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to video coding technologies. Specifically, it is about high level control of coding tools in image/video coding. It may be applied to the existing video coding standard like HEVC, VVC, and etc. It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 WET meeting, and the first version of VVC test model (VTM) was released at that time. The VVC working draft and test model VTM are then updated after every meeting. The VVC project achieved technical completion (FDIS) at the July 2020 meeting.

### 2.1 Intra Prediction

In intra prediction the smallest chroma intra prediction unit (SCIPU) constraint in VVC is removed. In addition, the VPDU constraint for reducing CCLM prediction latency is also removed.

### 2.1.1 Multi-Model LM (MMLM)

CCLM included in VVC is extended by adding three Multi-model LM (MMLM) modes. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

### 2.1.1.1 Slope Adjustment of CCLM

CCLM uses a model with 2 parameters to map luma values to chroma values. The slope parameter “a” and the bias parameter “b” define the mapping as follows:

$$chromaVal = a * lumaVal + b .$$

An adjustment “u” to the slope parameter is signaled to update the model to the following form:

$$chromaVal = {a}^{′} * lumaVal + {b}^{′} ,$$

$$where$$

$${a}^{′} = a + u ,$$

$${b}^{′} = b - u * {y}_{r} .$$

With this selection the mapping function is tilted or rotated around the point with luminance value yᵣ. The average of the reference luma samples used in the model creation as yᵣ in order to provide a meaningful modification to the model. Picture below illustrates the process.

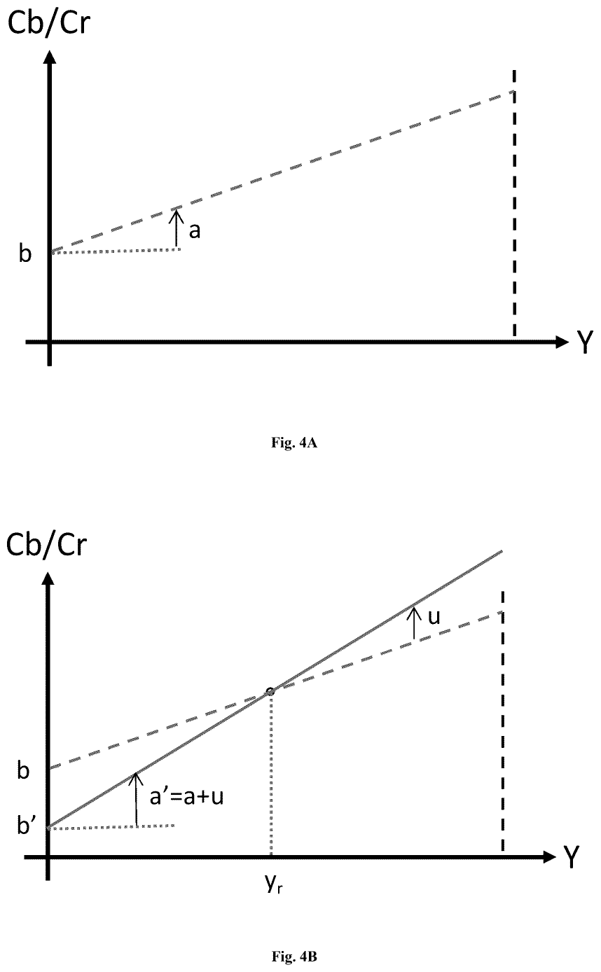

FIG. 4A and FIG. 4B illustrate the effect of the slope adjustment parameter “u”, where FIG. 4A corresponds to the model created with the current CCLM, and FIG. 4B corresponds to the model updated as proposed.

### Implementation

Slope adjustment parameter is provided as an integer between −4 and 4, inclusive, and signaled in the bitstream. The unit of the slope adjustment parameter is ⅛^{th} of a chroma sample value per one luma sample value (for 10-bit content).

Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 2.1.2 Gradient PDPC

In VVC, for a few scenarios, PDPC may not be applied due to the unavailability of the secondary reference samples. In these cases, a gradient based PDPC, extended from horizontal/vertical mode, is applied. The PDPC weights (wT/wL) and nScale parameter for determining the decay in PDPC weights with respect to the distance from left/top boundary are set equal to corresponding parameters in horizontal/vertical mode, respectively. When the secondary reference sample is at a fractional sample position, bilinear interpolation is applied.

### 2.1.3 Secondary MPM

Secondary MPM lists is introduced. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL.

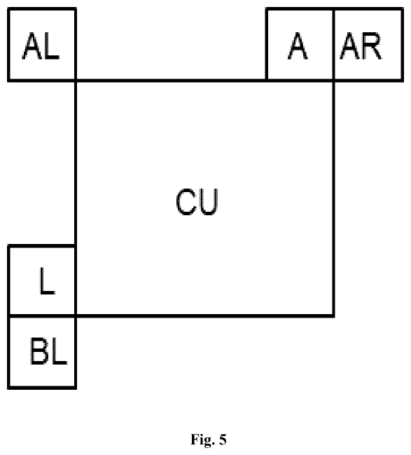

FIG. 5 illustrates neighboring blocks (L, A, BL, AR, AL) used in the derivation of a general MPM list.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.1.4 Reference Sample Interpolation and Smoothing for Intra-Prediction

The 4-tap cubic interpolation is replaced with a 6-tap cubic interpolation filter, for the derivation of predicted samples from the reference samples.

For reference sample filtering, a 6-tap gaussian filter is applied for larger blocks (W>=32 and H>=32), existing VVC 4-tap gaussian interpolation filter is applied otherwise. The extended intra reference samples are derived using the 4-tap interpolation filter instead of the nearest neighbor rounding.

### 2.1.5 Decoder Side Intra Mode Derivation (DIMD)

When DIMD is applied, two intra modes are derived from the reconstructed neighbor samples, and those two predictors are combined with the planar mode predictor with the weights derived from the gradients. The division operations in weight derivation are performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$x = Floor ( Log 2 ( G x ) )$$

$$normDiff = ( ( Gx ≪ 4 ) ≫ x ) \& 15$$

$$x += ( 3 + ( normDiff != 0 ) ? 1 : 0 )$$

$$Orient = ( Gy * ( DivSigTable [ normDiff ] \vert 8 ) + ( 1 ≪ ( x - 1 ) ) ) ≫ x$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \} .$$

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

### 2.1.5.1 DIMD Chroma Mode

The DIMD chroma mode uses the DIMD derivation method to derive the chroma intra prediction mode of the current block based on the neighboring reconstructed Y, Cb and Cr samples in the second neighboring row and column. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

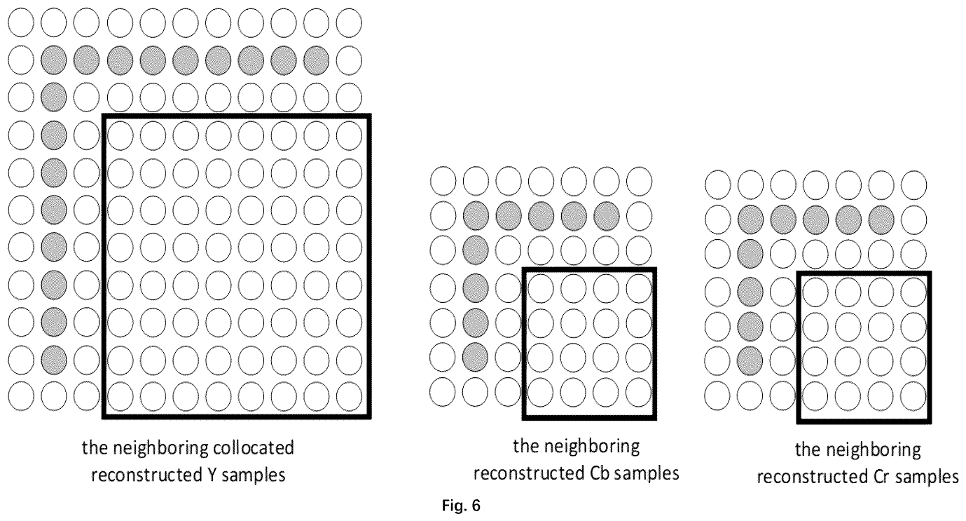

FIG. 6 illustrates neighboring reconstructed samples used for DIMD chroma mode.

When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

### 2.1.6 Fusion of Chroma Intra Prediction Modes

The DM mode and the four default modes can be fused with the MMLM_LT mode as follows:

$$pred = ( w 0 * pred 0 + w 1 * pred 1 + ( 1 ≪ ( shift - 1 ) ) ) ≫ shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}.

For the syntax design, if a non-LM mode is selected, one flag is signaled to indicate whether the fusion is applied. This method only applies to I slices.

### 2.1.7 Intra Template Matching

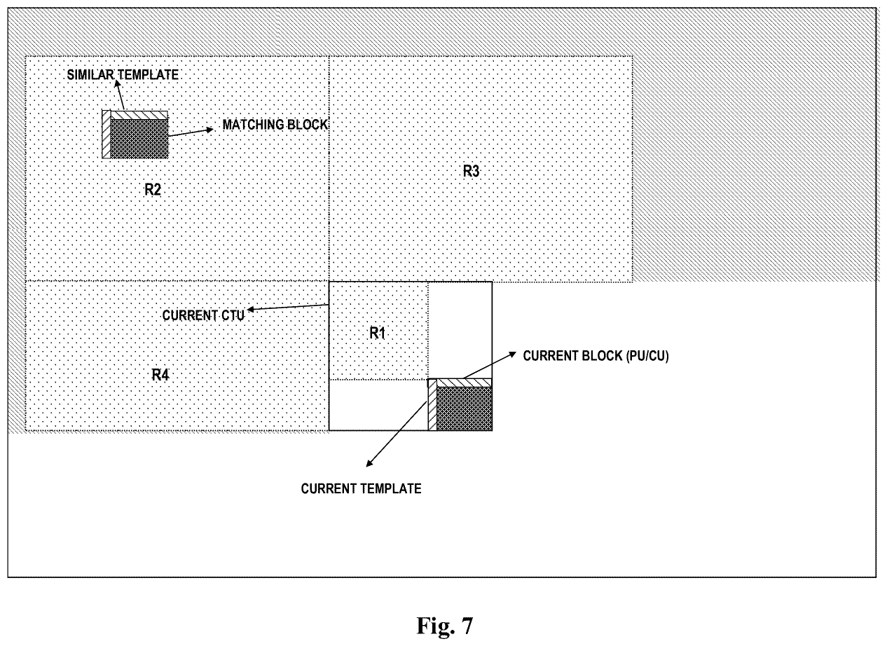

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side. The prediction signal is generated by matching the L-shaped causal neighbor of the current block with another block in a predefined search area in FIG. 7 consisting of:
R1: current CTU,
R2: top-left CTU,
R3: above CTU,
R4: left CTU.

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW ,$$

$$SearchRange\_h = a * BlkH .$$

Where ‘a’ is a constant that controls the gain/complexity trade-off. In practice, ‘a’ is equal to 5.

FIG. 7 illustrates an intra template matching search area used.

To speed-up the template matching process, the search range of all search regions is subsampled by a factor of 2. This leads to a reduction of template matching search by 4. After finding the best match, a refinement process is performed. The refinement is done via a second template matching search around the best match with a reduced range. The reduced range is defined as min(BlkW, BlkH)/2.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.1.7.1 IntraTMP Derived Block Vector Candidates for IBC

In this method block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

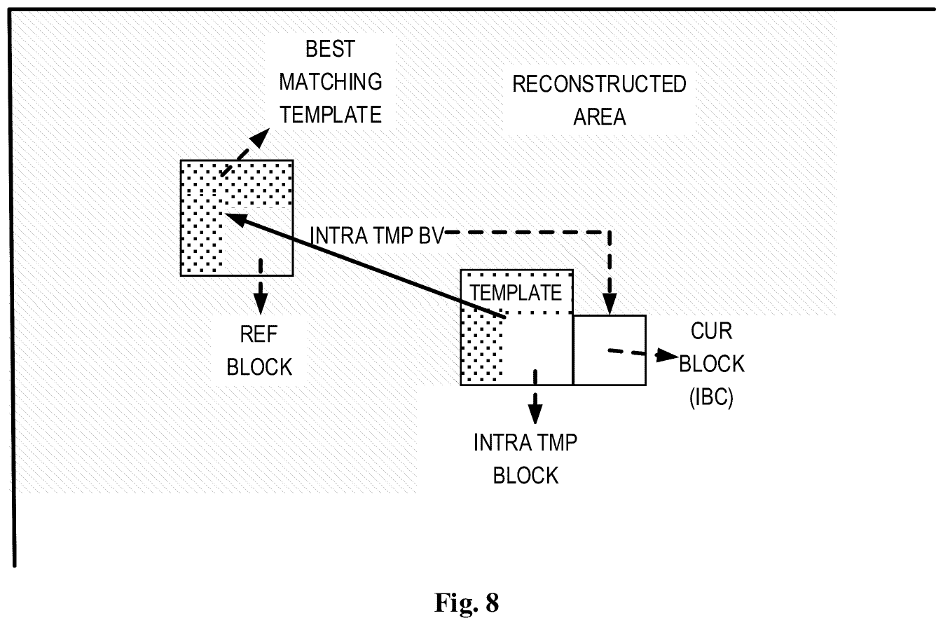

IntraTMP block vector is stored in the IBC block vector buffer and, the current IBC block can use both IBC BV and IntraTMP BV of neighbouring blocks as BV candidate for IBC BV candidate list as shown in FIG. 8.

FIG. 8 illustrates use of intraTMP block vector for IBC block.

IntraTMP block vectors are added to IBC block vector candidate list as spatial candidates.

### 2.1.8 Fusion for Template-Based Intra Mode Derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

$$costMode 2 < 2 * costMode 1.$$

If this condition is true, the fusion is applied, otherwise the only model is used.

Weights of the modes are computed from their SATD costs as follows:

$$weight 1 = costMode 2 / ( costMode 1 + costMode 2 ) ,$$

$$weight 2 = 1 - weight 1.$$

The division operations are conducted using the same lookup table (LUT) based integerization scheme used by the CCLM.

### 2.1.9 Intra Prediction Fusion

This intra prediction method derives predicted samples as a weighted combination of multiple predictors generated from different reference lines. In this process multiple intra predictors are generated and then fused by weighted averaging. The process of deriving the predictors to be used in the fusion process is described as follows:
For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ+1, where pₗᵢₙₑ is the intra prediction from the default reference line and pₗᵢₙₑ₊₁ is the prediction from the line above the default reference line. The weights are set as w₀=¾ and w₁=¼.
For TIMD mode with blending, pₗᵢₙₑ is used for the first mode (w₀=1, w₁=0) and pₗᵢₙₑ₊₁ is used for the second mode (w₀=0, w₁=1).
For DIMD mode with blending, the number of predictors selected for a weighted average is increased from 3 to 6.

Intra prediction fusion method is applied to luma blocks when angular intra mode has non-integer slope (required reference samples interpolation) and the block size is greater than 16, it is used with MRL and not applied for ISP coded blocks. In the method studied in the sub-test a, PDPC is applied for the intra prediction mode using the closest to the current block reference line.

### 2.1.10 Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

In addition, it is also proposed to modify the weights (wIntra, wInter) for the two tests if the derived intra prediction mode is an angular mode. For near-horizontal modes (2<=angular mode index <34), the current block is vertically divided; for near-vertical modes (34<=angular mode index <=66), the current block is horizontally divided.

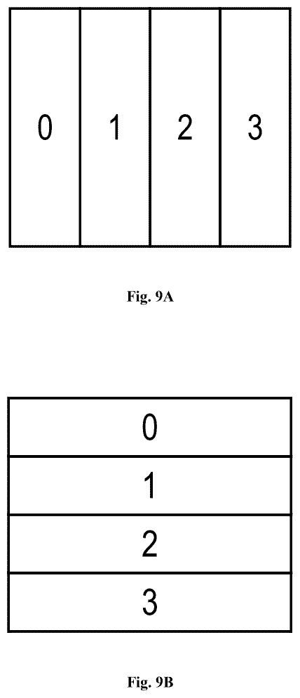

The (wIntra, wInter) for different sub-blocks are shown in FIG. 9A and FIG. 9B, which illustrate the division method for angular modes, respectively.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### 2.1.11 Extended Multiple Reference Line (MRL) List

MRL list in VVC is extended to include more reference lines for intra prediction. The extended reference line list consists of line indices {1, 3, 5, 7, 12}. For template-based intra mode derivation (TIMD), instead of the full MRL candidate list, only the first two reference line candidates, i.e., {1, 3}, are used.

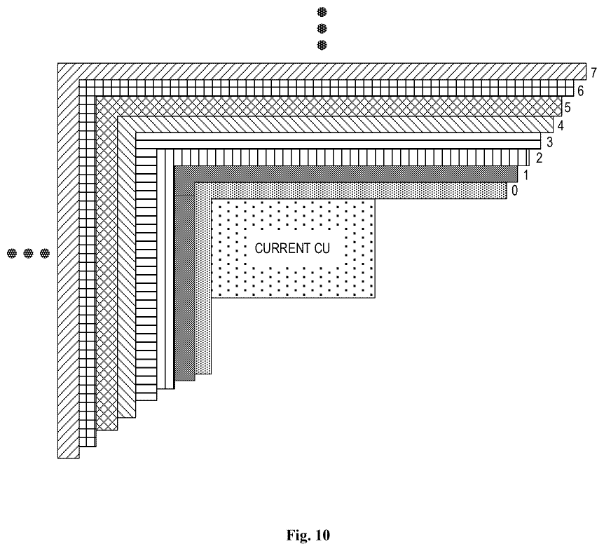

FIG. 10 illustrations an extended MRL candidate list.

### 2.1.12 Template-Based Multiple Reference Line Intra Prediction

Template-based multiple reference line intra prediction (TMRL) mode combines reference line and prediction mode together and uses a template matching method to construct a list of candidate combinations. An index to the candidate combination list is coded to indicate which reference line and prediction mode is used in coding the current block. The regular multiple reference line (MRL) for the non-TIMD part is replaced by TMRL mode.

The TMRL mode extends reference line candidate list and the intra-prediction-mode candidate list. The extended reference line candidate list is {1, 3, 5, 7, 12}. The restriction on the top CTU row is unchanged. The size of the intra-prediction-mode candidate list is 10. The construction of the intra-prediction-mode candidate list is similar to MPM except the PLANAR mode is excluded from the intra-prediction-mode candidate list, DC mode is added after 5 neighboring PUs' modes and DIMD modes if its not included and the angular modes with delta angles from ±1 to ±4 (compared the existing angular modes in the intra-prediction-mode candidate list) are added.

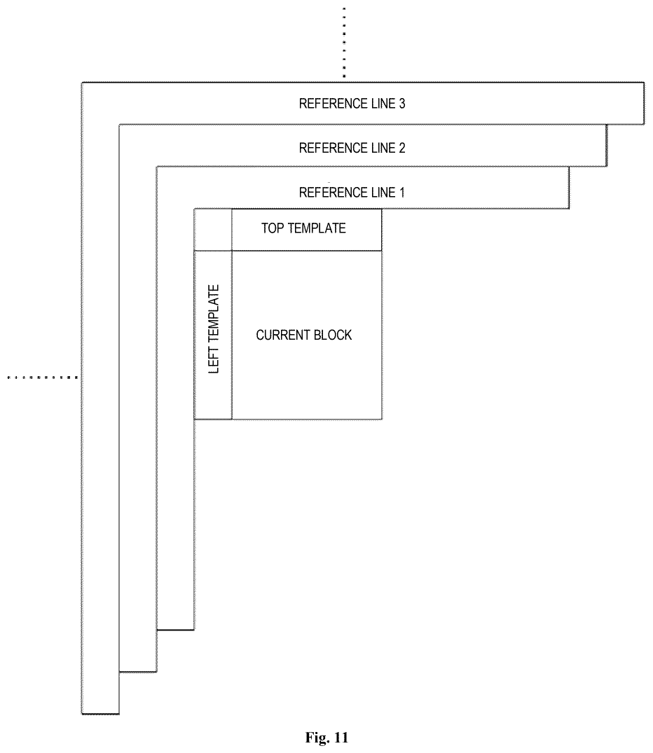

The TMRL candidate is constructed as follows. There are 5×10=50 combinations of the extended reference line and the allowed intra-prediction modes for a block. Since the extended reference line starts from reference line 1, the area covered by reference line 0 is used for template matching. The SAD costs over the template area (see FIG. 11) are calculated between the predictions (generated by 50 combinations) and the reconstructions. The 20 combinations with the least SAD cost are selected in an ascending order to form the TMRL candidate list.

FIG. 11 illustrates the template area.

For TMR signalling instead of coding the reference line and the intra mode directly, an index to the TMRL candidate list is coded to indicate which combination of reference line and prediction mode is used for coding the current block.

### 2.1.13 Convolutional Cross-Component Intra Prediction Model

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used. Similar to CCLM top, left or top and left reference samples are used as templates for model derivation.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.1.13.1 Convolutional Filter

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated below.

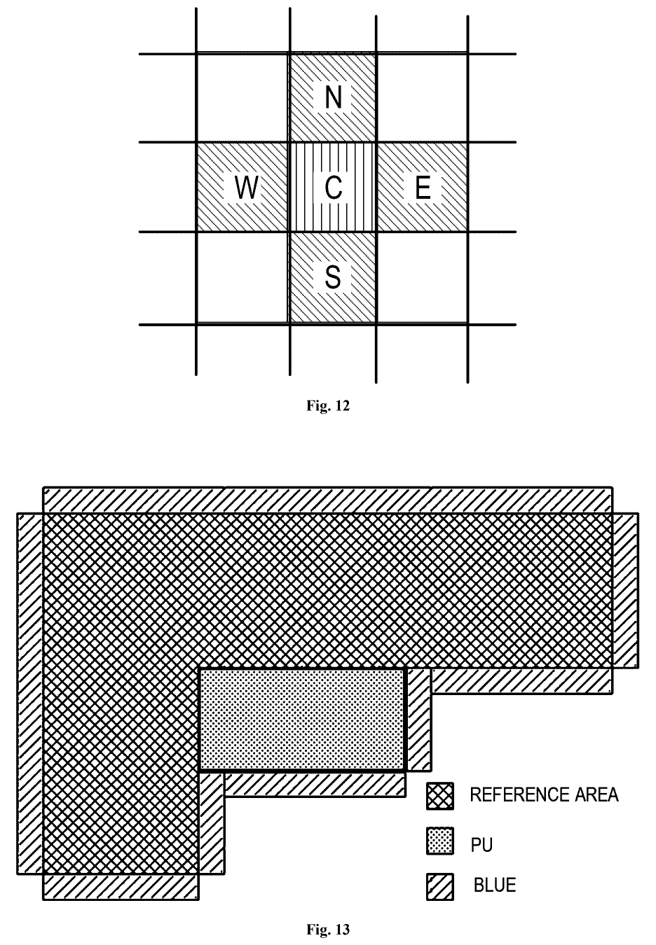

FIG. 12 illustrates a spatial part of the convolutional filter.

The nonlinear term P is represented as power of two of the center luma sample C and scaled to the sample value range of the content:

$$P = ( C * C + midVal ) ≫ bitDepth .$$

### That is, for 10-Bit Content it is Calculated as:

$$P = ( C * C + 512 ) >> 10.$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

### 2.13.2 Calculation of Filter Coefficients

The filter coefficients cᵢ are calculated by minimising MSE between predicted and reconstructed chroma samples in the reference area. FIG. 13 illustrates the reference area which consists of 6 lines of chroma samples above and left of the PU. Reference area extends one PU width to the right and one PU height below the PU boundaries. Area is adjusted to include only available samples. The extensions to the area are needed to support the “side samples” of the plus shaped spatial filter and are padded when in unavailable areas.

FIG. 13 illustrates a reference area (with its paddings) used to derive the filter coefficients.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

The autocorrelation matrix is calculated using the reconstructed values of luma and chroma samples. These samples are full range (e.g. between 0 and 1023 for 10-bit content) resulting in relatively large values in the autocorrelation matrix. This requires high bit depth operation during the model parameters calculation. It is proposed to remove fixed offsets from luma and chroma samples in each PU for each model. This is driving down the magnitudes of the values used in the model creation and allows reducing the precision needed for the fixed-point arithmetic. As a result, 16-bit decimal precision is proposed to be used instead of the 22-bit precision of the original CCCM implementation.

Reference sample values just outside of the top-left corner of the PU are used as the offsets (offsetLuma, offsetCb and offsetCr) for simplicity. The samples values used in both model creation and final prediction (i.e., luma and chroma in the reference area, and luma in the current PU) are reduced by these fixed values, as follows:

$${C}^{′} = C - offsetLuma ,$$

$${N}^{′} = N - offsetLuma ,$$

$${S}^{′} = S - offsetLuma ,$$

$${E}^{′} = E - offsetLuma ,$$

$${W}^{′} = W - offsetLuma ,$$

$${P}^{′} = nonLinear ( {C}^{′} ) ,$$

$$B = midValue = 1 << ( bitDepth - 1 ) ,$$

and the chroma value is predicted using the following equation, where offsetChroma is equal to offsetCr and offsetCb for Cr and Cb components, respectively:

$$predChromaVal = {c}_{0} {C}^{′} + {c}_{1} {N}^{′} + {c}_{2} {S}^{′} + {c}_{3} {E}^{′} + {c}_{4} {W}^{′} + {c}_{5} {P}^{′} + {c}_{6} B + offsetChroma .$$

In order to avoid any additional sample level operations, the luma offset is removed during the luma reference sample interpolation. This can be done, for example, by substituting the rounding term used in the luma reference sample interpolation with an updated offset including both the rounding term and the offsetLuma. The chroma offset can be removed by deducting the chroma offset directly from the reference chroma samples. As an alternative way, impact of the chroma offset can be removed from the cross-component vector giving identical result. In order to add the chroma offset back to the output of the convolutional prediction operation the chroma offset is added to the bias term of the convolutional model.

The process of CCCM model parameter calculation requires division operations. Division operations are not always considered implementation friendly. The division operation are replaced with multiplication (with a scale factor) and shift operation, where scale factor and number of shifts are calculated based on denominator similar to the method used in calculation of CCLM parameters.

### 2.1.13.3 Gradient Linear Model

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β .$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β .$$

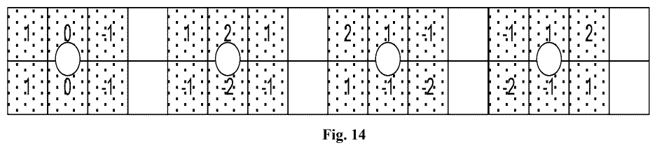

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation.
Four gradient filters are enabled for the GLM, as illustrated in FIG. 14. FIG. 14 illustrates four Sobel based gradient patterns for GLM.

### 2.1.13.4 Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.

### 2.1.14 Spatial Geometric Partitioning Mode (SGPM)

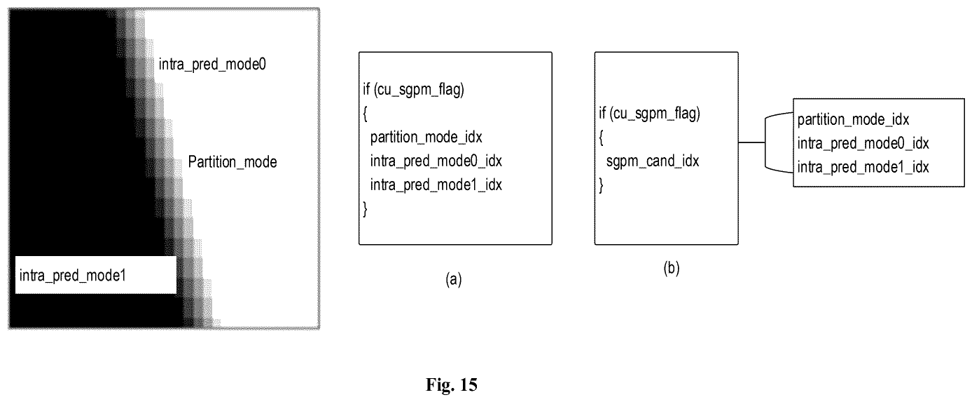

SGPM is an intra mode that resembles the inter coding tool of GPM, where the two prediction parts are generated from intra predicted process. In this mode, a candidate list is built with each entry containing one partition split and two intra prediction modes as shown in FIG. 15. 26 partition modes and 3 of intra prediction modes are used to form the combinations, the length of the candidate list is set equal to 16. The selected candidate index is signalled.

FIG. 15 illustrates spatial GPM candidates.

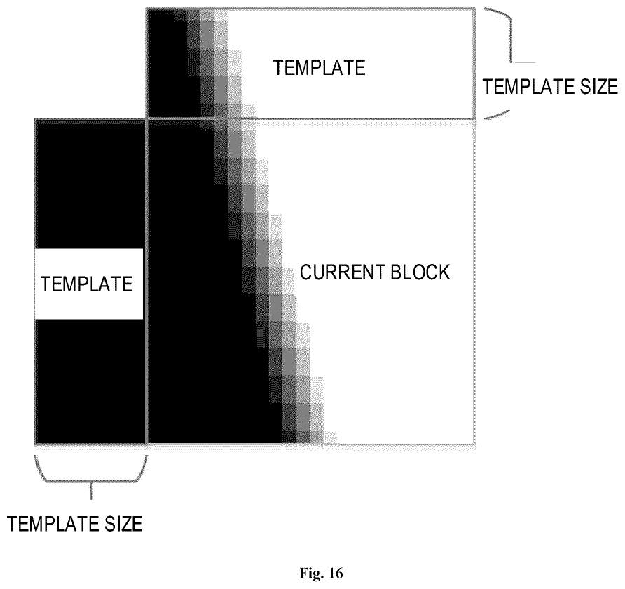

The list is reordered using template (FIG. 16) where SAD between the prediction and reconstruction of the template is used for ordering. The template size is fixed to 1.

FIG. 16 illustrates GPM template.

For each partition mode, an IPM list is derived for each part using the same intra-inter GPM list derivation. The IPM list size is set to 3. In the list, TIMD derived mode is replaced by 2 derived modes with horizontal and vertical orientations.

The SGPM mode is applied with a restricted blocks size: 4<=width<=64, 4<=height<=64, width<height*8, height<width*8, width*height>=32.

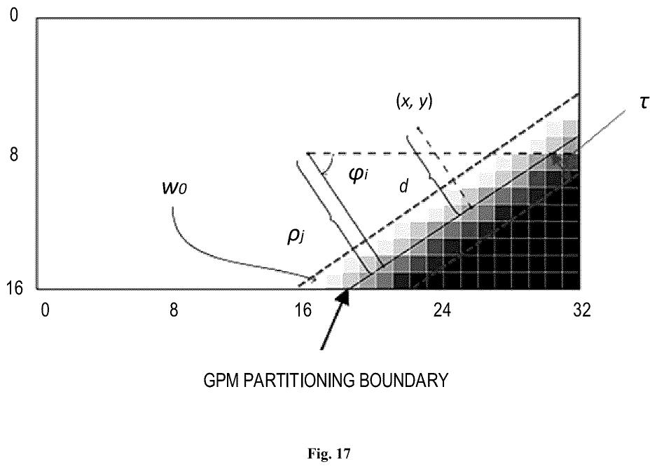

Adaptive blending is also used for spatial GPM, where blending depth r shown in FIG. 17 is derived as follows:
If min(width, height)==4, ½ π is selected.
else if min(width, height)==8, π is selected.
else if min(width, height)==16, 2 π is selected.
else if min(width, height)==32, 4 π is selected.
else, 8 π is selected.

FIG. 17 illustrates GPM blending.

### 2.1.15 Non-Local Cross-Component Prediction

Cross-component prediction (CCP) including CCLM, CCCM and their variants are adopted in ECM to exploit the cross-component correlation. With CCLM or CCCM, Training samples are always adjacent to the current block. However, the cross-component relationship of the current block may be more correlated to that of a non-local region.

Methods of non-local cross-component prediction are proposed to boost CCP by taking more advantage from non-local regions.

### Method #1:

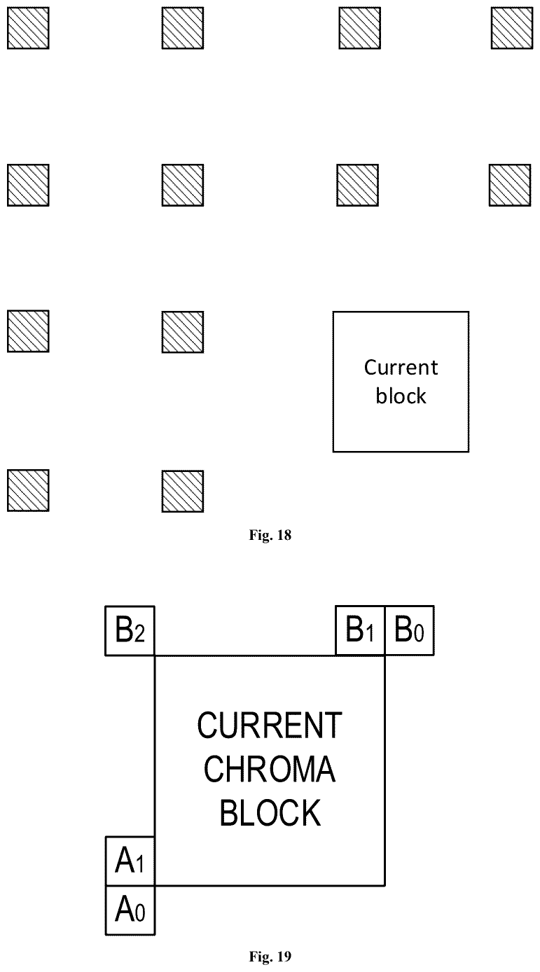

Non-adjacent cross-component prediction (NA-CCP) mode is proposed. With NA-CCP mode, Samples in regions non-adjacent to the current block can be used to derive a CCCM model for the current block. A candidate region list with 6 candidates is constructed by checking potential 8×8 regions in order. If a checked region is available, it is put into the candidate region list. The top-left positions of the potential 8×8 regions are predetermined as {(−xStep, 0), (0, −yStep), (xStep, −yStep), (−xStep, yStep), (−xStep, −yStep), (−2*xStep, 0), (0, −2*yStep), (−2*xStep,2*yStep), (2*xStep, −2*yStep), (−2*xStep, yStep), (xStep, −2*yStep), (−2*xStep, −yStep), (−xStep, −2*yStep), (−2*xStep, −2*yStep), (−xStep/2, 0), (0, −yStep/2), (xStep/2, −yStep/2), (−xStep/2, yStep/2), (−xStep/2, −yStep/2)}, where xStep=Max(width, 16), yStep=Max(height, 16). FIG. 18 show some possible positions of candidate regions.

A flag is signaled to indicate whether NA-CCP is applied to a chroma block. If NA-CCP is applied, an index is signaled to indicate which candidate in the candidate region list is used to derive the CCCM model.

### Method #2:

History-based cross-component prediction (H-CCP) mode is proposed. With H-CCP, a H-CCLM table and a H-CCCM table are maintained similar to the HMVP table. After decoding a CCLM or CCCM coded block, the corresponding table is updated. In the implementation of H-CCP, the size of either H-CCLM table or H-CCCM table is 6. If the current block is coded with CCLM or CCCM mode, a flag is signaled to indicate whether H-CCP is applied. If H-CCP is used, an index is further signaled to indicate which candidate model in the H-CCLM table or H-CCCM table is selected.

### 2.1.16 Cross-Component Merge Mode for Chroma Intra Coding

Cross-component prediction (CCP) including cross-component linear model (CCLM), convolutional cross-component model (CCCM), and gradient linear model (GLM) are adopted in ECM to exploit the cross-component correlation. A cross-component merge (CCMerge) mode is proposed as a new CCP mode. Cross component model parameters of the current chroma block coded with CCMerge can be inherited from a neighboring block coded with CCP. Through CCMerge, CCP can be more efficient with less signalling overhead.

In CCMerge, final cross-component model parameters of the current chroma block can be inherited from its spatial adjacent and non-adjacent neighbors, or default models. A list is created, which includes CCP models from the spatial adjacent and non-adjacent neighbors coded in CCLM, MMLM, CCCM, GLM, chroma fusion, and CCMerge modes. After including neighboring CCP models, default models are further included to fill the remaining empty positions in the list. To avoid including redundant CCP models in the list, pruning operations are applied. More details are described as follows.

FIG. 19 illustrates positions of the adjacent spatial candidates.
Spatial adjacent neighboring candidates

Positions of the spatial adjacent candidates are shown in FIG. 19. Spatial candidates are included in the following order: B1→A1→B0→A0→B2.
Spatial non-adjacent neighboring candidates

Spatial non-adjacent neighboring candidates are considered after all spatial adjacent neighbors are checked. In the current ECM design, in inter merge mode, two sets of spatial non-adjacent neighboring candidates are obtained. In the proposed method, positions and inclusion order of the spatial non-adjacent neighboring candidates from the first set are used.
CCLM candidates with default scaling parameters

CCLM candidates with default scaling parameters are considered after including the spatial adjacent and non-adjacent candidates if the list is not full. The default scaling parameters are {0, ⅛, −⅛, 2/8, − 2/8, ⅜}, and the offset parameter is derived according to the selected default scaling parameter, average neighboring reconstructed luma sample value (Yavg), and average neighboring reconstructed Cb/Cr sample value (Cavg).

### 2.1.16.1 Merging Model Candidates

When merging a CCLM candidate, only the scaling parameter is inherited. The offset parameter is derived by using the inherited scaling parameter, Yavg and Cavg.

When merging a MMLM candidate, the scaling parameters and the classification threshold are inherited. The offset parameter in each class is derived according to the inherited classification threshold and the Yavg and Cavg in each class. If no neighboring reconstructed samples are available in a class, the offset parameter is directly inherited from the candidate.

When merging a CCCM candidate, all convolution parameters, offsets (i.e., offsetLuma, offsetCb, and offsetCr), and the classification threshold are inherited.

When merging a GLM candidate, if the GLM candidate is 3-parameter GLM mode, all the gradient pattern index and model parameters are inherited; otherwise, if the GLM candidate is the 2-parameter GLM mode, the offset parameter is derived by using the inherited scaling parameter, Yavg, and Cavg.

When merging a chroma fusion candidate, the derived MMLM parameters are inherited and used as merging MMLM candidate.

For a CCMerge block, if its merging candidate mode is CCLM, MMLM, CCCM, or GLM, the merging candidate mode is stored as the propagation mode of the current chroma block; otherwise, if its merging candidate mode is chroma fusion, the propagation mode is set to MMLM. When merging a CCMerge candidate, how to inherit or derive the CCP parameters depends on the propagation mode of the CCMerge candidate, as described in the above five paragraphs.

### 2.1.16.2 Signaling

An additional flag is signalled indicating whether CCMerge is used or not after cclm_mode_flag syntax element. If CCMerge is used, a candidate index is additionally signalled. The signalled candidate index is shared for Cb/Cr color components. Currently, the maximum number of allowed candidates is set to 6 as default. If maximum number of allowed candidates is modified to 1, candidate index does not need to be signalled. Each bin of candidate index is context coded with a separate context.

### 2.1.17 Directional Planar Mode

Two additional planar modes where only the horizontal interpolation or only the vertical interpolation are used to obtain the predicted samples.

For planar horizontal mode, only the horizontal linear interpolation is performed based on the left reference sample and the top-right reference sample to predict the current sample as:

$$pred ( x , y ) = ( ( W - 1 - x ) * rec ( - 1 , y ) + ( x + 1 ) * rec ( W , - 1 ) + ( W >> 1 ) ) >> {log}_{2} ( W ) .$$

For planar vertical mode, only the vertical linear interpolation is performed based on the above reference sample and the bottom-left reference sample to predict the current sample as:

$$pred ( x , y ) = ( ( H - 1 - y ) * rec ( x , - 1 ) + ( y + 1 ) * rec ( - 1 , H ) + ( H >> 1 ) ) >> {log}_{2} ( H ) .$$

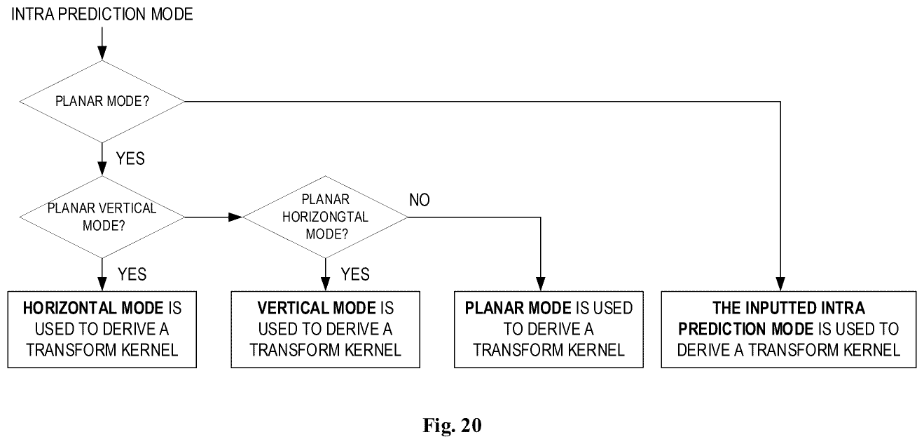

The transform kernel selection for planar horizontal and planar vertical mode is shown in FIG. 20. If an intra prediction mode of a current block is the planar vertical mode, the horizontal intra prediction mode is used to derive a transform kernel in MTS set and LFNST set. Also, if an intra prediction mode of a current block is the planar horizontal mode, the vertical intra prediction mode is used to derive a transform kernel in MTS set and LFNST set.

FIG. 20 illustrates a transform selection process for directional planar modes.

### 2.1.18 Direct Block Vector for Chroma Block

The direct block vector is used for chroma block in dual tree slices. When chroma dual tree is activated, a flag is signaled to indicate whether a chroma block is coded using IBC mode. If one of the luma blocks in five locations shown in FIG. 21 is coded with IBC or intraTMP mode, its block vector is scaled and is used as block vector for the chroma block. Template matching is used to perform block vector scaling.

FIG. 21 illustrates luma blocks used to derive direct block vector.

### 2.1.19 an Extrapolation Filter-Based Intra Prediction Mode (EFI Mode)

The proposed extrapolation filter-based intra prediction is processed in two steps. First, the extrapolation filter coefficients are obtained from the neighboring reconstructed pixels of the current block with a predetermined template. Second, the extrapolation generates a predicted value position by position from top-left to bottom-right within the current block.

### 2.1.19.1 Searching Mean, Min, and Max Value

Similar to CCCM mode, a mean value should be removed when feeding the inputs to the EIP filter. The value of the DC mode for the current block is used as a mean value for EIP prediction. The min and max value are searched from reconstructed pixels in the reconstructed area with thirteen columns and thirteen rows.

### 2.1.19.2 Calculation of Filter Coefficients

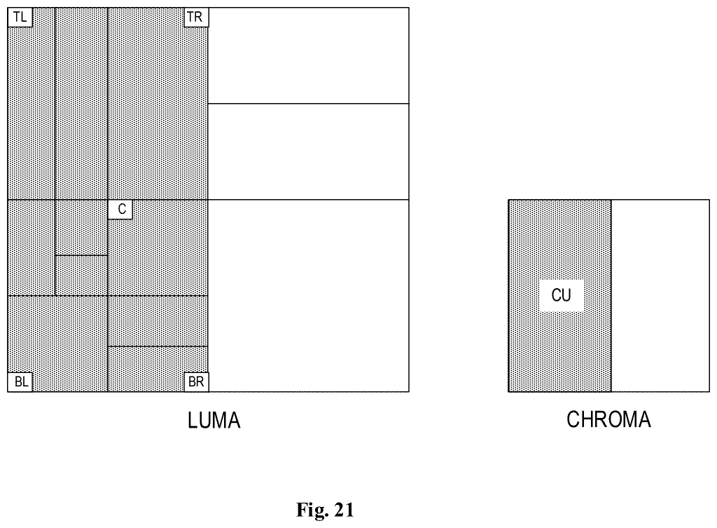

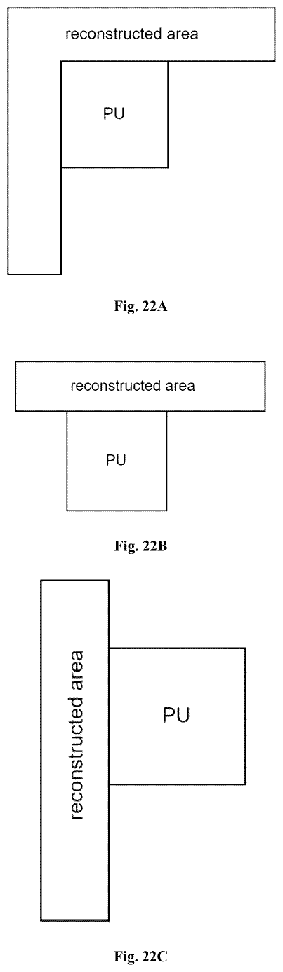

Three types of reconstructed areas and three filter shapes are proposed, as shown in FIG. 22A to FIG. 22C. The defined three types of reconstructed areas include thirteen columns or rows of reconstructed pixels. When the current block uses the proposed EIP mode for prediction, the decoder decodes the relevant syntax elements to determine the selected type of reconstructed area and filter shape for the current block.

FIG. 22A to FIG. 22C illustrate the defined three types of reconstructed areas include thirteen columns or rows of reconstructed pixels, respectively.

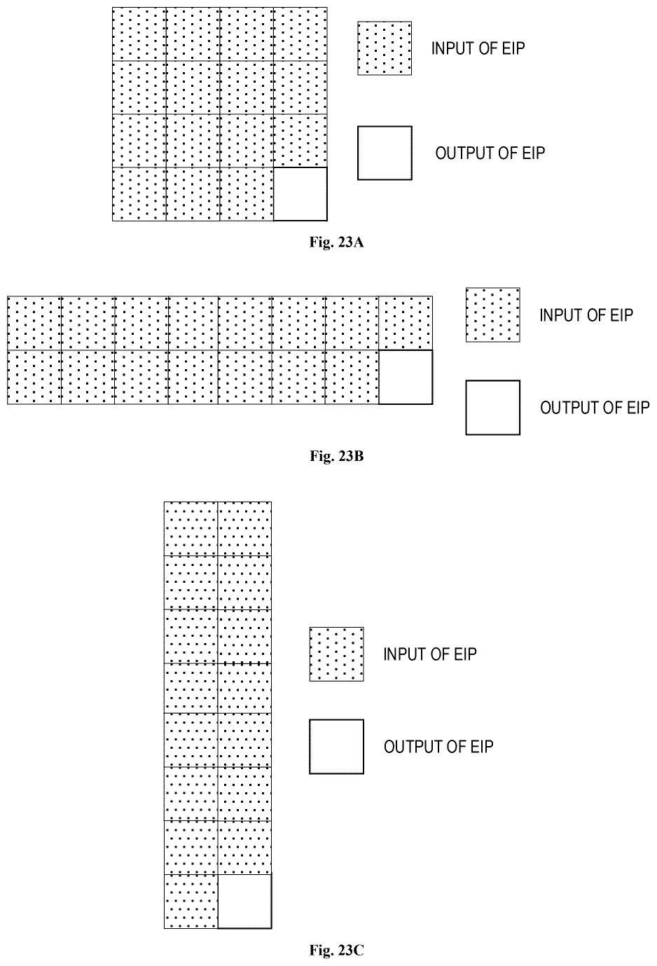

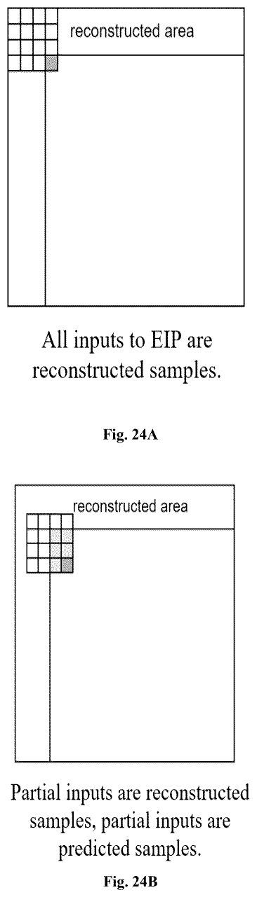

FIG. 23A to FIG. 23C illustrate the defined three types of filter shapes have fifteen inputs and generate one output, respectively.

The selected filter slides in the selected reconstructed area with a one-pixel step to collect input samples and output samples of EIP. The auto-correlation matrix and cross-correlation vector are constructed while removing the mean value from input samples and output samples. Then, the EIP coefficients are obtained by the same method in CCCM.

### 2.1.19.3 Prediction of Current Block

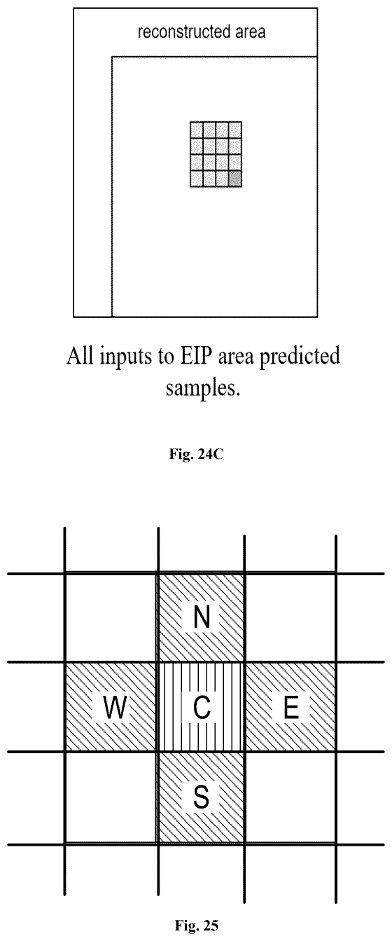

The EIP mode makes predictions for the current block position by position, as shown in FIG. 24A to FIG. 24C.

For the position located at top-left of the current block, the inputs to the EIP filter are reconstructed samples.

For the positions located along the boundaries of the current block, partial inputs to the EIP filter are reference samples, and partial inputs to the EIP filter are previously predicted samples.

For other positions in the current block, the inputs to the EIP filter are previously predicted samples.

FIG. 24A to FIG. 24C illustrate prediction for different positions in the current block, respectively. FIG. 24A corresponds to that all inputs to EIP are reconstructed samples. FIG. 24B corresponds to that partial inputs are reconstructed samples, partial inputs are predicted samples. FIG. 24C corresponds to that all inputs to EIP area predicted samples.
To reduce the prediction error, the searched min and max values are applied to restrict the output range of each predicted value,

$${pred}_{( x , y )} = clip ( min , max , ( {\sum }_{i = 0}^{n} ( {c}_{i} \times ( {t}_{x - xoffset , y - yoffset )} - mean ) ) ) + mean ) ,$$

pred_{(x,y)} is the predicted value at (x, y) in the current block,
min, max are searched min and max values from the thirteen reconstructed columns and rows,
cᵢ is the i^{th} coefficient of the derived EIP filter,
t_{(x-xoffset,y-yoffset)} is reconstructed or predicted value used for the current position's prediction, mean is a value calculated by the DC prediction mode.

### 2.1.20 IntraTMP Based on Linear Filter Model

The proposed 6-tap filter consist of a 5-tap plus sign shape spatial component and a bias term. The input to the spatial 5-tap component of the filter consists of a center (C) sample in the reference block which is at corresponding locations with the sample in the current block to be predicted and its above/north (N), below/south (S), left/west (W) and right/east (E) neighbors as illustrated below.

FIG. 25 illustrates a spatial part of the filter.

The bias term B represents a scalar offset between the input and output and is set to middle luma value (512 for 10-bit content).

### Output of the Filter is Calculated as Follows:

$$predLumaVal = c 0 C + c 1 N + c 2 S + c 3 E + c 4 W + c 5 B .$$

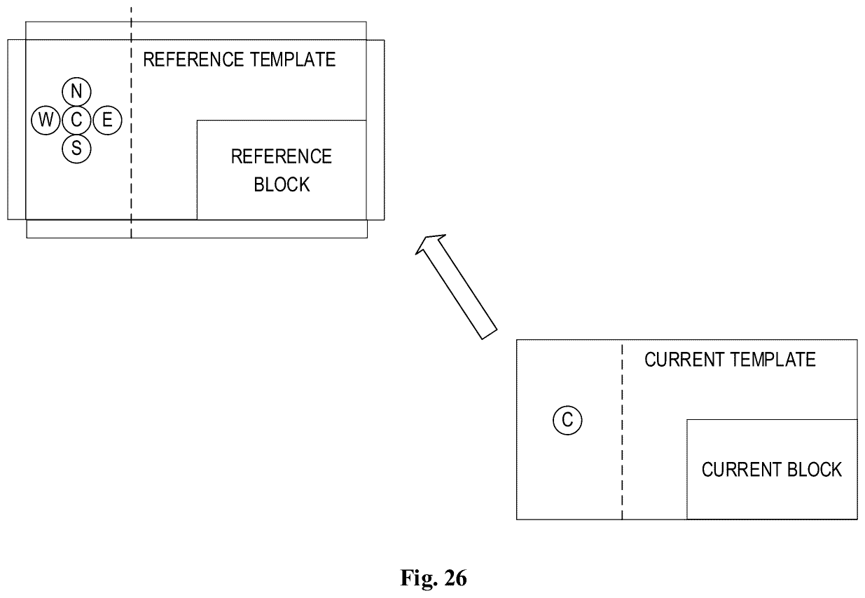

The filter coefficients ci are calculated by minimising the MSE between the reference template and current template, as shown in FIG. 26. The extensions to the area needed to support the “side samples” of the plus shaped spatial filter and are padded when in unavailable areas.

FIG. 26 illustrates reference area used to derive the filter coefficients.

The MSE minimization is performed by calculating autocorrelation matrix for the reference template input and current template output. Autocorrelation matrix is LDL decomposed and the final filter coefficients are calculated using back-substitution.

Usage of the Intra TMP-FLM mode is signalled coded CU level flag. Specifically, Intra TMP-FLM is considered a sub-mode of Intra TMP. That is, Intra TMP-FLM flag is only signalled if Intra TMP flag is true.

### 2.1.21 Filtered Intra Block Copy (FIBC)

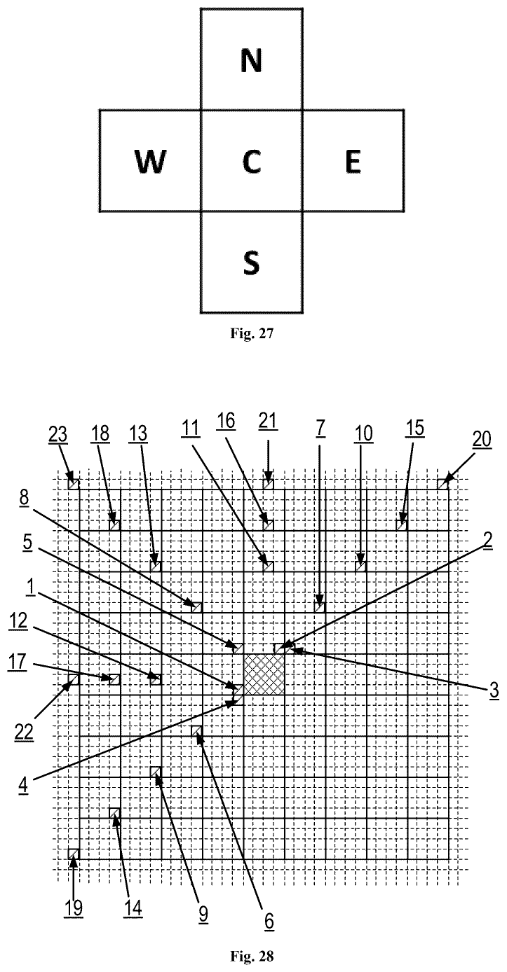

Filtered IBC (FIBC) is proposed which applies one linear filter to the prediction samples of the IBC. As shown in FIG. 27, the proposed filter consists of five spatial terms and a bias term. The five spatial terms consist of a center (C) position and its above/north (N), below/south (S), left/west (W) and right/east (E) neighbors.

$$preVal = {α}_{0} \cdot C + {α}_{1} \cdot N + {α}_{2} \cdot S + {α}_{3} \cdot W + {α}_{4} \cdot E + {α}_{5} \cdot β .$$

FIG. 27 illustrates a filter shape.
where aᵢ is the coefficient and β is the offset. Up to 4 lines/columns of samples above and left to the current CU are applied to derive the filter coefficients. The filter coefficients are derived based on the minimization of the difference between the template samples and their corresponding reference samples via the same regression-based minimization technique in the ECM that is used by other tools such as CCCM.

For the signaling, one extra indication flag is introduced for the FIBC which is signaled after the IBC-LIC flag. Specifically, when the IBC-LIC flag is true, the flag is signaled and used to indicate whether the FIBC is applied to the current block or not.

### 2.1 Inter and IBC Prediction

### 2.2.1 Local Illumination Compensation (LIC)

LIC is an inter prediction technique to model local illumination variation between current block and its prediction block as a function of that between current block template and reference block template. The parameters of the function can be denoted by a scale α and an offset β, which forms a linear equation, that is, α*p[x]+β to compensate illumination changes, where p[x] is a reference sample pointed to by MV at a location x on reference picture. When wrap around motion compensation is enabled, the MV shall be clipped with wrap around offset taken into consideration. Since α and β can be derived based on current block template and reference block template, no signaling overhead is required for them, except that an LIC flag is signaled for AMVP mode to indicate the use of LIC.

The local illumination compensation is used for uni-prediction inter CUs with the following modifications.
Intra neighbor samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.

### 2.2.2 Non-Adjacent Spatial Candidate

The non-adjacent spatial merge candidates are inserted after the TMVP in the regular merge candidate list. The pattern of spatial merge candidates is shown in FIG. 28. The distances between non-adjacent spatial candidates and current coding block are based on the width and height of current coding block. The line buffer restriction is not applied.

FIG. 28 illustrates spatial neighboring blocks used to derive the spatial merge candidates.

### 2.2.3 Template Matching (TM)

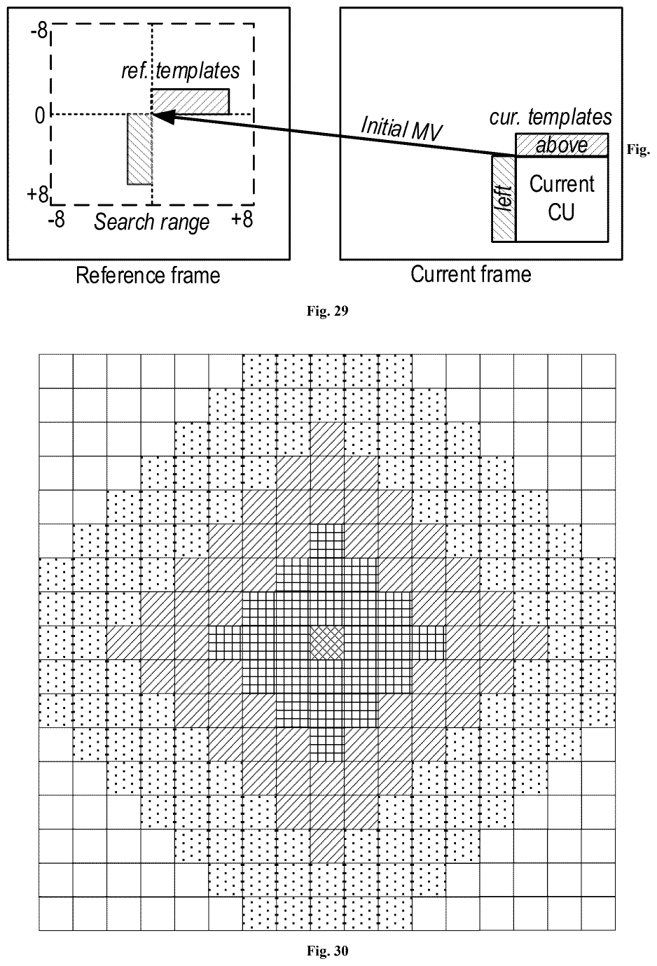

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. As illustrated in FIG. 29, a better MV is searched around the initial motion of the current CU within a [−8, +8]-pel search range. The template matching method is used with the following modifications: search step size is determined based on AMVR mode and TM can be cascaded with bilateral matching process in merge modes.

FIG. 29 illustrates template matching performs on a search area around initial MV.

In AMVP mode, an MVP candidate is determined based on template matching error to select the one which reaches the minimum difference between the current block template and the reference block template, and then TM is performed only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 2. This search process ensures that the MVP candidate still keeps the same MV precision as indicated by the AMVR mode after TM process. In the search process, if the difference between the previous minimum cost and the current minimum cost in the iteration is less than a threshold that is equal to the area of the block, the search process terminates.

TABLE 2
Search patterns of AMVR and merge mode with AMVR.

| | AMVR mode | | | | | |
|---|---|---|---|---|---|---|
| Search | | Full- | Half- | Quarter- | Merge mode | |
| pattern | 4-pel | pel | pel | pel | AltIF = 0 | AltIF = 1 |
| 4-pel diamond | v | | | | | |
| 4-pel cross | v | | | | | |
| Full-pel | | v | v | v | v | v |
| diamond | | | | | | |
| Full-pel cross | | v | v | v | v | v |
| Half-pel cross | | | v | v | v | v |
| Quarter-pel | | | | v | v | |
| cross | | | | | | |
| ⅛-pel cross | | | | | v | |

In merge mode, similar search method is applied to the merge candidate indicated by the merge index. As Table 2 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

### 2.2.4 Multi-Pass Decoder-Side Motion Vector Refinement

A multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### 2.2.4.1 First Pass—Block Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, mean-removal SAD (MRSAD) cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV 0\_pass1 = MV 0 + deltaMV ,$$

$$MV 1\_pass1 = MV 1 - deltaMV .$$

### 2.2.4.2 Second Pass—Subblock Based Bilateral Matching MV Refinement

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2(sbIdx2) and MV1_pass2(sbldx2)) are derived based on the minimum bilateral matching cost between the two reference subblocks in L0 and L1.

For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions shown on FIG. 30. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region.

When the minimum bilCost within the current search region is less than a threshold equal to sbW*sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

FIG. 30 illustrates diamond regions in the search area.

The existing VVC DMVR fractional sample refinement is further applied to derive the final deltaMV(sbldx2). The refined MVs at second pass is then derived as:

$$MV0\_pass2 ( sbIdx 2 ) = MV0\_pass1 + deltaMV ( sbIdx 2 ) ,$$

$$MV1\_pass2 ( sbIdx 2 ) = MV1\_pass1 - deltaMV ( sbIdx 2 ) .$$

### 2.2.4.3 Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3(sbldx3) and MV1_pass3(sbIdx3)) at third pass are derived as:

$$MV0\_pass3 ( sbIdx 3 ) = MV0\_pass2 ( sbIdx 2 ) + bioMv ,$$

$$MV1\_pass3 ( sbIdx 3 ) = MV0\_pass2 ( sbIdx 2 ) - bioMv .$$

In all aforementioned sub-clauses, when wrap around motion compensation is enabled, the motion vectors shall be clipped with wrap around offset taken into consideration.

### 2.2.5 Adaptive Decoder-Side Motion Vector Refinement

Adaptive decoder side motion vector refinement method is an extension of multi-pass DMVR which consists of the two new merge modes to refine MV only in one direction, either L0 or L1, of the bi-prediction for the merge candidates that meet the DMVR conditions. The multi-pass DMVR process is applied for the selected merge candidate to refine the motion vectors, however either MVD0 or MVD1 is set to zero in the 1^{st} pass (i.e., PU level) DMVR.

The merge candidates for the new merge mode are derived from spatial neighboring coded blocks, TMVPs, non-adjacent blocks, HMVPs, pair-wise candidate, similar as in the regular merge mode. The difference is that only those meet DMVR conditions are added into the candidate list. The same merge candidate list is used by the two new merge modes. If the list of BM candidates contains the inherited BCW weights and DMVR process is unchanged except the computation of the distortion is made using MRSAD or MRSATD if the weights are non-equal and the bi-prediction is weighted with BCW weights. Merge index is coded as in regular merge mode.

### 2.2.6 OBMC

When OBMC is applied, top and left boundary pixels of a CU are refined using neighboring block's motion information with a weighted prediction.
Conditions of not applying OBMC are as follows:
When OBMC is disabled at SPS level.
When current block has intra mode or IBC mode.
When current block applies LIC.
When current luma block area is smaller or equal to 32.

A subblock-boundary OBMC is performed by applying the same blending to the top, left, bottom, and right subblock boundary pixels using neighboring subblocks' motion information. It is enabled for the subblock based coding tools:
Affine AMVP modes;
Affine merge modes and subblock-based temporal motion vector prediction (SbTMVP);
Subblock-based bilateral matching.

When OBMC mode is used in CIIP mode with LMCS, inter blending is performed prior to LMCS mapping of inter samples. LMCS is applied to blended inter samples which are combined with LMCS applied intra samples in CIIP mode,

$${Inter}_{predY}^{′} = \frac{( 128 - {w}_{1} ) \times {Inter}_{predY} + {w}_{1} \times {OBMC}_{predY}}{128} ,$$

$$PredY = \frac{( 4 - {w}_{0} ) \times FwdMap ( {Inter}_{predY}^{′} ) + {w}_{0} \times {Intra}_{predY}}{4} ,$$

where Inter_{predY} represents the samples predicted by the motion of current block in the original domain, Intra_{predY} represents the samples predicted in the mapped domain, OBMC_{predY} represents the samples predicted by the motion of neighboring blocks in the original domain, and w₀ and w₁ are the weights.

### 2.2.7 Template Matching Based OBMC

In template matching based OBMC scheme, instead of directly using the weighted prediction, the prediction value of CU boundary samples derivation approach is decided according to the template matching costs, including using current block's motion information only, or using neighboring block's motion information as well with one of the blending modes.

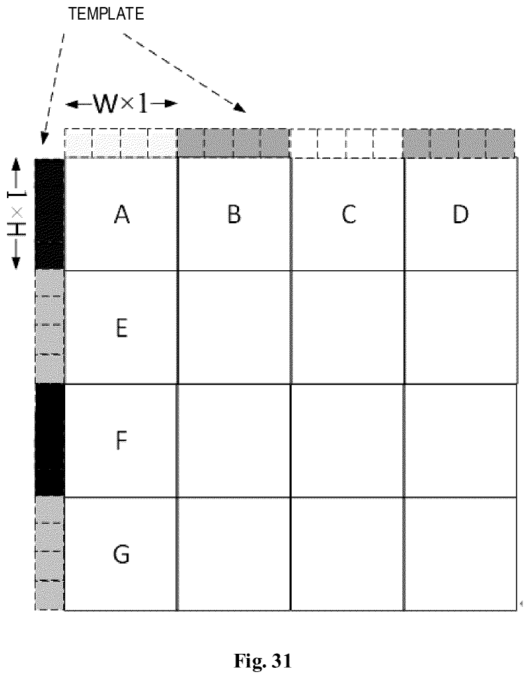

In this scheme for each block with a size of 4×4 at the top CU boundary, the above template size equals to 4×1. If N adjacent blocks have the same motion information, then the above template size is enlarged to 4N×1 since the MC operation can be processed at one time. For each left block with a size of 4×4 at the left CU boundary, the left template size equals to 1×4 or 1×4N (FIG. 31).

FIG. 31 illustrates a template.

For each 4×4 top block (or N4×4 blocks group), the prediction value of boundary samples is derived following the below steps.

Take block A as the current block and its above neighboring block AboveNeighbor_A for example. The operation for left blocks is conducted in the same manner.

First, three template matching costs (Cost1, Cost2, Cost3) are measured by SAD between the reconstructed samples of a template and its corresponding reference samples derived by MC process according to the following three types of motion information:
Cost1 is calculated according to A's motion information.
Cost2 is calculated according to AboveNeighbor_A's motion information.
Cost3 is calculated according to weighted prediction of A's andAboveNeighbor_A's motion information with weighting factors as ¾ and ¼ respectively.

Second, choose one approach to calculate the final prediction results of boundary samples by comparing Cost1, Cost2 and Cost 3.

The original MC result using current block's motion information is denoted as Pixel1, and the MC result using neighboring block's motion information is denoted as Pixel2. The final prediction result is denoted as NewPixel.
If Cost1 is minimum, then NewPixel(i, j)=Pixel1(i, j).
If (Cost2+(Cost2>>2)+(Cost2>>3))<=Cost1, then blending mode 1 is used.

For luma blocks, the number of blending pixel rows is 4.

$$NewPixel ( i , 0 ) = ( 26 \times Pixel 1 ( i , 0 ) + 6 \times Pixel 2 ( i , 0 ) + 16 ) ≫ 5 ,$$

$$NewPixel ( i , 1 ) = ( 7 \times Pixel 1 ( i , 1 ) + Pixel 2 ( i , 1 ) + 4 ) ≫ 3 ,$$

$$NewPixel ( i , 2 ) = ( 15 \times Pixel 1 ( i , 2 ) + Pixel 2 ( i , 2 ) + 8 ) ≫ 4 ,$$

$$NewPixel ( i , 3 ) = ( 31 \times Pixel 1 ( i , 3 ) + Pixel 2 ( i , 3 ) + 16 ) ≫ 5.$$

For chroma blocks, the number of blending pixel rows is 1.

$$NewPixel ( i , 0 ) = ( 26 \times Pixel 1 ( i , 0 ) + 6 \times Pixel 2 ( i , 0 ) + 16 ) ≫ 5.$$

For luma blocks, the number of blending pixel rows is 2.

$$NewPixel ( i , 0 ) = ( 15 \times Pixel 1 ( i , 0 ) + Pixel 2 ( i , 0 ) + 8 ) ≫ 4 ,$$

$$NewPixel ( i , 1 ) = ( 31 \times Pixel 1 ( i , 1 ) + Pixel 2 ( i , 1 ) + 16 ) ≫ 5.$$

For chroma blocks, the number of blending pixel rows/columns is 1.

$$NewPixel ( i , 0 ) = ( 15 \times Pixel 1 ( i , 0 ) + Pixel 2 ( i , 0 ) + 8 ) ≫ 4.$$

Otherwise, blending mode 3 is used.

For luma blocks, the number of blending pixel rows is 4.

$$NewPixel ( i , 1 ) = ( 7 \times Pixel 1 ( i , 1 ) + Pixel 2 ( i , 1 ) + 4 ) ≫ 3 ,$$

$$NewPixel ( i , 2 ) = ( 15 \times Pixel 1 ( i , 2 ) + Pixel 2 ( i , 2 ) + 8 ) ≫ 4 ,$$

$$NewPixel ( i , 3 ) = ( 31 \times Pixel 1 ( i , 3 ) + Pixel 2 ( i , 3 ) + 16 ) ≫ 5.$$

For chroma blocks, the number of blending pixel rows is 1.

$$NewPixel ( i , 0 ) = ( 7 \times Pixel 1 ( i , 0 ) + Pixel 2 ( i , 0 ) + 4 ) ≫ 3.$$

### 2.2.8 History-Parameter-Based Affine Model Inheritance and Non-Adjacent Affine Mode

History-parameter-based affine model inheritance (HAMI) allows the affine model to be inherited from a previously affine-coded block which may not be neighboring to the current block. Similar to the enhanced regular merge mode, non-adjacent affine mode (NA-AFF) is introduced.

A first history-parameter table (HPT) is established. An entry of the first HPT stores a set of affine parameters: a, b, c and d, each of which is represented by a 16-bit signed integer. Entries in HPT is categorized by reference list and reference index. Five reference indices are supported for each reference list in HPT. In a formular way, the category of HPT (denoted as HPTCat) is calculated as

$$HPTCat ( RefList , RefIdx ) = 5 \times RefList + min ( RefIdx , 4 ) ,$$

wherein RefList and RefIdx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefList_{cur} and RefIdx_{cur}, the affine parameters are utilized to update entries in the category HPTCat(RefList_{cur}, RefIdx_{cur}) in a way similar to HMVP table updating.

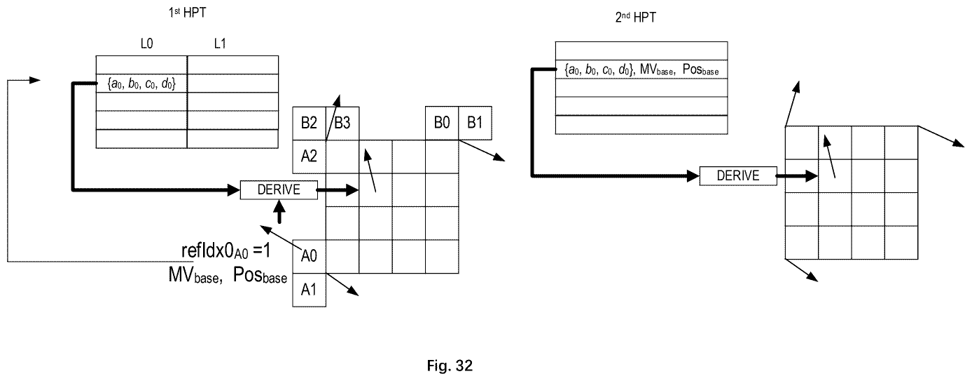

A history-affine-parameter-based candidate (HAPC) is derived from one of the seven neighbouring 4×4 blocks denoted as A0, A1, A2, B0, B1, B2 or B3 in FIG. 32 and a set of affine parameters stored in a corresponding entry in the first HPT. The MV of a neighbouring 4×4 block served as the base MV. In a formulating way, the MV of the current block at position (x, y) is calculated as:

$$\{ \begin{matrix}{mv}^{h} ( x , y ) = a ( x - {x}_{base} ) + c ( y - {y}_{base} ) + {mv}_{base}^{h} \\ {mv}^{v} ( x , y ) = b ( x - {x}_{base} ) + d ( y - {y}_{base} ) + {mv}_{base}^{v}\end{matrix} ,$$

where (mv^{h}_{base}, mv^{v}_{base}) represents the MV of the neighbouring 4×4 block, (x_{base}, y_{base}) represents the center position of the neighbouring 4×4 block. (x, y) can be the top-left, top-right and bottom-left corner of the current block to obtain the corner-position MVs (CPMVs) for the current block, or it can be the center of the current block to obtain a regular MV for the current block.

A second history-parameter table (HPT) with base MV information is also appended. There are nine entries in the second HPT, wherein an entry comprises a base MV, a reference index and four affine parameters for each reference list, and a base position. An additional merge HAPC can be generated from the second HPT with the base MV information the corresponding affine models stored in an entry. The difference between the first HPT and the second HPT is illustrated in FIG. 32.

Moreover, pair-wised affine merge candidates are generated by two affine merge candidates which are history-derived or not history-derived. A pair-wised affine merge candidates is generated by averaging the CPMVs of existing affine merge candidates in the list.

As a response to new HAPCs being introduced, the size of sub-block-based merge candidate list is increased from five to fifteen, which are all involved in the ARMC process.

FIG. 32 illustrates the first HPT and the second HPT.

In NA-AFF, the pattern of obtaining non-adjacent spatial neighbors is shown in FIG. 6. Same as the existing non-adjacent regular merge candidates, the distances between non-adjacent spatial neighbors and current coding block in the NA-AFF are also defined based on the width and height of current CU.

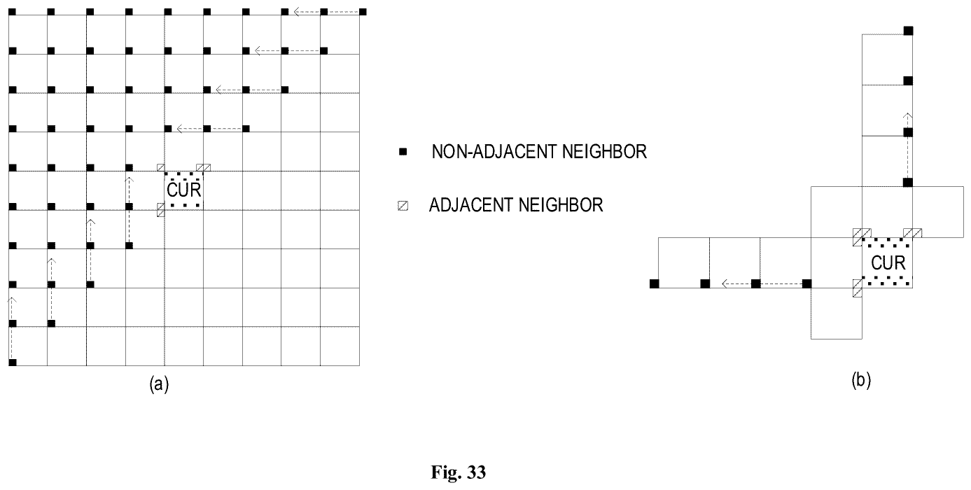

The motion information of the non-adjacent spatial neighbors in FIG. 6 is utilized to generate additional inherited and constructed affine merge/AMVP candidates. Specifically, for inherited candidates, the same derivation process of the inherited affine merge/AMVP candidates in the VVC is kept unchanged except that the CPMVs are inherited from non-adjacent spatial neighbors. The non-adjacent spatial neighbors are checked based on their distances to the current block, i.e., from near to far. At a specific distance, only the first available neighbor (that is coded with the affine mode) from each side (e.g., the left and above) of the current block is included for inherited candidate derivation. As indicated by the dash arrows in (a) of FIG. 33, the checking orders of the neighbors on the left and above sides are bottom-to-up and right-to-left, respectively.

FIG. 33 illustrates spatial neighbors for deriving affine merge/AMVP candidates: (a) for deriving inherited candidates (b) for deriving the first type of constructed candidates.

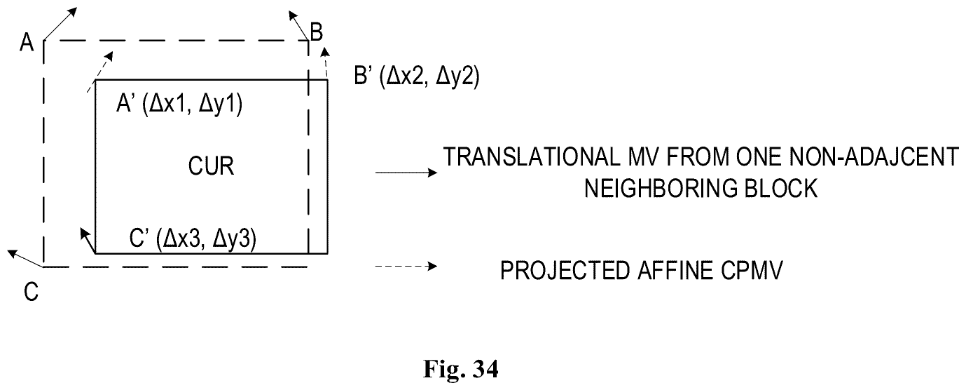

For the first type of constructed candidates, as shown in (b) of FIG. 33, the positions of one left and above non-adjacent spatial neighbors are firstly determined independently; After that, the location of the top-left neighbor can be determined accordingly which can enclose a rectangular virtual block together with the left and above non-adjacent neighbors. Then, as shown in the FIG. 34, the motion information of the three non-adjacent neighbors is used to form the CPMVs at the top-left (A), top-right (B) and bottom-left (C) of the virtual block, which is finally projected to the current CU to generate the corresponding constructed candidates.

FIG. 34 illustrates from non-adjacent neighbors to the first type of constructed affine merge/AMVP candidates.

The NA-AFF candidates are inserted into the existing affine merge candidate list and affine AMVP candidate list according to the following orders:

### Affine Merge Mode:

1. SbTMVP candidate, if available.
2. Inherited from adjacent neighbors.
3. Inherited from non-adjacent neighbors.
4. Constructed from adjacent neighbors.
5. The first type of constructed affine candidates from non-adjacent neighbors.
6. Zero MVs.

### Affine AMVP Mode:

1. Inherited from adjacent neighbors.
2. Constructed from adjacent neighbors.
3. Translational MVs from adjacent neighbors.
4. Translational MVs from temporal neighbors.
5. Inherited from non-adjacent neighbors.
6. The first type of constructed affine candidates from non-adjacent neighbors.
7. Zero MVs.

Due to the inclusion of the additional candidates generated by NA-AFF, the size of the affine merge candidate list is increased from 5 to 15. The subgroup size of ARMC for the affine merge mode is increased from 3 to 15.

### In NA-AFF:

1. The area from where the non-adjacent neighbors come is restricted to be within the current CTU (i.e., no additional storage requirements for line buffer).
2. The storage granularity for affine motion information, including CPMVs and reference indexes, is reduced from 8×8 to 16×16 (i.e., only the affine motion from the top-left 8×8 block is saved). Additionally, the saved CPMVs are projected to each 16×16 block before storage, such that the position and size information are not needed.
3. Only the top-left and top-right CPMVs are stored (i.e., always using 4-parameter affine model for NA-AFF).

### 2.2.9 Sample-Based BDOF

In the sample-based BDOF, instead of deriving motion refinement (Vx, Vy) on a block basis, it is performed per sample.

The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive Vx and Vy. The derived motion refinement (Vx, Vy) is applied to adjust the bi-predicted sample value for the center sample of the window.

### 2.2.10 Interpolation

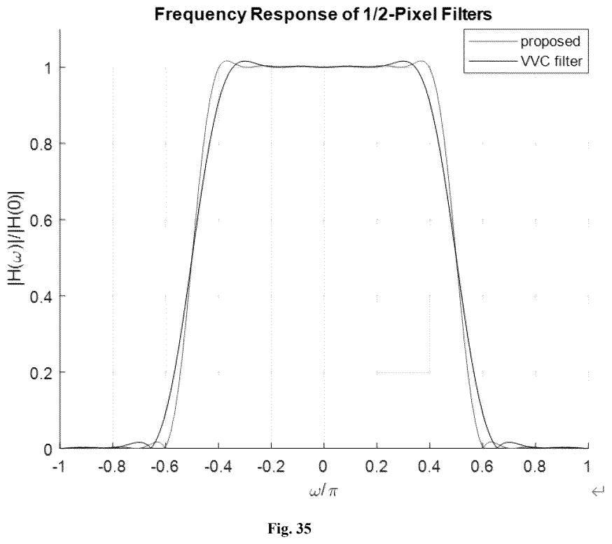

The 8-tap interpolation filter used in VVC is replaced with a 12-tap filter. The interpolation filter is derived from the sinc function of which the frequency response is cut off at Nyquist frequency and cropped by a cosine window function. Table 3 gives the filter coefficients of all 16 phases. FIG. 35 compares the frequency responses of the interpolation filters with the VVC interpolation filter, all at half-pel phase.

TABLE 3
Filter coefficients of the 12-tap interpolation filter

| | | | | | | | | | | | | |
|---|---|---|---|---|---|---|---|---|---|---|---|---|
| 1/16 | −1 | 2 | −3 | 6 | −14 | 254 | 16 | −7 | 4 | −2 | 1 | 0 |
| 2/16 | −1 | 3 | −7 | 12 | −26 | 249 | 35 | −15 | 8 | −4 | 2 | 0 |
| 3/16 | −2 | 5 | −9 | 17 | −36 | 241 | 54 | −22 | 12 | −6 | 3 | −1 |
| 4/16 | −2 | 5 | −11 | 21 | −43 | 230 | 75 | −29 | 15 | −8 | 4 | −1 |
| 5/16 | −2 | 6 | −13 | 24 | −48 | 216 | 97 | −36 | 19 | −10 | 4 | −1 |
| 6/16 | −2 | 7 | −14 | 25 | −51 | 200 | 119 | −42 | 22 | −12 | 5 | −1 |
| 7/16 | −2 | 7 | −14 | 26 | −51 | 181 | 140 | −46 | 24 | −13 | 6 | −2 |
| 8/16 | −2 | 6 | −13 | 25 | −50 | 162 | 162 | −50 | 25 | −13 | 6 | −2 |
| 9/16 | −2 | 6 | −13 | 24 | −46 | 140 | 181 | −51 | 26 | −14 | 7 | −2 |
| 10/16 | −1 | 5 | −12 | 22 | −42 | 119 | 200 | −51 | 25 | −14 | 7 | −2 |
| 11/16 | −1 | 4 | −10 | 19 | −36 | 97 | 216 | −48 | 24 | −13 | 6 | −2 |
| 12/16 | −1 | 4 | −8 | 15 | −29 | 75 | 230 | −43 | 21 | −11 | 5 | −2 |
| 13/16 | −1 | 3 | −6 | 12 | −22 | 54 | 241 | −36 | 17 | −9 | 5 | −2 |
| 14/16 | 0 | 2 | −4 | 8 | −15 | 35 | 249 | −26 | 12 | −7 | 3 | −1 |
| 15/16 | 0 | 1 | −2 | 4 | −7 | 16 | 254 | −14 | 6 | −3 | 2 | −1 |

FIG. 35 illustrates frequency responses of the interpolation filter and the VVC interpolation filter at half-pel phase.

For chroma interpolation additional longer 6-tap filters are used. The coefficients of filters are tabulated in Table 4.

TABLE 4
The coefficients of the 6-tap interpolation
filter for chroma components.

| Fractional position | Coefficients (6 taps) |
|---|---|
| 1/32 | {0, 0, 256, 0, 0, 0}, |
| 2/32 | {1, −6, 256, 7, −2, 0}, |
| 3/32 | {2, −11, 253, 15, −4, 1}, |
| 4/32 | {3, −16, 251, 23, −6, 1}, |
| 5/32 | {4, −21, 248, 33, −10, 2}, |
| 6/32 | {5, −25, 244, 42, −12, 2}, |
| 7/32 | {7, −30, 239, 53, −17, 4}, |
| 8/32 | {7, −32, 234, 62, −19, 4}, |
| 6/32 | {8, −35, 227, 73, −22, 5}, |
| 7/32 | {9, −38, 220, 84, −26, 7}, |
| 8/32 | {10, −40, 213, 95, −29, 7}, |
| 9/32 | {10, −41, 204, 106, −31, 8}, |
| 10/32 | {10, −42, 196, 117, −34, 9}, |
| 11/32 | {10, −41, 187, 127, −35, 8}, |
| 12/32 | {11, −42, 177, 138, −38, 10}, |
| 13/32 | {10, −41, 168, 148, −39, 10}, |
| 14/32 | {10, −40, 158, 158, −40, 10}, |
| 15/32 | {10, −39, 148, 168, −41, 10}, |
| 16/32 | {10, −38, 138, 177, −42, 11}, |
| 17/32 | {8, −35, 127, 187, −41, 10}, |
| 18/32 | {9, −34, 117, 196, −42, 10}, |
| 19/32 | {8, −31, 106, 204, −41, 10}, |
| 20/32 | {7, −29, 95, 213, −40, 10}, |
| 21/32 | {7, −26, 84, 220, −38, 9}, |
| 22/32 | {5, −22, 73, 227, −35, 8}, |
| 23/32 | {4, −19, 62, 234, −32, 7}, |
| 24/32 | {4, −17, 53, 239, −30, 7}, |
| 25/32 | {2, −12, 42, 244, −25, 5}, |
| 26/32 | {2, −10, 33, 248, −21, 4}, |
| 27/32 | {1, −6, 23, 251, −16, 3}, |
| 28/32 | {1, −4, 15, 253, −11, 2}, |
| 31/32 | {0, −2, 7, 256, −6, 1}, |

### 2.2.11 Multi-Hypothesis Prediction (MHP)

In the multi-hypothesis inter prediction mode, one or more additional motion-compensated prediction signals are signaled, in addition to the conventional bi-prediction signal. The resulting overall prediction signal is obtained by sample-wise weighted superposition. With the bi-prediction signal p_{bi} and the first additional inter prediction signal/hypothesis h₃, the resulting prediction signal p₃ is obtained as follows:

$${p}_{3} = ( 1 - α ) {p}_{bi} + α {h}_{3} .$$

The weighting factor α is specified by the new syntax element add_hyp_weight_idx, according to the following mapping:

| add_hyp_weight_idx | α |
|---|---|
| 0 | 1/4 |
| 1 | −1/8 |

Analogously to above, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1} .$$

The resulting overall prediction signal is obtained as the last pₙ (i.e., the pₙ having the largest index n). Within this EE, up to two additional prediction signals can be used (i.e., n is limited to 2).

The motion parameters of each additional prediction hypothesis can be signaled either explicitly by specifying the reference index, the motion vector predictor index, and the motion vector difference, or implicitly by specifying a merge index. A separate multi-hypothesis merge flag distinguishes between these two signalling modes.

For inter AMVP mode, MHP is only applied if non-equal weight in BCW is selected in bi-prediction mode.

Combination of MHP and BDOF is possible, however the BDOF is only applied to the bi-prediction signal part of the prediction signal (i.e., the ordinary first two hypotheses).

### 2.2.12 Adaptive Reordering of Merge Candidates with Template Matching (ARMC-TM)

The merge candidates are adaptively reordered with template matching (TM). The reordering method is applied to regular merge mode, TM merge mode, and affine merge mode (excluding the SbTMVP candidate). For the TM merge mode, merge candidates are reordered before the refinement process.

An initial merge candidate list is firstly constructed according to given checking order, such as spatial, TMVPs, non-adjacent, HMVPs, pairwise, virtual merge candidates. Then the candidates in the initial list are divided into several subgroups. For the template matching (TM) merge mode, adaptive DMVR mode, each merge candidate in the initial list is firstly refined by using TM/multi-pass DMVR. Merge candidates in each subgroup are reordered to generate a reordered merge candidate list and the reordering is according to cost values based on template matching. The index of selected merge candidate in the reordered merge candidate list is signalled to the decoder. For simplification, merge candidates in the last but not the first subgroup are not reordered. All the zero candidates from the ARMC reordering process are excluded during the construction of Merge motion vector candidates list. The subgroup size is set to 5 for regular merge mode and TM merge mode. The subgroup size is set to 3 for affine merge mode.
Cost calculation

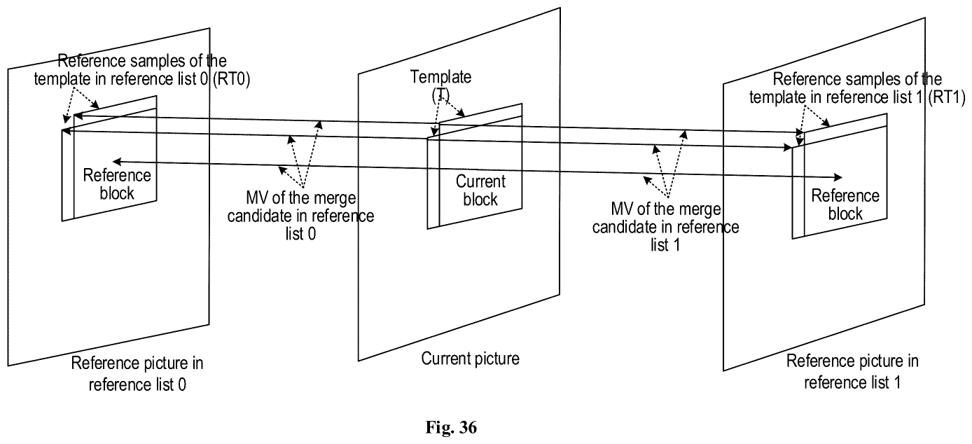

The template matching cost of a merge candidate during the reordering process is measured by the SAD between samples of a template of the current block and their corresponding reference samples. The template comprises a set of reconstructed samples neighboring to the current block. Reference samples of the template are located by the motion information of the merge candidate. When a merge candidate utilizes bi-directional prediction, the reference samples of the template of the merge candidate are also generated by bi-prediction as shown in FIG. 36.
Refinement of the initial merge candidate list

When multi-pass DMVR is used to derive the refined motion to the initial merge candidate list only the first pass (i.e., PU level) of multi-pass DMVR is applied in reordering. When template matching is used to derive the refined motion, the template size is set equal to 1. Only the above or left template is used during the motion refinement of TM when the block is flat with block width greater than 2 times of height or narrow with height greater than 2 times of width. TM is extended to perform 1/16-pel MVD precision. The first four merge candidates are reordered with the refined motion in TM merge mode.

FIG. 36 illustrates template and reference samples of the template in reference pictures.

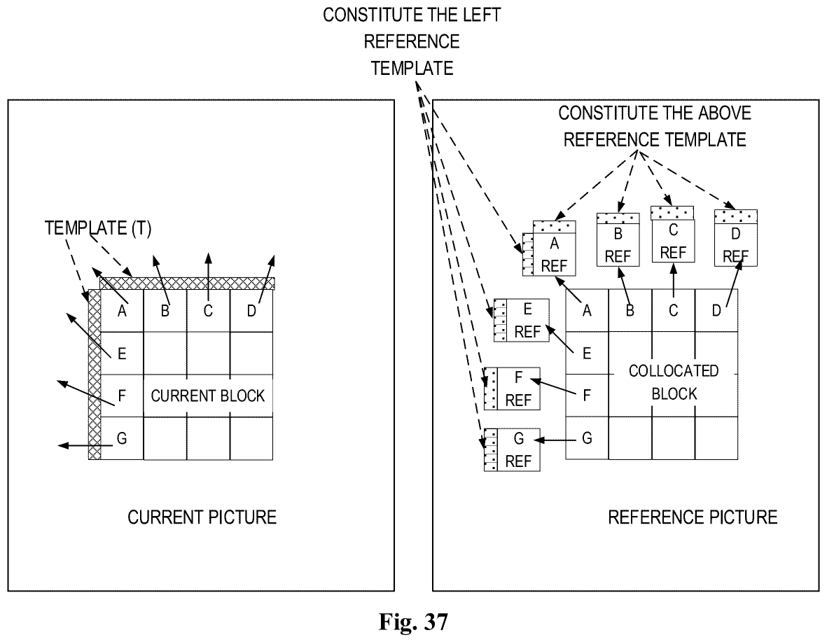

For subblock-based merge candidates with subblock size equal to Wsub×Hsub, the above template comprises several sub-templates with the size of Wsub×1, and the left template comprises several sub-templates with the size of 1×Hsub. As shown in FIG. 37, the motion information of the subblocks in the first row and the first column of current block is used to derive the reference samples of each sub-template. ° Reordering criterial In the reordering process, a candidate is considered as redundant if the cost difference between a candidate and its predecessor is inferior to a lambda value e.g. |D1-D2|<λ, where D1 and D2 are the costs obtained during the first ARMC ordering and X is the Lagrangian parameter used in the RD criterion at encoder side.

### The Proposed Algorithm is Defined as the Following:

Determine the minimum cost difference between a candidate and its predecessor among all candidates in the list.
   If the minimum cost difference is superior or equal to λ, the list is considered diverse enough and the reordering stops.
   If this minimum cost difference is inferior to λ, the candidate is considered as redundant, and it is moved at a further position in the list. This further position is the first position where the candidate is diverse enough compared to its predecessor.
The algorithm stops after a finite number of iterations (if the minimum cost difference is not inferior to λ).

This algorithm is applied to the Regular, TM, BM and Affine merge modes. A similar algorithm is applied to the Merge MMVD and sign MVD prediction methods which also use ARMC for the reordering.

The value of λ is set equal to the λ of the rate distortion criterion used to select the best merge candidate at the encoder side for low delay configuration and to the value λ corresponding to a another QP for Random Access configuration. A set of λ values corresponding to each signaled QP offset is provided in the SPS or in the Slice Header for the QP offsets which are not present in the SPS.
Extension to AMVP modes

The ARMC design is also applicable to the AMVP mode wherein the AMVP candidates are reordered according to the TM cost. For the template matching for advanced motion vector prediction (TM-AMVP) mode, an initial AMVP candidate list is constructed, followed by a refinement from TM to construct a refined AMVP candidate list. In addition, an MVP candidate with a TM cost larger than a threshold, which is equal to five times of the cost of the first MVP candidate, is skipped.

Note, when wrap around motion compensation is enabled, the MV candidate shall be clipped with wrap around offset taken into consideration.

FIG. 37 illustrates template and reference samples of the template for block with sub-block motion using the motion information of the subblocks of the current block.

### 2.2.13 MV Candidate Type Based ARMC

Merge candidates of one single candidate type, e.g., TMVP or non-adjacent MVP (NA-MVP), are reordered based on the ARMC TM cost values. The reordered candidates are then added into the merge candidate list. The TMVP candidate type adds more TMVP candidates with more temporal positions and different inter prediction directions to perform the reordering and the selection. Moreover, NA-MVP candidate type is further extended with more spatially non-adjacent positions. The target reference picture of the TMVP candidate can be selected from any one of reference picture in the list according to scaling factor. The selected reference picture is the one whose scaling factor is the closest to 1.

### 2.2.14 TM Based Reordering for MMVD and Affine MMVD

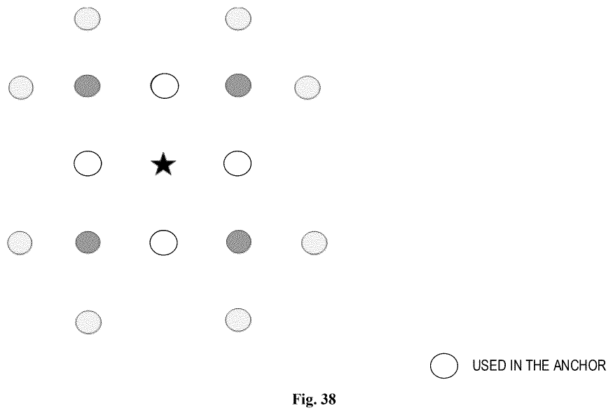

The MMVD offsets are extended for MMVD and affine MMVD modes. Additional refinement positions along k×π/8 diagonal angles are added shown in FIG. 38, thus increasing the number of directions from 4 to 16. Second, based on the SAD cost between the template (one row above and one column left to the current block) and its reference for each refinement position, all the possible MMVD refinement positions (16×6) for each base candidate are reordered. Finally, the top ⅛ refinement positions with the smallest template SAD costs are kept as available positions, consequently for MMVD index coding. The MMVD index is binarized by the rice code with the parameter equal to 2. The affine MMVD reordering is extended, in which additional refinement positions along k×π/4 diagonal angles are added. After reordering top ½ refinement positions with the smallest template SAD costs are kept.

The first N motion candidates in the candidate list before being reordered are utilized as the base candidates for MMVD and affine MMVD. N is equal to 3 for MMVD, and [1, 3] depending on the neighboring block affine flags for affine MMVD. Two ways of adding MMVD offsets are allowed, including the ‘two-side’ and ‘one-side’, depending on whether the offset of the other reference picture list is mirrored or directly set to zero. Which way is applied to one block is dependent on the TM cost.

FIG. 38 illustrates additional directions along k×π/8 diagonal angles (red positions are used in the anchor).

### 2.2.15 Regression Based Affine Candidate Derivation

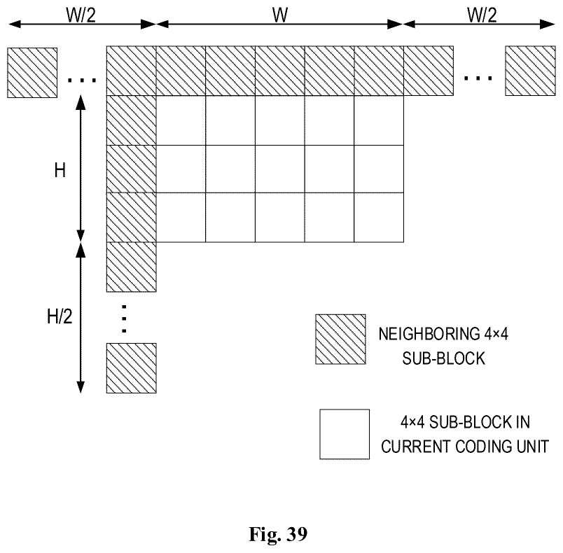

The Regression based Motion Vector Field (RMVF) derivation method provides a new variety of subblock-based merge candidate. The motion vectors and center positions from the neighboring subblocks of the current CU, as illustrated in FIG. 39, are used as the input to the linear regression process to derive a set of linear model parameters.

FIG. 39 illustrates the neighboring 4×4 subblocks that are used for RMVF parameter derivation. W and H are the width and height of the current CU.

The subblock motion field from a previous coded affine CU and the motion vectors from the adjacent subblocks of current CU are used as the input for the regression process. The predicted CPMVs for current block are derived as output.

The regression based affine merge candidates are derived and added to the affine merge list. Subblock motion field from a previously coded affine CU and motion information from adjacent subblocks of a current CU are used as the input to the regression process to derive proposed affine candidates.

The previously coded affine CU can be identified from scanning through non-adjacent positions and the affine HMVP table.

Adjacent subblock information of current CU is fetched from 4×4 sub-blocks represented by the grey zone as depicted in FIG. 39. For each sub-block, given a reference list, the corresponding motion vector and center coordinate of the sub-block may be used.

For each affine CU, up to 2 affine candidates can be derived. One with adjacent subblock information and one without. All the linear-regression-generated candidates are pruned and collected into one candidate subgroup, TM cost based ARMC process is applied when ARMC is enabled. Afterwards, up to N linear-regression-generated candidates are added to the affine merge list when N affine CUs are found. The number of affine candidates for ARMC is 30, the output list size is 15.

### 2.2.16 Geometric Partitioning Mode (GPM) with Merge Motion Vector Differences (MMVD)

GPM in VVC is extended by applying motion vector refinement on top of the existing GPM uni-directional MVs. A flag is first signalled for a GPM CU, to specify whether this mode is used. If the mode is used, each geometric partition of a GPM CU can further decide whether to signal MVD or not. If MVD is signalled for a geometric partition, after a GPM merge candidate is selected, the motion of the partition is further refined by the signalled MVDs information. All other procedures are kept the same as in GPM.

The MVD is signaled as a pair of distance and direction, similar as in MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD). In addition, when pic_fpel_mmvd_enabled_flag is equal to 1, the MVD is left shifted by 2 as in MMVD.

### 2.2.17 Geometric Partitioning Mode (GPM) with Adaptive Blending

In VVC, the final prediction samples are generated with by blending the prediction of the two prediction signals using weighted average. Two integer blending matrices (W₀ and W₁) are used. The weights in the GPM blending matrices are derived from the ramp function based on the displacement from a predicted sample position to the GPM partitioning boundary. The blending area size is fixed to two (2 samples on each side of the GPM partition split boundary).

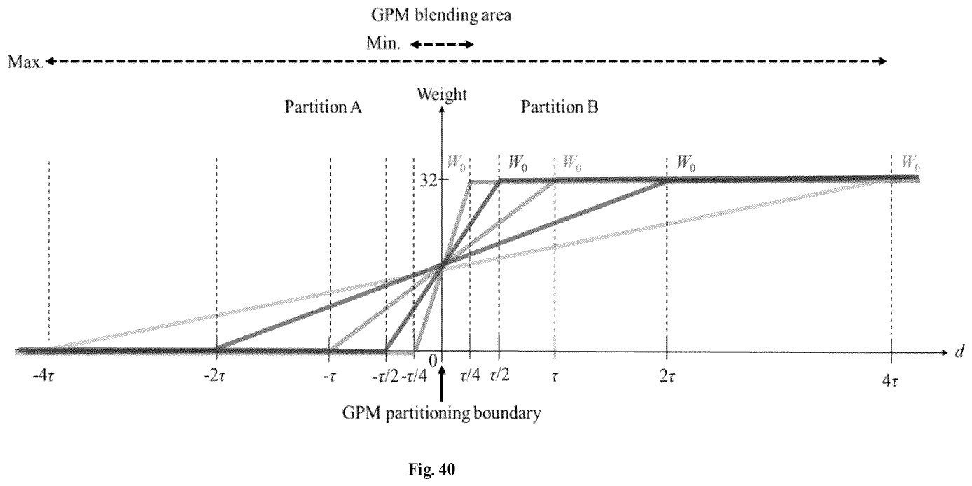

The blending process in ECM is improved by adding four extra blending area sizes (quarter, half, double, and quadrupole of the existing area size) as shown in FIG. 40. A CU level flag is coded to signal the selected blending area size is signalled. Furthermore, the extended weighting precision is utilized, in which the maximum value of the weighs is changed from 8 (in VVC) to 32 to accommodate the extended blending area sizes.

FIG. 40 illustrates the ramp function for the weights for GPM blending based on the displacement (d) from a predicted sample position to the GPM partitioning boundary and the blending area size (i).

### 2.2.18 Geometric Partitioning Mode (GPM) with Template Matching (TM)

Template matching is applied to GPM. When GPM mode is enabled for a CU, a CU-level flag is signaled to indicate whether TM is applied to both geometric partitions. Motion information for each geometric partition is refined using TM. When TM is chosen, a template is constructed using left, above or left and above neighboring samples according to partition angle, as shown in Table 5. The motion is then refined by minimizing the difference between the current template and the template in the reference picture using the same search pattern of merge mode with half-pel interpolation filter disabled.

TABLE 5
Template for the 1st and 2nd geometric partitions, where A represents using above samples,
L represents using left samples, and L+A represents using both left and above samples.

| Partition angle | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

### A GPM Candidate List is Constructed as Follows:

1. Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates.
2. Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates.
3. Zero MV candidates are padded until the GPM candidate list is full.

The GPM-MMVD and GPM-TM are exclusively enabled to one GPM CU. This is done by firstly signaling the GPM-MMVD syntax. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

### 2.2.19 GPM with Inter and Intra Prediction

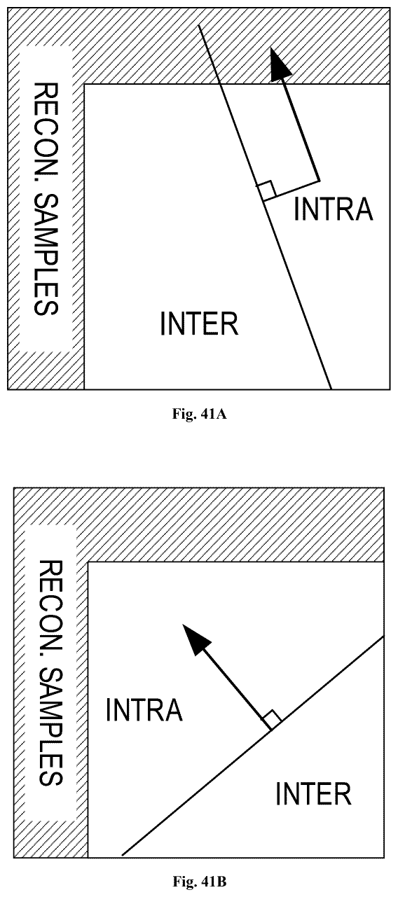

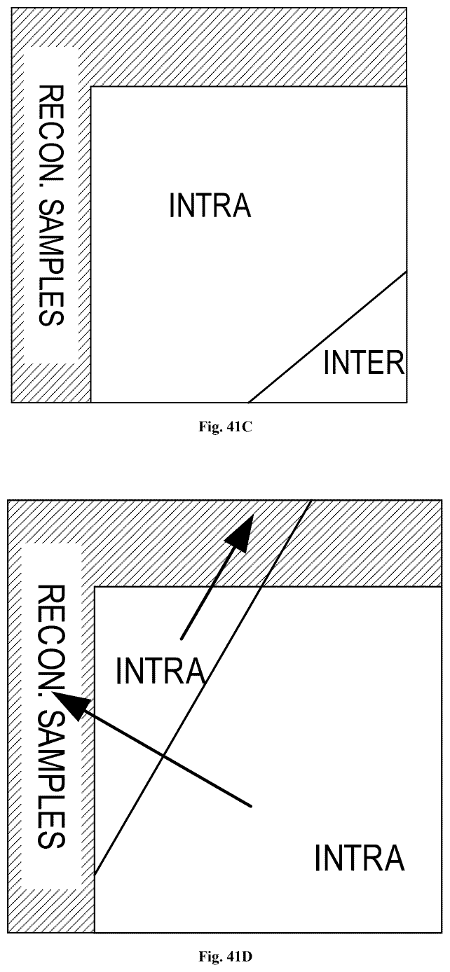

In GPM with inter and intra prediction, the final prediction samples are generated by weighting inter predicted samples and intra predicted samples for each GPM-separated region. The inter predicted samples are derived by inter GPM whereas the intra predicted samples are derived by an intra prediction mode (IPM) candidate list and an index signaled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown in FIG. 41A to FIG. 41C, respectively. Furthermore, GPM with intra and intra prediction as shown in FIG. 41D is restricted to reduce the signalling overhead for IPMs and avoid an increase in the size of the intra prediction circuit on the hardware decoder. In addition, a direct motion vector and IPM storage on the GPM-blending area is introduced to further improve the coding performance.

FIG. 41A to FIG. 41D illustrate GPM with inter and intra prediction. Available IPM candidates are shown in FIG. 41A to FIG. 41C. FIG. 41D shows example of GPM with intra and intra prediction.

In DIMD and neighboring mode based IPM derivation Parallel mode is registered first. Therefore, max two IPM candidates derived from the decoder-side intra mode derivation (DIMD) method and/or the neighboring blocks can be registered if there is not the same IPM candidate in the list. As for the neighboring mode derivation, there are five positions for available neighboring blocks at most, but they are restricted by the angle of GPM block boundary as shown in Table 6, which are already used for GPM with template matching (GPM-TM).

TABLE 6
The position of available neighboring blocks for IPM candidate derivation based on the angle
of GPM block boundary. A and L denotes the above and left side of the prediction block.

| Angle of GPM | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

GPM-intra can be combined with GPM with merge with motion vector difference (GPM-MMVD). TIMD is used for on IPM candidates of GPM-intra to further improve the coding performance. The Parallel mode can be registered first, then IPM candidates of TIMD, DIMD, and neighboring blocks.

### 2.2.20 Template Matching Based Reordering for GPM Split Modes

In template matching based reordering for GPM split modes, given the motion information of the current GPM block, the respective TM cost values of GPM split modes are computed. Then, all GPM split modes are reordered in ascending ordering based on the TM cost values. Instead of sending GPM split mode, an index using Golomb-Rice code to indicate where the exact GPM split mode located in the reordering list is signaled.

The reordering method for GPM split modes is a two-step process performed after the respective reference templates of the two GPM partitions in a coding unit are generated, as follows:
extending GPM partition edge into the reference templates of the two GPM partitions, resulting in 64 reference templates and computing the respective TM cost for each of the 64 reference templates;
reordering GPM split modes based on their TM cost values in ascending order and marking the best 32 split modes as available split modes.

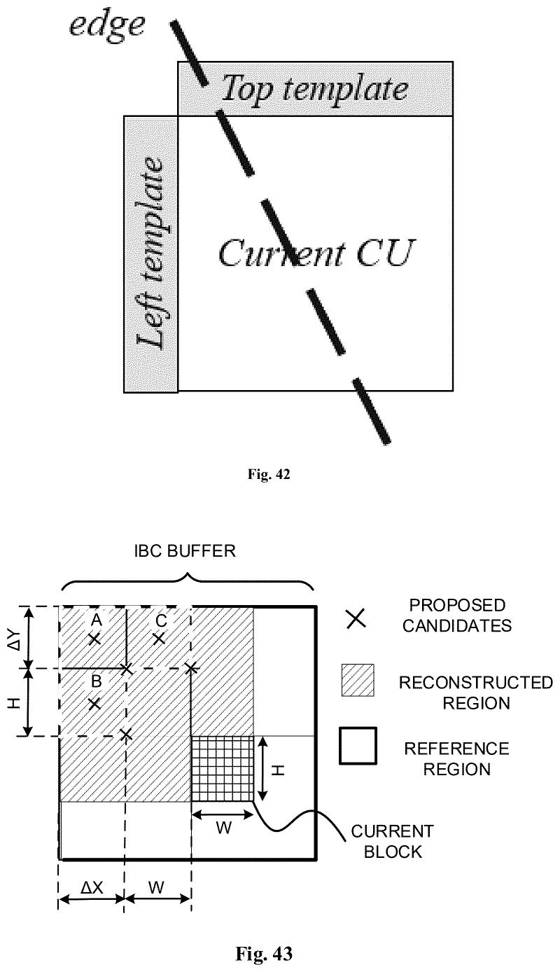

The edge on the template is extended from that of the current CU, as FIG. 42 illustrates, but GPM blending process is not used in the template area across the edge. FIG. 42 shows an edge on templates.

After ascending reordering using TM cost, an index is signaled.

### 2.2.21 Bilateral Matching AMVP-Merge Mode

The bi-directional predictor is composed of an AMVP predictor in one direction and a merge predictor in the other direction. The mode can be enabled to a coding block when the selected merge predictor and the AMVP predictor satisfy DMVR condition, where there is at least one reference picture from the past and one reference picture from the future relatively to the current picture and the distances from two reference pictures to the current picture are the same, the bilateral matching MV refinement is applied for the merge MV candidate and AMVP MVP as a starting point. Otherwise, if template matching functionality is enabled, template matching MV refinement is applied to the merge predictor or the AMVP predictor which has a higher template matching cost.

AMVP part of the mode is signaled as a regular uni-directional AMVP, i.e. reference index and MVD are signaled, and it has a derived MVP index if template matching is used or MVP index is signaled when template matching is disabled.

For AMVP direction LX, X can be 0 or 1, the merge part in the other direction (1−LX) is implicitly derived by minimizing the bilateral matching cost between the AMVP predictor and a merge predictor, i.e., for a pair of the AMVP and a merge motion vectors. For every merge candidate in the merge candidate list which has that other direction (1−LX) motion vector, the bilateral matching cost is calculated using the merge candidate MV and the AMVP MV. The merge candidate with the smallest cost is selected. The bilateral matching refinement is applied to the coding block with the selected merge candidate MV and the AMVP MV as a starting point.

The third pass of multi pass DMVR which is 8×8 sub-PU BDOF refinement of the multi-pass DMVR is enabled to AMVP-merge mode coded block.

The mode is indicated by a flag, if the mode is enabled AMVP direction LX is further indicated by a flag.

When bilateral matching (BM) AMVP-merge mode is used for the current block and template matching is enabled, MVD is not signalled. An additional pair of AMVP-merge MVPs is introduced. The merge candidate list is sorted based on the BM cost in increase order. An index (0 or 1) is signaled to indicate which merge candidate in the sorted merge candidate list to use. When there is only one candidate in merge candidate list, the pair of AMVP MVP and merge MVP without bilateral matching MV refinement is padded.

### 2.2.22 IBC Merge/AMVP List Construction

### The IBC Merge/AMVP List Construction is Modified as Follows:

Only if an IBC merge/AMVP candidate is valid, it can be inserted into the IBC merge/AMVP candidate list.
Above-right, bottom-left, and above-left spatial candidates and one pairwise average candidate can be added into the IBC merge/AMVP candidate list.
Template based adaptive reordering (ARMC-TM) is applied to IBC merge list.

The HMVP table size for IBC is increased to 25. After up to 20 IBC merge candidates are derived with full pruning, they are reordered together. After reordering, the first 6 candidates with the lowest template matching costs are selected as the final candidates in the IBC merge list.

The zero vectors' candidates to pad the IBC Merge/AMVP list are replaced with a set of BVP candidates located in the IBC reference region. A zero vector is invalid as a block vector in IBC merge mode, and consequently, it is discarded as BVP in the IBC candidate list.

Three candidates are located on the nearest corners of the reference region, and three additional candidates are determined in the middle of the three sub-regions (A, B, and C), whose coordinates are determined by the width, and height of the current block and the ΔX and ΔY parameters, as is depicted in FIG. 43.

FIG. 43 illustrates padding candidates for the replacement of the zero-vector in the IBC list.

### 2.2.23 IBC with Template Matching

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

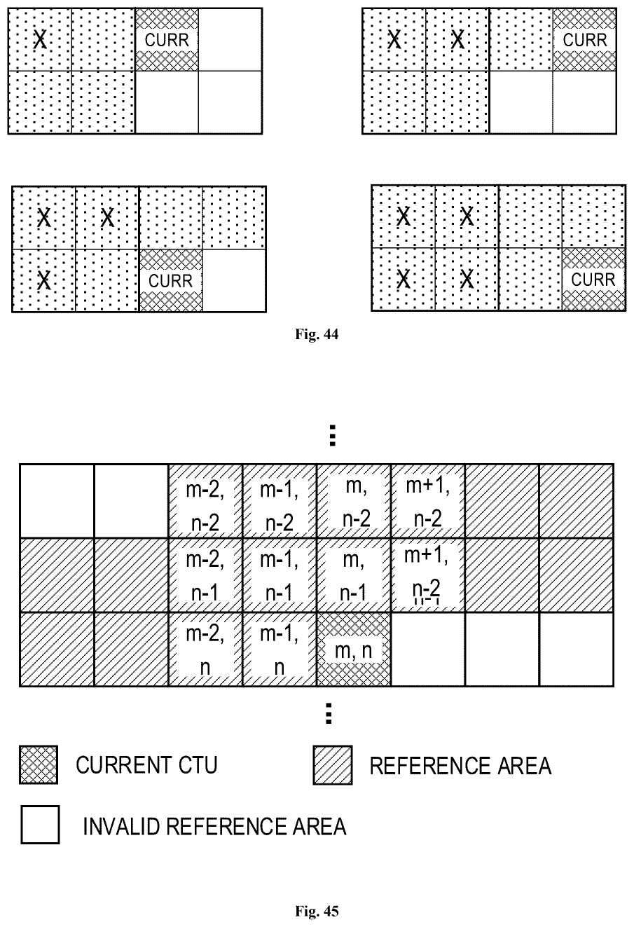

The Template Matching refinement for both IBC-TM merge and AMVP modes is quite simple since IBC motion vectors are constrained (i) to be integer and (ii) within a reference region as shown in FIG. 44. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

FIG. 44 illustrates an IBC reference region depending on current CU position.

### 2.2.24 IBC Reference Area

The reference area for IBC is extended to two CTU rows above. FIG. 45 illustrates the reference area for coding CTU (m, n). Specifically, for CTU (m, n) to be coded, the reference area includes CTUs with index (m−2, n−2) . . . (W, n−2),(0, n−1) . . . (W, n−1),(0, n) . . . (m, n), where W denotes the maximum horizontal index within the current tile, slice or picture. When CTU size is 256, the reference area is limited to one CTU row above. This setting ensures that for CTU size being 128 or 256, IBC does not require extra memory in the current ETM platform. The per-sample block vector search (or called local search) range is limited to [−(C<<1), C>>2] horizontally and [−C, C>>2] vertically to adapt to the reference area extension, where C denotes the CTU size.

FIG. 45 illustrates a reference area for IBC when CTU (m, n) is coded.

### 2.2.25 MVD Sign Prediction

In this method, possible MVD sign combinations are sorted according to the template matching cost and index corresponding to the true MVD sign is derived and context coded. At decoder side, the MVD signs are derived as following:
1. Parse the magnitude of MVD components.
2. Parse context coded MVD sign prediction index.
3. Build MV candidates by creating combination between possible signs and absolute MVD value and add it to the MV predictor.
4. Derive MVD sign prediction cost for each derived MV based on template matching cost and sort.
5. Use MVD sign prediction index to pick the true MVD sign.

MVD sign prediction is applied to inter AMVP, affine AMVP, MMVD and affine MMVD modes. Note, when wrap around motion compensation is enabled, the MV candidate shall be clipped with wrap around offset taken into consideration.

### 2.2.26 Enhanced Bi-Directional Motion Compensation

In bi-directional motion compensation the out of boundary (OOB) prediction samples are discarded and only the non-OOB predictors, when available, are used to generate the final predictor. Specifically, let PoS_x_{i,j}, and Pos_y_{i,j} denote the position of one prediction sample in one current block,

$${Mv\_x}_{i , j}^{Lx} and {Mv\_y}_{i , j}^{Lx} ( x = 0 , 1 )$$

denote the MV of the current block; Pos_{LeftBdry}, Pos_{RightBdry}, Pos_{TopBdry} and Pos_{BottomBdry} are the positions of four boundaries of the picture. One prediction sample is regarded as OOB when at least one of the following conditions is satisfied:

$$( {Pos\_x}_{i , j} + {Mv\_x}_{i , j}^{Lx} ) > ( {Pos}_{RightBdry} + half\_pixel ) ,$$

$$( {Pos\_x}_{i , j} + {Mv\_x}_{i , j}^{Lx} ) > ( {Pos}_{LeftBdry} - half\_pixel ) ,$$

$$( {Pos\_y}_{i , j} + {Mv\_y}_{i , j}^{Lx} ) > ( {Pos}_{BottomBdry} + half\_pixel ) ,$$

$$( {Pos\_y}_{i , j} + {Mv\_y}_{i , j}^{Lx} ) > ( {Pos}_{TopBdry} - half\_pixel ) ,$$

where half_pixel is equal to 8 that represents the half-pel sample distance in the 1/16-pel sample precision.

After examining the OOB condition for each sample, the final prediction samples of one bi-directional block are generated as follows:

$$If {P}_{i , j}^{L 0} is OOB and {P}_{i , j}^{L 1} is non - OOB$$

$${P}_{i , j}^{final} = {P}_{i , j}^{L 1}$$

$$else if {P}_{i , j}^{L 0} is non - OOB and {P}_{i , j}^{L 1} is OOB$$

$${P}_{i , j}^{final} = {P}_{i , j}^{L 0}$$

$$else$$

$${P}_{i , j}^{final} = ( {P}_{i , j}^{L 0} + {P}_{i , j}^{L 1} + 1 ) ≫ 1.$$

OOB checking process is also applicable when BCW is enabled.

Finally, note this sample-adaptive bi-prediction process only applies to prediction units for which at least a reference bock is first detected as partially or entirely out-of-bounds. Thus, a block-level OOB criteria is first checked. If both prediction blocks are non-OOB, then the usual bi-prediction takes place.

### 2.2.27 Motion Compensated Picture Boundary Padding

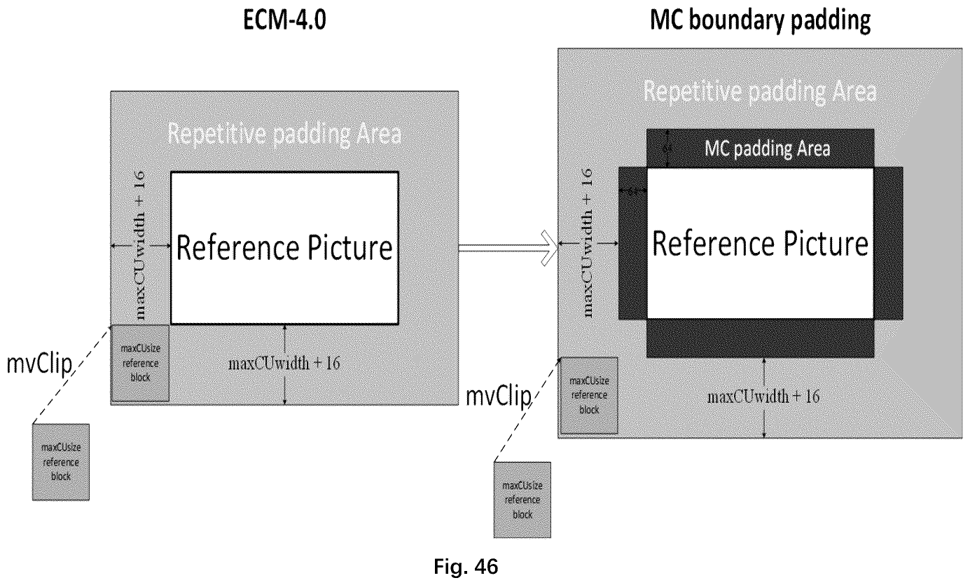

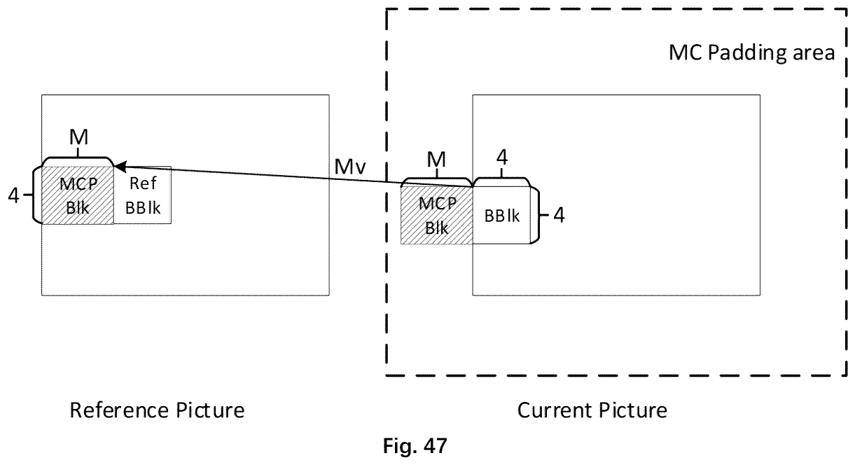

The samples outside of the picture boundary are derived by motion compensation instead of using only repetitive padding. In the implementation, the total padded area size is increased by 16 compared to repetitive padding. This is to keep MV clipping, which implements repetitive padding FIG. 46.

FIG. 46 illustrates motion compensated boundary padding method.

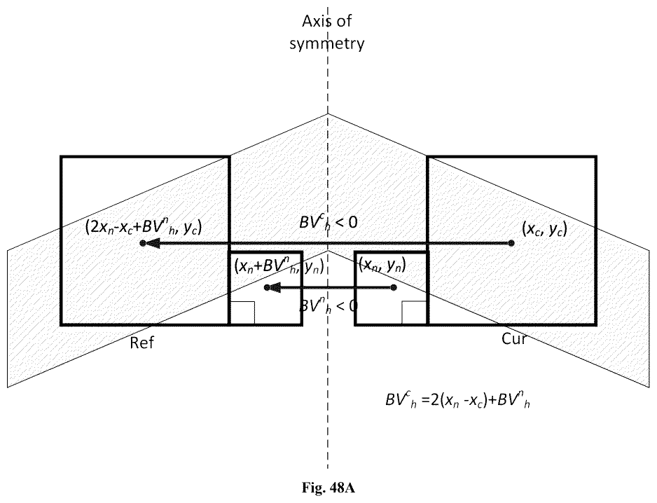

For motion compensation padding, MV of a 4×4 boundary block is utilized to derive a M×4 or 4×M padding block. The value M is derived as the distance of the reference block to the picture boundary as shown on FIG. 47. Moreover, M is set at least equal to 4 as soon as the motion vector points to a position internal to the reference picture bounds. If boundary block is intra coded, then MV is not available, and M is set equal to 0. If M is less than 16, the rest of the padded area is filled with the repetitive padded samples.

FIG. 47 illustrates an example of deriving a M×4 padding block with a left padding direction.

In case of bi-directional inter prediction, only one prediction direction, which has a motion vector pointing to the pixel position farther away from the picture boundary in the reference picture in terms of the padding direction, is used in MC boundary padding.

The pixels in MC padding block are corrected with an offset, which is equal to the difference between the DC values of the reconstructed boundary block and its corresponding reference block.

### 2.2.28 Block Level Reference Picture List Reordering

A block level reference picture reordering method based on template matching is used. For the uni-prediction AMVP mode, the reference pictures in List 0 and List 1 are interweaved to generate a joint list. For each hypothesis of the reference picture in the joint list template matching is performed to calculate the cost. The joint list is reordered based on ascending order of the template matching cost. The index of the selected reference picture in the reordered joint list is signaled in the bitstream. For the bi-prediction AMVP mode, a list of pairs of reference pictures from List 0 and List 1 is generated and similarly reordered based on the template matching cost. The index of the selected pair is signaled.

### 2.2.29 Reference Picture Resampling (RPR)

Reference picture resampling is inherited from VVC. Compared to the filter lengths in VVC, e.g., 8, 6 and 4 taps for luma affine coded blocks, luma non-affine coded blocks and chroma respectively, the corresponding RPR filters in ECM are increased to 12, 10 and 6 taps.

### 2.2.30 Reconstruction-Reordered IBC (RR-IBC)

A Reconstruction-Reordered IBC (RR-IBC) mode is allowed for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

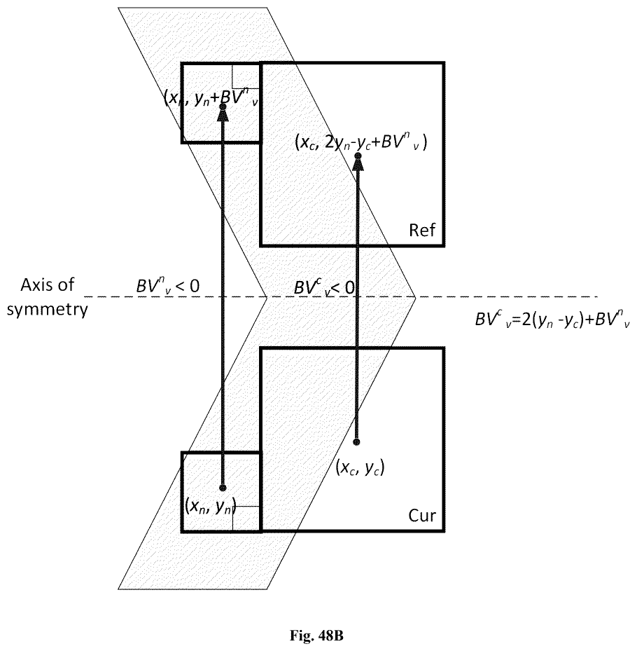

To better utilize the symmetry property, a flip-aware BV adjustment approach is applied to refine the block vector candidate. For example, as shown in FIG. 48A and FIG. 48B, (x_{nbr}, y_{nbr}) and (x_{cur}, y_{cur}) represent the coordinates of the center sample of the neighbouring block and the current block, respectively, BV^{nbr} and BV^{cur} denotes the BV of the neighbouring block and the current block, respectively. Instead of directly inheriting the BV from a neighbouring block, the horizontal component of BV^{cur} is calculated by adding a motion shift to the horizontal component of BV^{nbr} (denoted as BV^{nbr}h) in case that the neighbouring block is coded with a horizontal flip, i.e., BV^{cur}ₕ=2(x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip, i.e., BV^{cur}ᵥ=2(y_{nbr}−y_{cur})+BV^{nbr}ᵥ.

FIG. 48A illustrates BV adjustment for horizontal flip, and FIG. 48B illustrates BV adjustment for vertical flip, respectively.

### 2.2.31 IBC Merge Mode with Block Vector Differences (IBC-MBVD)

Affine-MMVD and GPM-MMVD have been adopted to ECM as an extension of regular MMVD mode. It is natural to extend the MMVD mode to the IBC merge mode.

In IBC-MBVD, the distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the rice code with the parameter equal to 1.

An IBC-MBVD coded block does not inherit flip type from a RR-IBC coded neighbor block.

### 2.2.32 Template Matching Based BCW Index Derivation for Merge Mode

The BCW index for merge coded CUs is derived based on template matching cost instead of being derived from neighboring blocks. Given a selected merge candidate, the TM cost values are calculated with different bi-prediction weights, and then, the bi-prediction weight with minimum TM cost value is used to predict the merge CU.

### When Calculating TM Cost for Bi-Predicted Weights, the Following Rules are Applied:

Since the inherited bi-predicted weight is likely to have higher accuracy than others, only the inherited bi-prediction weight and its two neighboring weights (i.e. ±1) are considered. For example, if the inherited bi-predicted weight is 4, then only three weights {3, 4, 5} are involved in TM cost calculation.
The TM cost of the inherited BCW index is multiplied with 0.90625, that is, the cost is reduced by 3/32.
The TM cost of the equal weight is multiplied with 0.90625 since bi-predicted samples are beneficial for BDOF and BDOF is only applied to CU with equal weights.

The template matching based BCW index derivation is applied to CUs coded in regular merge, template matching, adaptive decoder-side motion vector refinement and MMVD modes.

In addition, the bi-prediction weights for merge mode are extended from {−2, 3, 4, 5, 10} to {1, 2, 3, 4, 5, 6, 7}.

Furthermore, the negative bi-predicted weights for non-merge mode {−2, 10} are replaced with positive weights {1, 7}.

### 2.2.33 DMVR for Affine Merge Coded Blocks

DMVR is applied to affine merge coded blocks when DMVR condition is satisfied.

An affine motion field is modelized as follows (6-parameters affine case):

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix}$$

wherein(mvₓ, mv_{y}) is the motion vector at location (x, y) and (mv₀ₓ, mv_{0y}) is the base MV representing the translation motion of the affine model. Parameters

$$\frac{{mv}_{1 x} - {mv}_{0 x}}{W} , \frac{{mv}_{2 x} - {mv}_{0 x}}{H} , \frac{{mv}_{1 y} - {mv}_{0 y}}{W} and \frac{{mv}_{2 y} - {mv}_{0 y}}{H}$$

represent the non-translation parameters (rotation, scaling).

In the DMVR process applied to affine, the first stage of multi-stage DMVR is applied to the translation part of the affine motion such that a translation MV offset is added to all the CPMVs of the candidate in the affine merge list if the candidate meets the DMVR condition. The MV offset is derived by minimizing the cost of bilateral matching which is the same as conventional DMVR.

The first stage refinement process consists of 3×3 square search pattern used to loop through the search range which is set as [−3, 3] to find the best integer MV offset. Then, half-pel search is conducted around the best integer position and an error surface estimation is performed at last to find an optimal MV offset with 1/16 precision.

### 3. Problems

In ECM-9.0, there is an SPS flag (i.e., inter-TM sps flag) to control the enabling/disabling of template based INTER tools. Moreover, there is an SPS flag (i.e., ARMC sps flag) to control the enabling/disabling of ARMC. The ARMC is used not only for inter tools, but also for IBC and intra tools. However, the inter-TM sps flag would erroneously disable all ARMC aspects, even though some ARMC aspects are intended to be used for IBC/intra. It is claimed that such behavior breaks the design intention.

The current design which couples inter and intra/IBC TM aspects together should be modified.

### 4. Detailed Solutions

The detailed embodiments below should be considered as examples to explain general concepts. These embodiments should not be interpreted in a narrow way. Furthermore, these embodiments can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

The terms “non-inter” may refer to IBC, PLT, intra and etc. The disclosed method may be used in single tree.

The term “ARMC” may refer to template based motion/block vector candidate reordering, or template based intra candidate reordering. It may be used for intra, inter, and IBC coding tools.

The term “high level syntax element” may refer to a syntax element being signalled above the coding unit level, such as sequence level/group of pictures level/picture header level/picture level/slice header level/slice level/tile group level.
1) A Syntax Element May be Signalled at High Level to Control More than One Template Based Method.
   a. For example, the template-based method may refer to a coding technique which involves template with search (such as template cost calculation, template matching, etc.) and/or template without search (such as DIMD, CCCM, LM, CCLM, GLM, LIC, etc.).
   b. For example, the template-based method may refer to a coding technique which belongs to intra, and/or inter, and/or IBC coding.
   c. For example, a first high level syntax element may be signalled to control the enabling/disabling/allowance/disallowance of template aspects, no matter whether the template aspect is used to intra, IBC, PLT, or inter tools.
   d. For example, a second high level syntax element may be signalled to control the enabling/disabling/allowance/disallowance of template aspects for intra tools.
   e. For example, a third high level syntax element may be signalled to control the enabling/disabling/allowance/disallowance of template aspects for IBC tools.
   f. For example, a fourth high level syntax element may be signalled to control the enabling/disabling/allowance/disallowance of template aspects for inter tools.
   g. For example, a fifth high level syntax element may be signalled to control the enabling/disabling/allowance/disallowance of template aspects for non-inter (such as intra, and IBC, and/or PLT, etc.) tools.
   h. For example, the first, second, third, fourth syntax elements may be signalled, wherein the second, third, and fourth syntax elements are conditionally signalled only if the first syntax indicates that template aspects are allowed in the bitstream.
      i. Additionally, when not present (signalled), the syntax element may be inferred to be equal to a certain number which means template aspect is not enabled/allowed.
   i. For example, the first, fourth, fifth syntax elements may be signalled, wherein the fourth and fifth syntax elements are conditionally signalled only if the first syntax indicates that template aspects are allowed in the bitstream.
      i. Additionally, when not present (signalled), the syntax element may be inferred to be equal to a certain number which means template aspect is not enabled/allowed.
   j. For example, the second, third, and fourth syntax elements may be signalled independently.
   k. For example, the fourth and fifth syntax elements may be signalled independently.
2) A High Level Syntax Element May be Signalled to Control the Enabling/Disabling/Allowance/Disallowance of template aspects for intra and/or IBC tools.
   a. For example, an SPS flag (e.g., sps tin non-inter flag) may be signalled at sequence level to control the template aspects for intra and IBC tools.
   b. For example, an SPS flag (e.g., sps tm ibc/intra flag) may be signalled at sequence level to control the template aspects for intra or IBC tools.
3) The template parts of local-boosting cross-component prediction may be controlled based on IBC and/or intra TM control (e.g., sps ibc/intra/non-inter tm flag).
   a. For example, whether and/or how to use template cost based intra chroma fusion (e.g., fuse an angular intra mode with an LM mode) may be controlled by such IBC and/or intra TM control (e.g., sps ibc/intra/non-inter tin flag).
   b. For example, whether and/or how to use template cost based method for CCCM training region determination (e.g., whether to use M lines or N lines training region (such as M=2 and N=6), or, whether to use collocated luma samples or neighboring luma samples to calculate the multi-model threshold) may be controlled by such IBC and/or intra TM control (e.g., sps ibc/intra/non-inter tm flag).
4) The ARMC control (e.g., sps armc flag) may be used to control the enabling/disabling/allowance/disallowance of ARMC aspects for intra/inter/IBC tools, but it may be a necessary condition rather than sufficient conditions.
   a. The ARMC part of IBC/intra coding tools may be controlled based on both ARMC control (e.g., sps armc flag) and IBC/intra TM control (e.g., sps ibc/intra/non-inter tin flag).
      i. For example, only if both ARMC (e.g., sps armc flag) and ibc/intra TM (e.g., sps ibc/intra/non-inter tm flag) are turned on, the ARMC may be allowed/enabled for IBC/intra coding tools.
   b. The ARMC part of IBC/intra coding tools may NOT be controlled based on inter TM control (e.g., sps inter tin flag).
   c. The ARMC part of inter coding tools may be controlled based on both ARMC control (e.g., sps armc flag) and inter TM control (e.g., sps inter tm flag).
      i. For example, only if both ARMC (e.g., sps armc flag) and inter TM (e.g., sps inter tm flag) are turned on, the ARMC may be allowed/enabled for inter coding tools.
5) More than one syntax element may be signalled to control the on/off of ARMC.
   a. For example, a first high level syntax element may be signalled to control the enabling/disabling/allowance/disallowance of ARMC for inter tools.
   b. For example, a second high level syntax element may be signalled to control the enabling/disabling/allowance/disallowance of ARMC for intra tools.
   c. For example, a third high level syntax element may be signalled to control the enabling/disabling/allowance/disallowance of ARMC for IBC tools.
   d. Alternatively, a high level syntax element may be signalled to control the enabling/disabling/allowance/disallowance of ARMC for non-inter (such as intra, and IBC, and/or PLT, etc.) tools.
6) Template based Intra/IBC coding tools may be controlled based on IBC/intra TM control (e.g., sps ibc/intra/non-inter tm flag).
   a. For example, whether to enable/allow ARMC for IBC merge list/candidates reordering.
   b. For example, whether to enable/allow ARMC for IBC merge list/candidates reordering.
   c. For example, whether to enable/allow ARMC for IBC MBVD list/candidates reordering.
   d. For example, whether to enable/allow ARMC for IBC HMVP candidates reordering.
   e. For example, whether to enable/allow ARMC for IBC non-adjacent candidates reordering.
   f. For example, whether to enable/allow ARMC for CCP merge candidates/list reordering.
   g. For example, whether to enable/allow ARMC for intraTMP candidates reordering.
   h. For example, whether to enable/allow IBC BVD prediction based techniques.
   i. For example, whether to enable/allow IBC BVP clustering based techniques.
   j. For example, whether to enable/allow intra DBV based techniques (e.g., ARMC for intra DBV).
   k. For example, whether to enable/allow intraTMP based techniques.
   l. For example, whether to enable/allow TIMD based techniques.
   m. For example, whether to enable/allow SGPM based techniques.
   n. For example, whether to enable/allow TMRL based techniques.
   o. For example, whether to enable/allow MPM sorting based techniques.
   p. For example, whether to enable/allow TM-IBC based techniques.
   q. For example, whether to enable/allow CCP merge based techniques.
   r. Furthermore, whether a TM based IBC/intra coding tool is allowed/enabled may be controlled by the ibc/intra TM control (e.g., sps ibc/intra/non-inter tm flag).
      i. For example, when the ibc/intra TM control indicates that the IBC/intra TM is disabled/disallowed, the syntax elements for TM based IBC/intra coding tools may not be signalled and inferred to be not enabled/allowed.
7) Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
8) Whether to and/or how to apply the disclosed methods above may be signalled at PB/TB/CB/PU/TU/CU/VPDU/CTU/CTU row/slice/tile/sub-picture/other kinds of region contain more than one sample or pixel.
9) Whether to and/or how to apply the disclosed methods above may be dependent on coded information, such as block size, colour format, single/dual tree partitioning, colour component, slice/picture type.

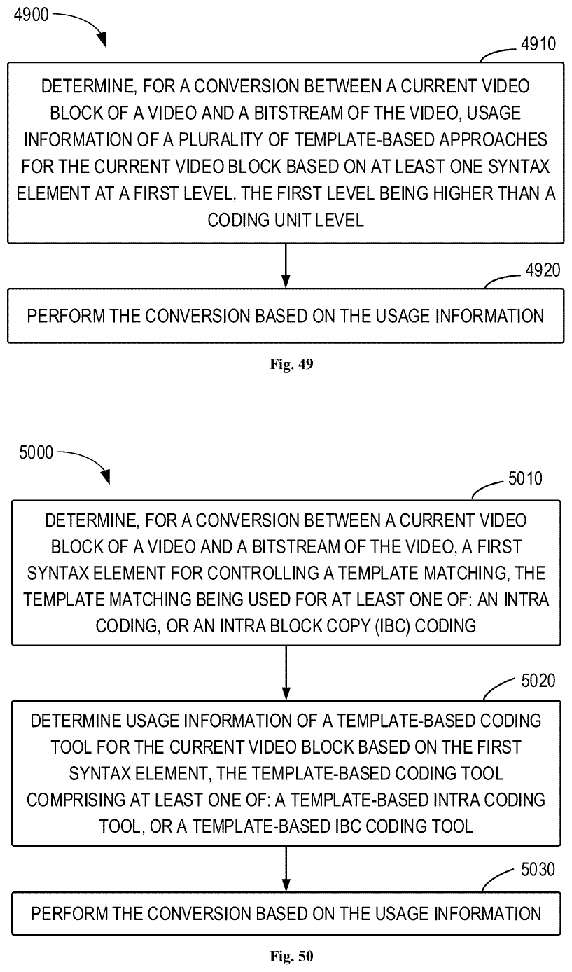

FIG. 49 illustrates a flowchart of a method 4900 for video processing in accordance with embodiments of the present disclosure. The method 4900 is implemented during a conversion between a video unit or a video block of a video and a bitstream of the video.

At block 4910, for a conversion between a current video block of a video and a bitstream of the video, usage information of a plurality of template-based approaches is determined for the current video block based on at least one syntax element at a first level. The first level is higher than a coding unit level. As used herein, the systax element at the first level may be referred to as a high level syntax element. The plurality of template-based approaches comprises at least two coding tools associated with at least one of: intra coding, inter coding, or intra block copy (IBC) coding.

At block 4920, the conversion is performed based on the usage information. In some embodiments, the conversion comprises encoding the current video block into the bitstream. Alternatively, or in addition, the conversion comprises decoding the current video block from the bitstream.

The method 4900 enables determining the usage information of the template-based approaches based on high level syntax element. In this way, the coding efficiency and/or coding effectiveness can be improved.

In some embodiments, the at least one syntax element comprises at least one of: a first syntax element at the first level in the bitstream, the first syntax element indicating one of: enabling, disabling, allowance or disallowance of a template-based determination, without considering whether the template-based determination is used to an intra tool, an IBC tool, a palette (PLT) tool, or an inter tool, a second syntax element at the first level in the bitstream, the second syntax element indicating one of: enabling, disabling, allowance or disallowance of a template-based determination for an intra tool, a third syntax element at the first level in the bitstream, the third syntax element indicating at least one of: enabling, disabling, allowance or disallowance of a template-based determination for an IBC tool, a fourth syntax element at the first level in the bitstream, the fourth syntax element indicating one of: enabling, disabling, allowance or disallowance of a template-based determination for an inter tool, or a fifth syntax element at the first level in the bitstream, the fifth syntax element indicating one of: enabling, disabling, allowance or disallowance of a template-based determination for a non-inter tool. The template-based determination may be referred to as template-based determination aspect or template aspect herein. The template aspect may be any method, tool, parameter or value associated with a template-based process or tool.

In some embodiments, the non-inter tool comprises at least one of: an intra tool, an IBC tool or a palette (PLT) tool.

In some embodiments, whether at least one of the second, the third, the fourth or the fifth syntax element is included in the bitstream is based on the first syntax element.

In some embodiments, the first syntax element indicates enabling or allowance of the template-based determination in the bitstream, and the fourth and fifth syntax elements are included in the bitstream.

In some embodiments, the fourth and fifth syntax elements are excluded from the bitstream and determined to be a predetermined number, the predetermined number indicative of disabling or disallowance of the template-based determination.

In some embodiments, the first syntax element indicates enabling or allowance of the template-based determination in the bitstream, and the second, the third and the fourth syntax elements are included in the bitstream.

In some embodiments, the second, the third and the fourth syntax elements are excluded from the bitstream and determined to be a predetermined number, the predetermined number indicative of disabling or disallowance of the template-based determination.

In some embodiments, the second, the third and the fourth syntax elements are included in the bitstream independently.

In some embodiments, the fourth syntax element and the fifth syntax element are included in the bitstream independently.

In some embodiments, the at least one syntax element comprises a syntax element controlling at least one of: enabling, disabling, allowance or disallowance of a template-based determination for at least one of: an intra tool, or an IBC tool.

In some embodiments, the syntax element comprises a sequence parameter set (SPS) flag at a sequence level controlling at least one of: enabling, disabling, allowance or disallowance of the template-based determination for the intra tool and the IBC tool.

In some embodiments, the syntax element comprises a sequence parameter set (SPS) flag at a sequence level controlling at least one of: enabling, disabling, allowance or disallowance of the template-based determination for the intra tool or the IBC tool.

In some embodiments, the SPS flag comprises an SPS template matching non-inter flag.

In some embodiments, the plurality of template-based approaches comprises at least one of: a coding tool involving a template with search or a coding tool involving a template without search.

In some embodiments, the coding tool involving the template with search comprises at least one of: a template cost calculation, or a template matching.

In some embodiments, the coding tool involving the template without search comprises at least one of: a decoder side intra mode derivation (DIMD), a convolutional cross-component model (CCCM), a linear model (LM), a cross-component linear model (CCLM), a gradient linear model (GLM), or a local illumination compensation (LIC).

In some embodiments, the template-based determination indicates whether to use the plurality of template-based approaches for the current video block.

In some embodiments, the first level comprises one of: a sequence level, a group of pictures level, a picture header level, a picture level, a slice header level, a slice level, or a tile group level.

In some embodiments, an indication of whether to and/or how to determine the usage information based on the at least one syntax element at the first level is included in the bitstream at one of: a sequence level, a group of pictures level, a picture level, a slice level, or a tile group level.

In some embodiments, an indication of whether to and/or how to determine the usage information based on the at least one syntax element at the first level is included in the bitstream in one of: a sequence header, a picture header, a sequence parameter set (SPS), a video parameter set (VPS), a dependency parameter set (DPS), a decoding capability information (DCI), a picture parameter set (PPS), an adaptation parameter set (APS), a slice header, or a tile group header.

In some embodiments, an indication of whether to and/or how to determine the usage information based on the at least one syntax element at the first level is included in the bitstream in one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 4900 further comprises: determining, based on coded information of the current video block, whether to and/or how to determine the usage information based on the at least one syntax element at the first level, the coded information including at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. In the method, usage information of a plurality of template-based approaches is determined for a current video block of the video based on at least one syntax element at a first level. The first level is higher than a coding unit level. The plurality of template-based approaches comprises at least two coding tools associated with at least one of: intra coding, inter coding, or intra block copy (IBC) coding. The bitstream is generated based on the usage information.

According to still further embodiments of the present disclosure, a method for storing bitstream of a video is provided. In the method, usage information of a plurality of template-based approaches is determined for a current video block of the video based on at least one syntax element at a first level. The first level is higher than a coding unit level. The plurality of template-based approaches comprises at least two coding tools associated with at least one of: intra coding, inter coding, or intra block copy (IBC) coding. The bitstream is generated based on the usage information. The bitstream is stored in a non-transitory computer-readable recoding medium.

FIG. 50 illustrates a flowchart of a method 5000 for video processing in accordance with embodiments of the present disclosure. The method 5000 is implemented during a conversion between a video unit or a video block of a video and a bitstream of the video.

At block 5010, for a conversion between a current video block of a video and a bitstream of the video, a first syntax element for controlling a template matching is determined. The template matching is used for at least one of: an intra coding, or an intra block copy (IBC) coding.

At block 5020, usage information of a template-based coding tool is determined for the current video block based on the first syntax element. The template-based coding tool comprises at least one of: a template-based intra coding tool, or a template-based IBC coding tool.

At block 5030, the conversion is performed based on the usage information. In some embodiments, the conversion comprises encoding the current video block into the bitstream. Alternatively, or in addition, the conversion comprises decoding the current video block from the bitstream.

The method 5000 enables determining the usage information of the template-based coding tool based on the high-level syntax element. In this way, the coding efficiency and/or coding effectiveness can be improved.

In some embodiments, the first syntax element comprises at least one of: a sequence parameter set (SPS) IBC template matching flag, an SPS intra template matching flag, or an SPS non-inter template matching flag.

In some embodiments, the template-based coding tool comprises an adaptive reordering of merge candidates (ARMC) for IBC merge list reordering or an ARMC for IBC merge candidates reordering.

In some embodiments, the template-based coding tool comprises an adaptive reordering of merge candidates (ARMC) for IBC merge mode with block vector differences (IBC-MBVD) list reordering or an ARMC for IBC-MBVD candidates reordering.

In some embodiments, the template-based coding tool comprises an adaptive reordering of merge candidates (ARMC) for IBC history-based motion vector prediction (HMVP) candidates reordering.

In some embodiments, the template-based coding tool comprises an adaptive reordering of merge candidates (ARMC) for IBC non-adjacent candidates reordering.

In some embodiments, the template-based coding tool comprises an adaptive reordering of merge candidates (ARMC) for cross-component prediction (CCP) merge candidates reordering or an ARMC for CCP merge list reordering.

In some embodiments, the template-based coding tool comprises an adaptive reordering of merge candidates (ARMC) for intra template matching prediction (intraTMP) candidates reordering.

In some embodiments, the template-based coding tool comprises an IBC block vector differences (BVD) prediction-based tool.

In some embodiments, the template-based coding tool comprises an IBC block vector prediction (BVP) clustering-based tool.

In some embodiments, the template-based coding tool comprises an intra derived block vector (DBV) based tool.

In some embodiments, the intra DBV based tool comprises an adaptive reordering of merge candidates (ARMC) for intra DBV.

In some embodiments, the template-based coding tool comprises an intra template matching prediction (intraTMP) based tool.

In some embodiments, the template-based coding tool comprises a template-based intra mode derivation (TIMD) based tool.

In some embodiments, the template-based coding tool comprises spatial geometric partitioning mode (SGPM) based approaches.

In some embodiments, the template-based coding tool comprises a template-based multiple reference line (TMRL) based tool.

In some embodiments, the template-based coding tool comprises a most probable modes (MPM) sorting based tool.

In some embodiments, the template-based coding tool comprises a template matching IBC (TM-IBC) based tool.

In some embodiments, the template-based coding tool comprises a cross-component prediction (CCP) merge based tool.

In some embodiments, whether the template-based coding tool is allowed or enabled is based on the first syntax element.

In some embodiments, the first syntax element indicates that the template matching for IBC or intra is disabled or disallowed, a syntax element for the template-based coding tool is excluded from the bitstream, and the template-based coding tool is determined to be disabled or disallowed.

In some embodiments, the usage information indicates whether to enable or allow the template-based coding tool.

In some embodiments, an indication of whether to and/or how to determine the usage information of the template-based coding tool for the current video block based on the first syntax element is included in the bitstream at one of: a sequence level, a group of pictures level, a picture level, a slice level, or a tile group level.

In some embodiments, an indication of whether to and/or how to determine the usage information of the template-based coding tool for the current video block based on the first syntax element is included in the bitstream in one of: a sequence header, a picture header, a sequence parameter set (SPS), a video parameter set (VPS), a dependency parameter set (DPS), a decoding capability information (DCI), a picture parameter set (PPS), an adaptation parameter set (APS), a slice header, or a tile group header.

In some embodiments, an indication of whether to and/or how to determine the usage information of the template-based coding tool for the current video block based on the first syntax element is included in the bitstream in one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 5000 further comprises: determining, based on coded information of the current video block, whether to and/or how to determine the usage information of the template-based coding tool for the current video block based on the first syntax element, the coded information including at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. In the method, a first syntax element for controlling a template matching is determined. The template matching is used for at least one of: an intra coding, or an intra block copy (IBC) coding. Usage information of a template-based coding tool is determined for a current video block of the video based on the first syntax element. The template-based coding tool comprises at least one of: a template-based intra coding tool, or a template-based IBC coding tool. The bitstream is generated based on the usage information.

According to still further embodiments of the present disclosure, a method for storing bitstream of a video is provided. In the method, a first syntax element for controlling a template matching is determined. The template matching is used for at least one of: an intra coding, or an intra block copy (IBC) coding. Usage information of a template-based coding tool is determined for a current video block of the video based on the first syntax element. The template-based coding tool comprises at least one of: a template-based intra coding tool, or a template-based IBC coding tool. The bitstream is generated based on the usage information. The bitstream is stored in a non-transitory computer-readable recording medium.

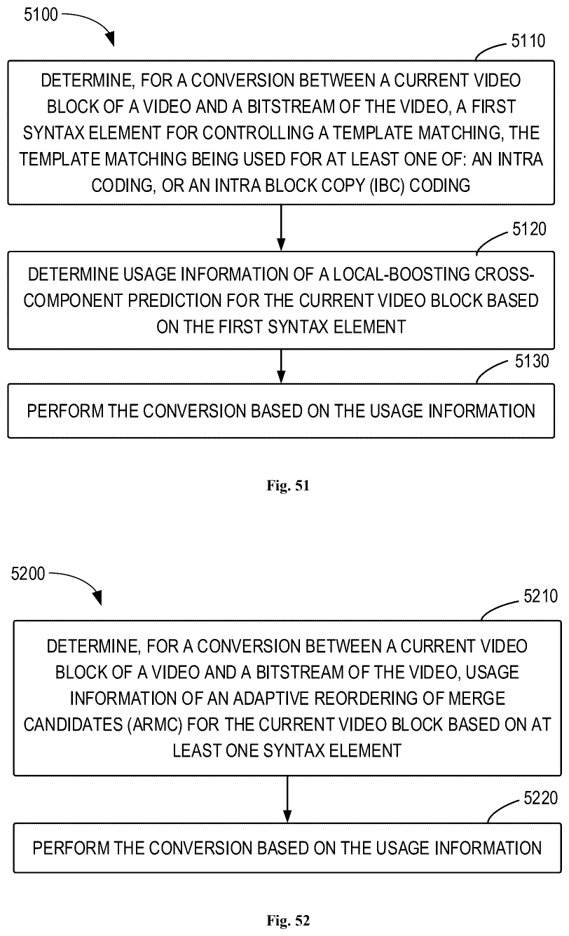

FIG. 51 illustrates a flowchart of a method 5100 for video processing in accordance with embodiments of the present disclosure. The method 5100 is implemented during a conversion between a video unit or a video block of a video and a bitstream of the video.

At block 5110, for a conversion between a current video block of a video and a bitstream of the video, a first syntax element for controlling a template matching is determined. The template matching is used for at least one of: an intra coding, or an intra block copy (IBC) coding.

At block 5120, usage information of a local-boosting cross-component prediction is determined for the current video block based on the first syntax element.

At block 5130, the conversion is performed based on the usage information. In some embodiments, the conversion comprises encoding the current video block into the bitstream. Alternatively, or in addition, the conversion comprises decoding the current video block from the bitstream.

The method 5100 enables determining the usage information of the local-boosting cross-component prediction based on a syntax element for the template matching. In this way, the coding efficiency and/or coding effectiveness can be improved.

In some embodiments, the first syntax element comprises at least one of: a sequence parameter set (SPS) IBC template matching flag, an SPS intra template matching flag, or an SPS non-inter template matching flag.

In some embodiments, the first syntax element indicates whether and/or how to use a template cost based intra chroma fusion.

In some embodiments, the template cost based intra chroma fusion comprises fusing an angular intra mode with a linear model (LM) mode.

In some embodiments, the first syntax element indicates whether and/or how to use a template cost-based approach for a convolutional cross-component model (CCCM) training region determination.

In some embodiments, the CCCM training region determination comprises at least one of: whether to use M lines or N lines training region, M and N being positive integers, or whether to use collocated luma samples or neighboring luma samples to calculate a multi-model threshold.

In some embodiments, an indication of whether to and/or how to determine the usage information of the local-boosting cross-component prediction for the current video block based on the first syntax element is included in the bitstream at one of: a sequence level, a group of pictures level, a picture level, a slice level, or a tile group level.

In some embodiments, an indication of whether to and/or how to determine the usage information of the local-boosting cross-component prediction for the current video block based on the first syntax element is included in the bitstream in one of: a sequence header, a picture header, a sequence parameter set (SPS), a video parameter set (VPS), a dependency parameter set (DPS), a decoding capability information (DCI), a picture parameter set (PPS), an adaptation parameter set (APS), a slice header, or a tile group header.

In some embodiments, an indication of whether to and/or how to determine the usage information of the local-boosting cross-component prediction for the current video block based on the first syntax element is included in the bitstream in one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 5100 further comprises: determining, based on coded information of the current video block, whether to and/or how to determine the usage information of the local-boosting cross-component prediction for the current video block based on the first syntax element, the coded information including at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. In the method, a first syntax element for controlling a template matching is determined. The template matching is used for at least one of: an intra coding, or an intra block copy (IBC) coding. Usage information of a local-boosting cross-component prediction is determined for a current video block of the video based on the first syntax element. The bitstream is generated based on the usage information.

According to still further embodiments of the present disclosure, a method for storing bitstream of a video is provided. In the method, a first syntax element for controlling a template matching is determined. The template matching is used for at least one of: an intra coding, or an intra block copy (IBC) coding. Usage information of a local-boosting cross-component prediction is determined for a current video block of the video based on the first syntax element. The bitstream is generated based on the usage information. The bitstream is stored in a non-transitory computer-readable recoding medium.

FIG. 52 illustrates a flowchart of a method 5200 for video processing in accordance with embodiments of the present disclosure. The method 5200 is implemented during a conversion between a video unit or a video block of a video and a bitstream of the video.

At block 5210, for a conversion between a current video block of a video and a bitstream of the video, usage information of an adaptive reordering of merge candidates (ARMC) is determined for the current video block based on at least one syntax element.

At block 5220, the conversion is performed based on the usage information. In some embodiments, the conversion comprises encoding the current video block into the bitstream. Alternatively, or in addition, the conversion comprises decoding the current video block from the bitstream.

The method 5200 enables determining the usage information of the ARMC based on the at least one syntax element. In this way, the coding efficiency and/or coding effectiveness can be improved.

In some embodiments, the at least one syntax element comprises a first syntax element at a first level in the bitstream, the first level being higher than a coding unit level, the first syntax element indicating at least one of: enabling, disabling, allowance or disallowance of ARMC for an inter tool.

In some embodiments, the at least one syntax element comprises a second syntax element at a first level in the bitstream, the first level being higher than a coding unit level, the second syntax element indicating at least one of: enabling, disabling, allowance or disallowance of ARMC for an intra tool.

In some embodiments, the at least one syntax element comprises a third syntax element at a first level in the bitstream, the first level being higher than a coding unit level, the third syntax element indicating at least one of: enabling, disabling, allowance or disallowance of ARMC for an intra block copy (IBC) tool.

In some embodiments, the at least one syntax element comprises a fourth syntax element at a first level in the bitstream, the first level being higher than a coding unit level, the fourth syntax element indicating at least one of: enabling, disabling, allowance or disallowance of ARMC for a non-inter tool.

In some embodiments, the at least one syntax element indicates enabling, disabling, allowance or disallowance of an ARMC for at least one of: an intra tool, an inter tool, or an IBC tool.

In some embodiments, the enabling or allowance of the ARMC is further based on additional information or syntax element.

In some embodiments, whether to use the ARMC for at least one of: an intra tool or an intra block copy (IBC) tool is determined based on the at least one syntax element and a further syntax element controlling a template matching, the template matching being used for at least one of: an intra coding, or an IBC coding.

In some embodiments, whether to use the ARMC for at least one of: an intra tool or an intra block copy (IBC) tool is determined regardless of a further syntax element for controlling an inter template matching.

In some embodiments, whether to use the ARMC for at least one of: an intra tool or an intra block copy (IBC) tool is determined based on the at least one syntax element and a further syntax element for controlling an inter template matching.

In some embodiments, the ARMC is allowed or enabled for an inter coding tool based on the at least one syntax element indicative of enabling or allowance of the ARMC and the further syntax element indicative of enabling or allowance of the inter template matching.

In some embodiments, the at least one syntax element comprises a sequence parameter set (SPS) ARMC flag, and the further syntax element comprises an SPS inter TM flag.

In some embodiments, an indication of whether to and/or how to determine the usage information of ARMC for the current video block based on the at least one syntax element is included in the bitstream at one of: a sequence level, a group of pictures level, a picture level, a slice level, or a tile group level.

In some embodiments, an indication of whether to and/or how to determine the usage information of ARMC for the current video block based on at least one syntax element is included in the bitstream in one of: a sequence header, a picture header, a sequence parameter set (SPS), a video parameter set (VPS), a dependency parameter set (DPS), a decoding capability information (DCI), a picture parameter set (PPS), an adaptation parameter set (APS), a slice header, or a tile group header.

In some embodiments, an indication of whether to and/or how to determine the usage information of ARMC for the current video block based on at least one syntax element is included in the bitstream in one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 5200 further comprises: determining, based on coded information of the current video block, whether to and/or how to determine the usage information of ARMC for the current video block based on the at least one syntax element, the coded information including at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. In the method, usage information of an adaptive reordering of merge candidates (ARMC) is determined for a current video block of the video based on at least one syntax element. The bitstream is generated based on the usage information.

According to still further embodiments of the present disclosure, a method for storing bitstream of a video is provided. In the method, usage information of an adaptive reordering of merge candidates (ARMC) is determined for a current video block of the video based on at least one syntax element. The bitstream is generated based on the usage information. The bitstream is stored in a non-transitory computer-readable recording medium.

Implementations of the present disclosure can be described in view of the following clauses, the features of which can be combined in any reasonable manner.

Clause 1. A method for video processing, comprising: determining, for a conversion between a current video block of a video and a bitstream of the video, usage information of a plurality of template-based approaches for the current video block based on at least one syntax element at a first level, the first level being higher than a coding unit level; and performing the conversion based on the usage information, wherein the plurality of template-based approaches comprises at least two coding tools associated with at least one of: intra coding, inter coding, or intra block copy (IBC) coding.

Clause 2. The method of clause 1, wherein the at least one syntax element comprises at least one of: a first syntax element at the first level in the bitstream, the first syntax element indicating one of: enabling, disabling, allowance or disallowance of a template-based determination, without considering whether the template-based determination is used to an intra tool, an IBC tool, a palette (PLT) tool, or an inter tool, a second syntax element at the first level in the bitstream, the second syntax element indicating one of: enabling, disabling, allowance or disallowance of a template-based determination for an intra tool, a third syntax element at the first level in the bitstream, the third syntax element indicating at least one of: enabling, disabling, allowance or disallowance of a template-based determination for an IBC tool, a fourth syntax element at the first level in the bitstream, the fourth syntax element indicating one of: enabling, disabling, allowance or disallowance of a template-based determination for an inter tool, or a fifth syntax element at the first level in the bitstream, the fifth syntax element indicating one of: enabling, disabling, allowance or disallowance of a template-based determination for a non-inter tool.

Clause 3. The method of clause 2, wherein the non-inter tool comprises at least one of: an intra tool, an IBC tool or a palette (PLT) tool.

Clause 4. The method of clause 2, wherein whether at least one of the second, the third, the fourth or the fifth syntax element is included in the bitstream is based on the first syntax element.

Clause 5. The method of clause 4, wherein the first syntax element indicates enabling or allowance of the template-based determination in the bitstream, and the fourth and fifth syntax elements are included in the bitstream.

Clause 6. The method of clause 4, wherein the fourth and fifth syntax elements are excluded from the bitstream and determined to be a predetermined number, the predetermined number indicative of disabling or disallowance of the template-based determination.

Clause 7. The method of clause 4, wherein the first syntax element indicates enabling or allowance of the template-based determination in the bitstream, and the second, the third and the fourth syntax elements are included in the bitstream.

Clause 8. The method of clause 4, wherein the second, the third and the fourth syntax elements are excluded from the bitstream and determined to be a predetermined number, the predetermined number indicative of disabling or disallowance of the template-based determination.

Clause 9. The method of clause 2, wherein the second, the third and the fourth syntax elements are included in the bitstream independently.

Clause 10. The method of clause 2, wherein the fourth syntax element and the fifth syntax element are included in the bitstream independently.

Clause 11. The method of clause 2, wherein the at least one syntax element comprises a syntax element controlling at least one of: enabling, disabling, allowance or disallowance of a template-based determination for at least one of: an intra tool, or an IBC tool.

Clause 12. The method of clause 11, wherein the syntax element comprises a sequence parameter set (SPS) flag at a sequence level controlling at least one of: enabling, disabling, allowance or disallowance of the template-based determination for the intra tool and the IBC tool.

Clause 13. The method of clause 11, wherein the syntax element comprises a sequence parameter set (SPS) flag at a sequence level controlling at least one of: enabling, disabling, allowance or disallowance of the template-based determination for the intra tool or the IBC tool.

Clause 14. The method of clause 12 or clause 13, wherein the SPS flag comprises an SPS template matching non-inter flag.

Clause 15. The method of any of clauses 1-14, wherein the plurality of template-based approaches comprises at least one of: a coding tool involving a template with search or a coding tool involving a template without search.

Clause 16. The method of clause 15, wherein the coding tool involving the template with search comprises at least one of: a template cost calculation, or a template matching.

Clause 17. The method of clause 15, wherein the coding tool involving the template without search comprises at least one of: a decoder side intra mode derivation (DIMD), a convolutional cross-component model (CCCM), a linear model (LM), a cross-component linear model (CCLM), a gradient linear model (GLM), or a local illumination compensation (LIC).

Clause 18. The method of any of clauses 1-17, wherein the template-based determination indicates whether to use the plurality of template-based approaches for the current video block.

Clause 19. The method of any of clauses 1-18, wherein the first level comprises one of: a sequence level, a group of pictures level, a picture header level, a picture level, a slice header level, a slice level, or a tile group level.

Clause 20. The method of clause 1-19, wherein an indication of whether to and/or how to determine the usage information based on the at least one syntax element at the first level is included in the bitstream at one of: a sequence level, a group of pictures level, a picture level, a slice level, or a tile group level.

Clause 21. The method of any of clauses 1-19, wherein an indication of whether to and/or how to determine the usage information based on the at least one syntax element at the first level is included in the bitstream in one of: a sequence header, a picture header, a sequence parameter set (SPS), a video parameter set (VPS), a dependency parameter set (DPS), a decoding capability information (DCI), a picture parameter set (PPS), an adaptation parameter set (APS), a slice header, or a tile group header.

Clause 22. The method of any of clauses 1-19, wherein an indication of whether to and/or how to determine the usage information based on the at least one syntax element at the first level is included in the bitstream in one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 23. The method of any of clauses 1-19, further comprising: determining, based on coded information of the current video block, whether to and/or how to determine the usage information based on the at least one syntax element at the first level, the coded information including at least one of: a block size, a colour format, a single and/or dual tree partitioning, a colour component, a slice type, or a picture type.

Clause 24. A method for video processing, comprising: determining, for a conversion between a current video block of a video and a bitstream of the video, a first syntax element for controlling a template matching, the template matching being used for at least one of: an intra coding, or an intra block copy (IBC) coding; determining usage information of a template-based coding tool for the current video block based on the first syntax element, the template-based coding tool comprising at least one of: a template-based intra coding tool, or a template-based IBC coding tool; and performing the conversion based on the usage information.

Clause 25. The method of clause 24, wherein the first syntax element comprises at least one of: a sequence parameter set (SPS) IBC template matching flag, an SPS intra template matching flag, or an SPS non-inter template matching flag.

Clause 26. The method of clause 24 or 25, wherein the template-based coding tool comprises an adaptive reordering of merge candidates (ARMC) for IBC merge list reordering or an ARMC for IBC merge candidates reordering.

Clause 27. The method of clause 24 or 25, wherein the template-based coding tool comprises an adaptive reordering of merge candidates (ARMC) for IBC merge mode with block vector differences (IBC-MBVD) list reordering or an ARMC for IBC-MBVD candidates reordering.

Clause 28. The method of clause 24 or 25, wherein the template-based coding tool comprises an adaptive reordering of merge candidates (ARMC) for IBC history-based motion vector prediction (HMVP) candidates reordering.

Clause 29. The method of clause 24 or 25, wherein the template-based coding tool comprises an adaptive reordering of merge candidates (ARMC) for IBC non-adjacent candidates reordering.

Clause 30. The method of clause 24 or 25, wherein the template-based coding tool comprises an adaptive reordering of merge candidates (ARMC) for cross-component prediction (CCP) merge candidates reordering or an ARMC for CCP merge list reordering.

Clause 31. The method of clause 24 or 25, wherein the template-based coding tool comprises an adaptive reordering of merge candidates (ARMC) for intra template matching prediction (intraTMP) candidates reordering.

Clause 32. The method of clause 24 or 25, wherein the template-based coding tool comprises an IBC block vector differences (BVD) prediction-based tool.

Clause 33. The method of clause 24 or 25, wherein the template-based coding tool comprises an IBC block vector prediction (BVP) clustering-based tool.

Clause 34. The method of clause 24 or 25, wherein the template-based coding tool comprises an intra derived block vector (DBV) based tool.

Clause 35. The method of clause 34, wherein the intra DBV based tool comprises an adaptive reordering of merge candidates (ARMC) for intra DBV.

Clause 36. The method of clause 24 or 25, wherein the template-based coding tool comprises an intra template matching prediction (intraTMP) based tool.

Clause 37. The method of clause 24 or 25, wherein the template-based coding tool comprises a template-based intra mode derivation (TIMD) based tool.

Clause 38. The method of clause 24 or 25, wherein the template-based coding tool comprises spatial geometric partitioning mode (SGPM) based approaches.

Clause 39. The method of clause 24 or 25, wherein the template-based coding tool comprises a template-based multiple reference line (TMRL) based tool.

Clause 40. The method of clause 24 or 25, wherein the template-based coding tool comprises a most probable modes (MPM) sorting based tool.

Clause 41. The method of clause 24 or 25, wherein the template-based coding tool comprises a template matching IBC (TM-IBC) based tool.

Clause 42. The method of clause 24 or 25, wherein the template-based coding tool comprises a cross-component prediction (CCP) merge based tool.

Clause 43. The method of any of clauses 24-42, wherein whether the template-based coding tool is allowed or enabled is based on the first syntax element.

Clause 44. The method of any of clauses 24-43, wherein the first syntax element indicates that the template matching for IBC or intra is disabled or disallowed, a syntax element for the template-based coding tool is excluded from the bitstream, and the template-based coding tool is determined to be disabled or disallowed.

Clause 45. The method of any of claims 24-44, wherein the usage information indicates whether to enable or allow the template-based coding tool.

Clause 46. The method of any of clauses 24-45, wherein an indication of whether to and/or how to determine the usage information of the template-based coding tool for the current video block based on the first syntax element is included in the bitstream at one of: a sequence level, a group of pictures level, a picture level, a slice level, or a tile group level.

Clause 47. The method of any of clauses 24-45, wherein an indication of whether to and/or how to determine the usage information of the template-based coding tool for the current video block based on the first syntax element is included in the bitstream in one of: a sequence header, a picture header, a sequence parameter set (SPS), a video parameter set (VPS), a dependency parameter set (DPS), a decoding capability information (DCI), a picture parameter set (PPS), an adaptation parameter set (APS), a slice header, or a tile group header.

Clause 48. The method of any of clauses 24-45, wherein an indication of whether to and/or how to determine the usage information of the template-based coding tool for the current video block based on the first syntax element is included in the bitstream in one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 49. The method of any of clauses 24-45, further comprising: determining, based on coded information of the current video block, whether to and/or how to determine the usage information of the template-based coding tool for the current video block based on the first syntax element, the coded information including at least one of: a block size, a colour format, a single and/or dual tree partitioning, a colour component, a slice type, or a picture type.

Clause 50. A method for video processing, comprising: determining, for a conversion between a current video block of a video and a bitstream of the video, a first syntax element for controlling a template matching, the template matching being used for at least one of: an intra coding, or an intra block copy (IBC) coding; determining usage information of a local-boosting cross-component prediction for the current video block based on the first syntax element; and performing the conversion based on the usage information.

Clause 51. The method of clause 50, wherein the first syntax element comprises at least one of: a sequence parameter set (SPS) IBC template matching flag, an SPS intra template matching flag, or an SPS non-inter template matching flag.

Clause 52. The method of clause 50 or 51, wherein the first syntax element indicates whether and/or how to use a template cost based intra chroma fusion.

Clause 53. The method of clause 52, wherein the template cost based intra chroma fusion comprises fusing an angular intra mode with a linear model (LM) mode.

Clause 54. The method of clause 50 or 51, wherein the first syntax element indicates whether and/or how to use a template cost-based approach for a convolutional cross-component model (CCCM) training region determination.

Clause 55. The method of clause 54, wherein the CCCM training region determination comprises at least one of: whether to use M lines or N lines training region, M and N being positive integers, or whether to use collocated luma samples or neighboring luma samples to calculate a multi-model threshold.

Clause 56. The method of any of clauses 50-55, wherein an indication of whether to and/or how to determine the usage information of the local-boosting cross-component prediction for the current video block based on the first syntax element is included in the bitstream at one of: a sequence level, a group of pictures level, a picture level, a slice level, or a tile group level.

Clause 57. The method of any of clauses 50-55, wherein an indication of whether to and/or how to determine the usage information of the local-boosting cross-component prediction for the current video block based on the first syntax element is included in the bitstream in one of: a sequence header, a picture header, a sequence parameter set (SPS), a video parameter set (VPS), a dependency parameter set (DPS), a decoding capability information (DCI), a picture parameter set (PPS), an adaptation parameter set (APS), a slice header, or a tile group header.

Clause 58. The method of any of clauses 50-55, wherein an indication of whether to and/or how to determine the usage information of the local-boosting cross-component prediction for the current video block based on the first syntax element is included in the bitstream in one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 59. The method of any of clauses 50-55, further comprising: determining, based on coded information of the current video block, whether to and/or how to determine the usage information of the local-boosting cross-component prediction for the current video block based on the first syntax element, the coded information including at least one of: a block size, a colour format, a single and/or dual tree partitioning, a colour component, a slice type, or a picture type.

Clause 60. A method for video processing, comprising: determining, for a conversion between a current video block of a video and a bitstream of the video, usage information of an adaptive reordering of merge candidates (ARMC) for the current video block based on at least one syntax element; and performing the conversion based on the usage information.

Clause 61. The method of clause 60, wherein the at least one syntax element comprises a first syntax element at a first level in the bitstream, the first level being higher than a coding unit level, the first syntax element indicating at least one of: enabling, disabling, allowance or disallowance of ARMC for an inter tool.

Clause 62. The method of clause 60, wherein the at least one syntax element comprises a second syntax element at a first level in the bitstream, the first level being higher than a coding unit level, the second syntax element indicating at least one of: enabling, disabling, allowance or disallowance of ARMC for an intra tool.

Clause 63. The method of clause 60, wherein the at least one syntax element comprises a third syntax element at a first level in the bitstream, the first level being higher than a coding unit level, the third syntax element indicating at least one of: enabling, disabling, allowance or disallowance of ARMC for an intra block copy (IBC) tool.

Clause 64. The method of clause 60, wherein the at least one syntax element comprises a fourth syntax element at a first level in the bitstream, the first level being higher than a coding unit level, the fourth syntax element indicating at least one of: enabling, disabling, allowance or disallowance of ARMC for a non-inter tool.

Clause 65. The method of clause 60, wherein the at least one syntax element indicates enabling, disabling, allowance or disallowance of an ARMC for at least one of: an intra tool, an inter tool, or an IBC tool.

Clause 66. The method of clause 65, wherein the enabling or allowance of the ARMC is further based on additional information or syntax element.

Clause 67. The method of clause 66, wherein whether to use the ARMC for at least one of: an intra tool or an intra block copy (IBC) tool is determined based on the at least one syntax element and a further syntax element controlling a template matching, the template matching being used for at least one of: an intra coding, or an IBC coding.

Clause 68. The method of clause 65, wherein whether to use the ARMC for at least one of: an intra tool or an intra block copy (IBC) tool is determined regardless of a further syntax element for controlling an inter template matching.

Clause 69. The method of clause 68, wherein whether to use the ARMC for at least one of: an intra tool or an intra block copy (IBC) tool is determined based on the at least one syntax element and a further syntax element for controlling an inter template matching.

Clause 70. The method of clause 69, wherein the ARMC is allowed or enabled for an inter coding tool based on the at least one syntax element indicative of enabling or allowance of the ARMC and the further syntax element indicative of enabling or allowance of the inter template matching.

Clause 71. The method of any of clauses 68-70, wherein the at least one syntax element comprises a sequence parameter set (SPS) ARMC flag, and the further syntax element comprises an SPS inter TM flag.

Clause 72. The method of any of clauses 60-71, wherein an indication of whether to and/or how to determine the usage information of ARMC for the current video block based on the at least one syntax element is included in the bitstream at one of: a sequence level, a group of pictures level, a picture level, a slice level, or a tile group level.

Clause 73. The method of any of clauses 60-71, wherein an indication of whether to and/or how to determine the usage information of ARMC for the current video block based on at least one syntax element is included in the bitstream in one of: a sequence header, a picture header, a sequence parameter set (SPS), a video parameter set (VPS), a dependency parameter set (DPS), a decoding capability information (DCI), a picture parameter set (PPS), an adaptation parameter set (APS), a slice header, or a tile group header.

Clause 74. The method of any of clauses 60-71, wherein an indication of whether to and/or how to determine the usage information of ARMC for the current video block based on at least one syntax element is included in the bitstream in one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 75. The method of any of clauses 60-71 further comprising: determining, based on coded information of the current video block, whether to and/or how to determine the usage information of ARMC for the current video block based on the at least one syntax element, the coded information including at least one of: a block size, a colour format, a single and/or dual tree partitioning, a colour component, a slice type, or a picture type.

Clause 76. The method of any of clauses 1-75, wherein the conversion comprising encoding the current video block into the bitstream.

Clause 77. The method of any of clauses 1-75, wherein the conversion comprises decoding the current video block from the bitstream.

Clause 78. An apparatus for video processing comprising a processor and a non-transitory memory with instructions thereon, wherein the instructions upon execution by the processor, cause the processor to perform a method in accordance with any of clauses 1-77.

Clause 79. A non-transitory computer-readable storage medium storing instructions that cause a processor to perform a method in accordance with any of clauses 1-77.

Clause 80. A non-transitory computer-readable recording medium storing a bitstream of a video which is generated by a method performed by an apparatus for video processing, wherein the method comprises: determining usage information of a plurality of template-based approaches for a current video block of the video based on at least one syntax element at a first level, the first level being higher than a coding unit level; and generating the bitstream based on the usage information, wherein the plurality of template-based approaches comprises at least two coding tools associated with at least one of: intra coding, inter coding, or intra block copy (IBC) coding.

Clause 81. A method for storing a bitstream of a video, comprising: determining usage information of a plurality of template-based approaches for a current video block of the video based on at least one syntax element at a first level, the first level being higher than a coding unit level; generating the bitstream based on the usage information; and storing the bitstream in a non-transitory computer-readable recording medium, wherein the plurality of template-based approaches comprises at least two coding tools associated with at least one of: intra coding, inter coding, or intra block copy (IBC) coding.

Clause 82. A non-transitory computer-readable recording medium storing a bitstream of a video which is generated by a method performed by an apparatus for video processing, wherein the method comprises: determining a first syntax element for controlling a template matching, the template matching being used for at least one of: an intra coding, or an intra block copy (IBC) coding; determining usage information of a template-based coding tool for a current video block of the video based on the first syntax element, the template-based coding tool comprising at least one of: a template-based intra coding tool, or a template-based IBC coding tool; and generating the bitstream based on the usage information.

Clause 83. A method for storing a bitstream of a video, comprising: determining a first syntax element for controlling a template matching, the template matching being used for at least one of: an intra coding, or an intra block copy (IBC) coding; determining usage information of a template-based coding tool for a current video block of the video based on the first syntax element, the template-based coding tool comprising at least one of: a template-based intra coding tool, or a template-based IBC coding tool; generating the bitstream based on the usage information; and storing the bitstream in a non-transitory computer-readable recording medium.

Clause 84. A non-transitory computer-readable recording medium storing a bitstream of a video which is generated by a method performed by an apparatus for video processing, wherein the method comprises: determining a first syntax element for controlling a template matching, the template matching being used for at least one of: an intra coding, or an intra block copy (IBC) coding; determining usage information of a local-boosting cross-component prediction for a current video block of the video based on the first syntax element; and generating the bitstream based on the usage information.

Clause 85. A method for storing a bitstream of a video, comprising: determining a first syntax element for controlling a template matching, the template matching being used for at least one of: an intra coding, or an intra block copy (IBC) coding; determining usage information of a local-boosting cross-component prediction for a current video block of the video based on the first syntax element; generating the bitstream based on the usage information; and storing the bitstream in a non-transitory computer-readable recording medium.

Clause 86. A non-transitory computer-readable recording medium storing a bitstream of a video which is generated by a method performed by an apparatus for video processing, wherein the method comprises: determining usage information of an adaptive reordering of merge candidates (ARMC) for a current video block of the video based on at least one syntax element; and generating the bitstream based on the usage information.

Clause 87. A method for storing a bitstream of a video, comprising: determining usage information of an adaptive reordering of merge candidates (ARMC) for a current video block of the video based on at least one syntax element; generating the bitstream based on the usage information; and storing the bitstream in a non-transitory computer-readable recording medium.

### Example Device

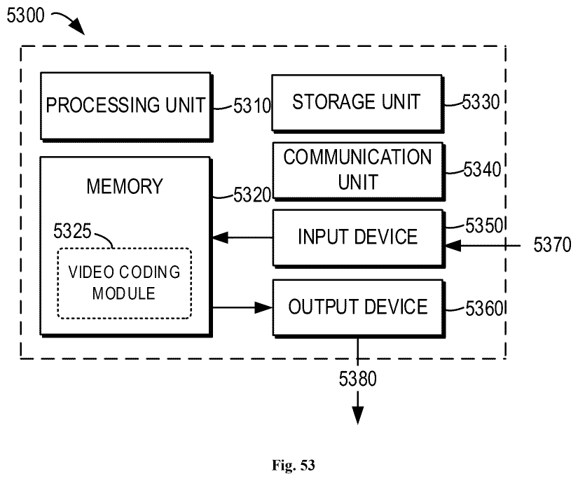

FIG. 53 illustrates a block diagram of a computing device 5300 in which various embodiments of the present disclosure can be implemented. The computing device 5300 may be implemented as or included in the source device 110 (or the video encoder 114 or 200) or the destination device 120 (or the video decoder 124 or 300).

It would be appreciated that the computing device 5300 shown in FIG. 53 is merely for purpose of illustration, without suggesting any limitation to the functions and scopes of the embodiments of the present disclosure in any manner.

As shown in FIG. 53, the computing device 5300 includes a general-purpose computing device 5300. The computing device 5300 may at least comprise one or more processors or processing units 5310, a memory 5320, a storage unit 5330, one or more communication units 5340, one or more input devices 5350, and one or more output devices 5360.

In some embodiments, the computing device 5300 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 5300 can support any type of interface to a user (such as “wearable” circuitry and the like).

The processing unit 5310 may be a physical or virtual processor and can implement various processes based on programs stored in the memory 5320. In a multi-processor system, multiple processing units execute computer executable instructions in parallel so as to improve the parallel processing capability of the computing device 5300. The processing unit 5310 may also be referred to as a central processing unit (CPU), a microprocessor, a controller or a microcontroller.

The computing device 5300 typically includes various computer storage medium. Such medium can be any medium accessible by the computing device 5300, including, but not limited to, volatile and non-volatile medium, or detachable and non-detachable medium. The memory 5320 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 5330 may be any detachable or non-detachable medium and may include a machine-readable medium such as a memory, flash memory drive, magnetic disk or another other media, which can be used for storing information and/or data and can be accessed in the computing device 5300.

The computing device 5300 may further include additional detachable/non-detachable, volatile/non-volatile memory medium. Although not shown in FIG. 53, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 5340 communicates with a further computing device via the communication medium. In addition, the functions of the components in the computing device 5300 can be implemented by a single computing cluster or multiple computing machines that can communicate via communication connections. Therefore, the computing device 5300 can operate in a networked environment using a logical connection with one or more other servers, networked personal computers (PCs) or further general network nodes.

The input device 5350 may be one or more of a variety of input devices, such as a mouse, keyboard, tracking ball, voice-input device, and the like. The output device 5360 may be one or more of a variety of output devices, such as a display, loudspeaker, printer, and the like. By means of the communication unit 5340, the computing device 5300 can further communicate with one or more external devices (not shown) such as the storage devices and display device, with one or more devices enabling the user to interact with the computing device 5300, or any devices (such as a network card, a modem and the like) enabling the computing device 5300 to communicate with one or more other computing devices, if required. Such communication can be performed via input/output (I/O) interfaces (not shown).

In some embodiments, instead of being integrated in a single device, some or all components of the computing device 5300 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 5300 may be used to implement video encoding/decoding in embodiments of the present disclosure. The memory 5320 may include one or more video coding modules 5325 having one or more program instructions. These modules are accessible and executable by the processing unit 5310 to perform the functionalities of the various embodiments described herein.

In the example embodiments of performing video encoding, the input device 5350 may receive video data as an input 5370 to be encoded. The video data may be processed, for example, by the video coding module 5325, to generate an encoded bitstream. The encoded bitstream may be provided via the output device 5360 as an output 5380.

In the example embodiments of performing video decoding, the input device 5350 may receive an encoded bitstream as the input 5370. The encoded bitstream may be processed, for example, by the video coding module 5325, to generate decoded video data. The decoded video data may be provided via the output device 5360 as the output 5380.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, usage information of a plurality of template-based approaches for the current video block based on at least one syntax element at a first level, the first level being higher than a coding unit level; and
performing the conversion based on the usage information,
wherein the plurality of template-based approaches comprises at least two coding tools associated with at least one of: intra coding, inter coding, or intra block copy (IBC) coding.

2. The method of claim 1, wherein the at least one syntax element comprises at least one of:
a first syntax element at the first level in the bitstream, the first syntax element indicating one of:
enabling, disabling, allowance or disallowance of a template-based determination, without considering whether the template-based determination is used to an intra tool, an IBC tool, a palette (PLT) tool, or an inter tool,
a second syntax element at the first level in the bitstream, the second syntax element indicating one of: enabling, disabling, allowance or disallowance of a template-based determination for an intra tool,
a third syntax element at the first level in the bitstream, the third syntax element indicating at least one of: enabling, disabling, allowance or disallowance of a template-based determination for an IBC tool,
a fourth syntax element at the first level in the bitstream, the fourth syntax element indicating one of: enabling, disabling, allowance or disallowance of a template-based determination for an inter tool, or
a fifth syntax element at the first level in the bitstream, the fifth syntax element indicating one of: enabling, disabling, allowance or disallowance of a template-based determination for a non-inter tool.

3. The method of claim 2, wherein the non-inter tool comprises at least one of: an intra tool, an IBC tool or a palette (PLT) tool, or
wherein whether at least one of the second, the third, the fourth or the fifth syntax element is included in the bitstream is based on the first syntax element.

4. The method of claim 3, wherein the first syntax element in the bitstream indicates enabling or allowance of the template-based determination, and the fourth and fifth syntax elements are included in the bitstream, or
wherein the fourth and fifth syntax elements are excluded from the bitstream and determined to be a predetermined number, the predetermined number indicative of disabling or disallowance of the template-based determination, or
wherein the first syntax element in the bitstream indicates enabling or allowance of the template-based determination, and the second, the third and the fourth syntax elements are included in the bitstream, or
wherein the second, the third and the fourth syntax elements are excluded from the bitstream and determined to be a predetermined number, the predetermined number indicative of disabling or disallowance of the template-based determination.

5. The method of claim 2, wherein the second, the third and the fourth syntax elements are included in the bitstream independently.

6. The method of claim 2, wherein the fourth syntax element and the fifth syntax element are included in the bitstream independently.

7. The method of claim 2, wherein the at least one syntax element comprises a syntax element controlling at least one of: enabling, disabling, allowance or disallowance of a template-based determination for at least one of: an intra tool, or an IBC tool.

8. The method of claim 7, wherein the syntax element comprises a sequence parameter set (SPS) flag at a sequence level controlling at least one of: enabling, disabling, allowance or disallowance of the template-based determination for the intra tool and the IBC tool.

9. The method of claim 7, wherein the syntax element comprises a sequence parameter set (SPS) flag at a sequence level controlling at least one of: enabling, disabling, allowance or disallowance of the template-based determination for the intra tool or the IBC tool.

10. The method of claim 8, wherein the SPS flag comprises an SPS template matching non-inter flag.

11. The method of claim 1, wherein the plurality of template-based approaches comprises at least one of: a coding tool involving a template with search or a coding tool involving a template without search.

12. The method of claim 11, wherein the coding tool involving the template with search comprises at least one of: a template cost calculation, or a template matching.

13. The method of claim 11, wherein the coding tool involving the template without search comprises at least one of:
a decoder side intra mode derivation (DIMD),
a convolutional cross-component model (CCCM),
a linear model (LM),
a cross-component linear model (CCLM),
a gradient linear model (GLM), or
a local illumination compensation (LIC).

14. The method of claim 1, wherein the template-based determination indicates whether to use the plurality of template-based approaches for the current video block.

15. The method of claim 1, wherein the first level comprises one of:
a sequence level,
a group of pictures level,
a picture header level,
a picture level,
a slice header level,
a slice level, or
a tile group level, or
wherein an indication of whether to and/or how to determine the usage information based on the at least one syntax element at the first level is included in the bitstream at one of:
a sequence level,
a group of pictures level,
a picture level,
a slice level, or
a tile group level, or
wherein an indication of whether to and/or how to determine the usage information based on the at least one syntax element at the first level is included in the bitstream in one of:
a sequence header,
a picture header,
a sequence parameter set (SPS),
a video parameter set (VPS),
a dependency parameter set (DPS),
a decoding capability information (DCI),
a picture parameter set (PPS),
an adaptation parameter set (APS),
a slice header, or
a tile group header, or
wherein an indication of whether to and/or how to determine the usage information based on the at least one syntax element at the first level is included in the bitstream in one of:
a prediction block (PB),
a transform block (TB),
a coding block (CB),
a prediction unit (PU),
a transform unit (TU),
a coding unit (CU),
a virtual pipeline data unit (VPDU),
a coding tree unit (CTU),
a CTU row,
a slice,
a tile,
a sub-picture, or
a region containing more than one sample or pixel.

16. The method of claim 1, further comprising:
determining, based on coded information of the current video block, whether to and/or how to determine the usage information based on the at least one syntax element at the first level, the coded information including at least one of:
a block size,
a colour format,
a single and/or dual tree partitioning,
a colour component,
a slice type, or
a picture type.

17. The method of claim 1, wherein the conversion comprising encoding the current video block into the bitstream, or wherein the conversion comprises decoding the current video block from the bitstream.

18. An apparatus for video processing comprising a processor and a non-transitory memory with instructions thereon, wherein the instructions upon execution by the processor, cause the processor to:
determine, for a conversion between a current video block of a video and a bitstream of the video, usage information of a plurality of template-based approaches for the current video block based on at least one syntax element at a first level, the first level being higher than a coding unit level; and
perform the conversion based on the usage information,
wherein the plurality of template-based approaches comprises at least two coding tools associated with at least one of: intra coding, inter coding, or intra block copy (IBC) coding.

19. A non-transitory computer-readable storage medium storing instructions that cause a processor to perform a method performed by an apparatus for video processing, wherein the method comprises:
determining, for a conversion between a current video block of a video and a bitstream of the video, usage information of a plurality of template-based approaches for the current video block based on at least one syntax element at a first level, the first level being higher than a coding unit level; and
performing the conversion based on the usage information,
wherein the plurality of template-based approaches comprises at least two coding tools associated with at least one of: intra coding, inter coding, or intra block copy (IBC) coding.

20. A non-transitory computer-readable recording medium storing a bitstream of a video which is generated by a method performed by an apparatus for video processing, wherein the method comprises:
determining usage information of a plurality of template-based approaches for a current video block of the video based on at least one syntax element at a first level, the first level being higher than a coding unit level; and
generating the bitstream based on the usage information,
wherein the plurality of template-based approaches comprises at least two coding tools associated with at least one of: intra coding, inter coding, or intra block copy (IBC) coding.
